(19) United States
(12) Patent Application Publication
(10) Pub. No.: US 2024/0340667 A1
(43) Pub. Date: Oct. 10, 2024

(54) METHOD EXECUTED BY USER EQUIPMENT, METHOD EXECUTED BY NETWORK NODE, AND STORAGE MEDIUM

(71) Applicant: Samsung Electronics Co., Ltd., Suwon-si (KR)

(72) Inventors: Dan LIU, Beijing (CN); Bozhi LI, Beijing (CN); He WANG, Beijing (CN); Yuanyuan ZHANG, Beijing (CN); Chanho AN, Suwon-si (KR)

(21) Appl. No.: 18/666,195

(22) Filed: May 16, 2024

Related U.S. Application Data
(63) Continuation of application No. PCT/KR2024/004570, filed on Apr. 5, 2024.

(30) Foreign Application Priority Data
Apr. 7, 2023 (CN) 202310370606.3
Feb. 6, 2024 (CN) 202410172073.2
Mar. 27, 2024 (CN) 202410362972.9

(51) Int. Cl. H04W 24/08; H04W 76/27

(52) U.S. Cl. CPC H04W 24/08; H04W 76/27

(57) ABSTRACT

A method performed by a user equipment (UE) is provided. The method comprises receiving a radio resource control (RRC) configuration, the RRC configuration comprising a configuration related to a group based beam reporting. The method comprises in case that the group based beam reporting is enabled, performing, based on the RRC configuration, measurement on at least two downlink signals transmitted by a network node. The method comprises transmitting a measurement result to the network node before a first moment.

### CROSS-REFERENCE TO RELATED APPLICATION(S)

This application is a continuation application, claiming priority under § 365 (c), of an International application No. PCT/KR2024/004570, filed on Apr. 5, 2024, which is based on and claims the benefit of a Chinese patent application number 202310370606.3, filed on Apr. 7, 2023, in the Chinese Intellectual Property Office, of a Chinese patent application number 202410172073.2, filed on Feb. 6, 2024, in the Chinese Intellectual Property Office, and of a Chinese patent application number 202410362972.9, filed on Mar. 27, 2024, in the Chinese Intellectual Property Office, the disclosure of each of which is incorporated by reference herein in its entirety.

### TECHNICAL FIELD

The disclosure relates to the technical field of wireless communication. More particularly, the disclosure relates to a method executed by a user equipment (UE), a method executed by a network node, and a storage medium.

### BACKGROUND

In order to meet the increasing demand for wireless data communication services since the deployment of fourth generation (4G) communication systems, efforts have been made to develop improved fifth generation (5G) or pre-5G communication systems. Therefore, 5G or pre-5G communication systems are also called “Beyond 4G networks” or “Post-Long Term Evolution (LTE) systems”.

In order to achieve a higher data rate, 5G communication systems are implemented in higher frequency (millimeter, mmWave) bands, e.g., 60 GHz bands. In order to reduce propagation loss of radio waves and increase a transmission distance, technologies such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (COMP), reception-end interference cancellation, etc.

In 5G systems, hybrid Frequency Shift-Keying (FSK) and Quadrature Amplitude Modulation (QAM) (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a scheme which can better satisfy communication requirements.

Additional aspects will be set forth in part in the description which follows and, in part, will be apparent from the description, or may be learned by practice of the presented embodiments.

In accordance with an aspect of the disclosure, a method performed by a user equipment (UE) in a wireless communication system is provided. The method includes receiving, by the UE, a radio resource control (RRC) configuration, the RRC configuration including a configuration related to a group based beam reporting, and in case that the group based beam reporting is enabled, performing, by the UE, based on the RRC configuration, simultaneous measurement on at least two downlink reference signals transmitted by a network node, and transmitting, by the UE, a measurement result to the network node no later than a first moment.

In accordance with another aspect of the disclosure, a method performed by a user equipment (UE) in a wireless communication system is provided. The method includes receiving, by the UE, a radio resource control (RRC) configuration, the RRC configuration including information related to resource scheduling, and when a resource scheduled by the RRC configuration satisfies a first condition related to scheduling, simultaneously receiving, by the UE, a downlink reference signal and a physical downlink shared channel, wherein the first condition is related to an overlapping situation of the downlink reference signal and the physical downlink shared channel in a time domain.

In accordance with another aspect of the disclosure, a method performed by a user equipment (UE) in a wireless communication system is provided. The method includes receiving, by the UE, a radio resource control (RRC) configuration, the RRC configuration being related to beam failure detection (BFD) measurement of a set layer, when the RRC configuration includes multiple measurement gap related information, determining, by the UE, a first scaling factor based on the multiple measurement gap related information, the first scaling factor being related to a time domain overlapping situation of at least one of the following information, a measurement gap occasion, a synchronization signal block (SSB)-based measurement timing configuration (SMTC) window, or a SSB occasion used for BFD, and determining, by the UE, based on the first scaling factor and a beam sweeping factor, a link quality evaluation time based on corresponding downlink reference signals from at least two transmission/reception points (TRPs).

In accordance with another aspect of the disclosure, a method performed by a network node in a wireless communication system is provided. The method includes transmitting, by the network node, a radio resource control (RRC) configuration to a user equipment (UE), the RRC configuration including a configuration related to a group based beam reporting, and in case that the group based beam reporting of the UE is enabled, transmitting, by the network node, at least two downlink reference signals, and no later than a first moment, receiving, by the network node, a measurement result obtained by performing simultaneous measurement on the at least two downlink reference signals based on the RRC configuration by the UE.

In accordance with another aspect of the disclosure, a method performed by a network node in a wireless communication system is provided. The method includes transmitting, by the network node, a radio resource control (RRC) configuration to a user equipment (UE), the RRC configuration including information related to resource scheduling, and when a resource scheduled by the second RRC configuration satisfies a first condition related to scheduling, simultaneously transmitting, by the network node, a downlink reference signal and a physical downlink shared channel, wherein the first condition is related to an overlapping situation of the downlink reference signal and the physical downlink shared channel in a time domain.

In accordance with another aspect of the disclosure, a method performed by a network node in a wireless communication system is provided. The method includes transmitting, by the network node, a radio resource control (RRC) configuration to a user equipment (UE), the RRC configuration being related to beam failure detection (BFD) measurement of a set layer, wherein, in case that the RRC configuration includes multiple measurement gap related information, a link quality evaluation time based on corresponding downlink reference signals from at least two transmission/reception points (TRPs) is determined based on a first scaling factor and a beam sweeping factor, and wherein the first scaling factor is determined based on the multiple measurement gap related information, and the first scaling factor is related to a time domain overlapping situation of at least one of the following information, a measurement gap occasion, a synchronization signal block (SSB)-based measurement timing configuration (SMTC) window, or a SSB occasion used for BFD.

In accordance with another aspect of the disclosure, a user equipment (UE) is provided. The UE includes at least one transceiver, memory storing one or more computer programs, and one or more processors communicatively coupled to the at least one transceiver and the memory, wherein the one or more computer programs include computer-executable instructions that, when executed by the one or more processors, cause the UE to receive a radio resource control (RRC) configuration, the RRC configuration including a configuration related to a group based beam reporting, in case that the group based beam reporting is enabled, perform based on the RRC configuration, simultaneous measurement on at least two downlink reference signals transmitted by a network node, and transmit a measurement result to the network node no later than a first moment.

In accordance with another aspect of the disclosure, a network node is provided. The network node includes at least one transceiver, memory storing one or more computer programs, and one or more processors communicatively coupled to the at least one transceiver and the memory, wherein the one or more computer programs include computer-executable instructions that, when executed by the one or more processors, cause the network node to transmit a radio resource control (RRC) configuration to a user equipment (UE), the RRC configuration including a configuration related to a group based beam reporting, in case that the group based beam reporting of the UE is enabled, transmit at least two downlink reference signals, and no later than a first moment, receive a measurement result obtained by performing simultaneous measurement on the at least two downlink reference signals based on the RRC configuration by the UE.

In accordance with another aspect of the disclosure, one or more non-transitory computer-readable storage media storing one or more computer programs including computer-executable instructions that, when executed by one or more processors of a user equipment (UE), cause the UE to perform operations are provided. The operations include receiving, by the UE, a radio resource control (RRC) configuration, the RRC configuration including a configuration related to a group based beam reporting, in case that the group based beam reporting is enabled, performing, by the UE, based on the RRC configuration, simultaneous measurement on at least two downlink reference signals transmitted by a network node, and transmitting, by the UE, a measurement result to the network node no later than a first moment.

Other aspects, advantages, and salient features of the disclosure will become apparent to those skilled in the art from the following detailed description, which, take in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 shows a schematic structure diagram of a wireless network system according to an embodiment of the disclosure;

FIGS. 2A and 2B show example wireless transmit and receive paths according to various embodiments of the disclosure;

FIG. 3A shows a schematic structure diagram of an example UE according to an embodiment of the disclosure;

FIG. 3B shows a schematic structure diagram of an example base station according to an embodiment of the disclosure;

FIG. 4 shows a schematic diagram of a beam reporting framework based on group based beam reporting according to an embodiment of the disclosure;

FIG. 5 shows a diagram of architecture of an optional scheme according to an embodiment of the disclosure;

FIG. 6 shows a schematic diagram of a multi-Chain receiving scenario according to an embodiment of the disclosure;

FIG. 7 shows a flowchart of a method executed by a UE according to an embodiment of the disclosure;

FIG. 8 shows a schematic diagram of principles of multi-panel based downlink reception according to an embodiment of the disclosure;

FIG. 9 shows a schematic diagram of principles of the separate design of new capabilities of the UE according to an embodiment of the disclosure;

FIG. 10 shows a schematic diagram of principles of the combined design of new capabilities of the UE according to an embodiment of the disclosure;

FIG. 11 shows a scenario of simultaneous L1 measurement and PDSCH reception under an intra-cell mDCI multi-TRP multi-Rx chain operation according to an embodiment of the disclosure;

FIG. 12 shows a scenario of simultaneous L1 measurement and PDSCH reception under an intra-cell sDCI multi-TRP multi-Rx chain operation according to an embodiment of the disclosure;

FIG. 13 shows a schematic diagram of principles of a communication method according to an embodiment of the disclosure;

FIG. 14 shows a schematic timeline diagram of simultaneous L1 measurement based on SSB under an intra-cell multi-TRP multi-Rx chain operation according to an embodiment of the disclosure;

FIG. 15 shows a schematic diagram of principles of simultaneous L1 measurement based on SSB under an intra-cell multi-TRP multi-Rx chain operation according to an embodiment of the disclosure;

FIG. 16 shows a schematic diagram of principles of simultaneous L1 measurement and PDSCH reception based on SSB under an intra-cell multi-TRP multi-Rx chain operation according to an embodiment of the disclosure;

FIG. 17 shows a schematic diagram of principles of the time overlapping relationship among BFD-SSB, SMTC and MG and the corresponding time sharing ratio under an inter-cell single-TRP single-Rx chain operation according to an embodiment of the disclosure;

FIG. 18 shows a schematic diagram of principles of the time overlapping relationship among BFD-SSB, SMTC and MG and the corresponding time sharing ratio under an inter-cell multi-TRP single-Rx chain operation according to an embodiment of the disclosure;

FIGS. 19 and 20 show schematic principle diagrams of a different time overlapping situations of resources in a case of supporting a concurrent measurement gap and in a case of not supporting the concurrent measurement gap under an inter-cell multi-TRP multi-Rx chain operation according to various embodiments of the disclosure;

FIGS. 21A, 21B, 21C and 21D are schematic diagrams of several configuration modes according to various embodiments of the disclosure;

FIG. 22 shows a schematic diagram of principles of L1 BFD measurement based on SSB under an inter-cell multi-TRP single-Rx chain operation according to an embodiment of the disclosure;

FIG. 23 shows a schematic diagram of principles of simultaneous L1 BFD measurement based on SSB under an inter-cell multi-TRP multi-Rx chain operation according to an embodiment of the disclosure;

FIG. 24 shows a flowchart of simultaneous L1 BFD measurement under inter-cell multi-TRP multi-Rx simultaneous reception according to an embodiment of the disclosure;

FIG. 25 shows a schematic structure diagram of an electronic device according to an embodiment of the disclosure; and

FIG. 26 shows a schematic diagram of principles of simultaneous L3 measurement under an intra-cell/serving cell multi-TRP multi-Rx simultaneous reception according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the disclosure belongs. Such terms as those defined in a generally used dictionary are to be interpreted to have the meanings equal to the contextual meanings in the relevant field of art, and are not to be interpreted to have ideal or excessively formal meanings unless clearly defined in the disclosure.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an integrated circuit (IC), or the like.

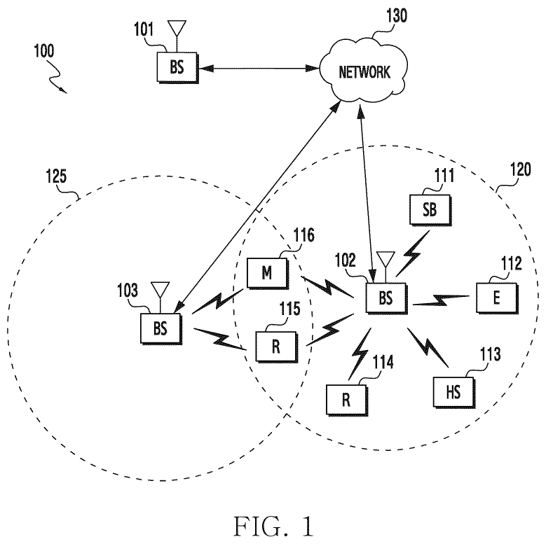

FIG. 1 illustrates an example wireless network according to an embodiment of the disclosure.

The embodiment of a wireless network 100 shown in FIG. 1 is for illustration only. Other embodiments of the wireless network 100 can be used without departing from the scope of the disclosure.

Referring to FIG. 1, the wireless network 100 includes a gNodeB (gNB) 101, a gNB 102, and a gNB 103. The gNB 101 communicates with gNB 102 and gNB 103. The gNB 101 also communicates with at least one Internet Protocol (IP) network 130, such as the Internet, a private IP network, or other data networks.

Depending on a type of the network, other well-known terms such as “base station” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

The gNB 102 provides wireless broadband access to the network 130 for a first plurality of User Equipments (UEs) within a coverage area 120 of the gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); and a UE 116, which may be a mobile device (M), such as a cellular phone, a wireless laptop computer, a wireless PDA, etc. The gNB 103 provides wireless broadband access to network 130 for a second plurality of UEs within a coverage area 125 of the gNB 103. The second plurality of UEs include a UE 115 and a UE 116. In some embodiments, one or more of the gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of the gNB 101, the gNB 102, and the gNB 103 include a two dimensional (2D) antenna array as described in embodiments of the disclosure. In some embodiments, one or more of the gNB 101, the gNB 102, and the gNB 103 support codebook designs and structures for systems with 2D antenna arrays.

Although FIG. 1 illustrates an example of the wireless network 100, various changes can be made to FIG. 1. The wireless network 100 can include any number of the gNBs and any number of UEs in any suitable arrangement, for example. Furthermore, the gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, the gNB 101, 102 and/or 103 can provide access to other or additional external networks, such as external telephone networks or other types of data networks.

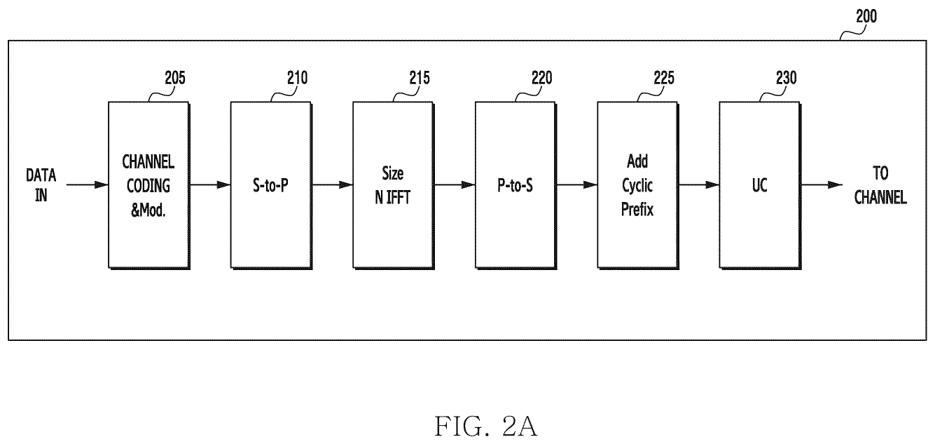

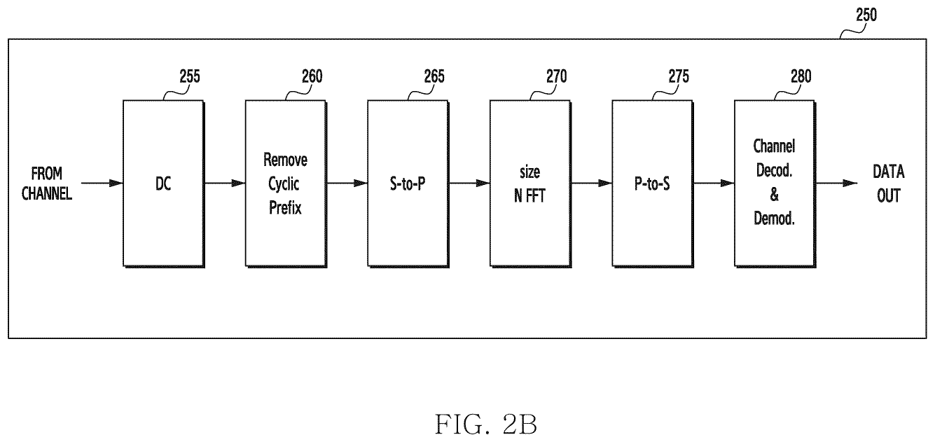

FIGS. 2A and 2B illustrate example wireless transmission and reception paths according to various embodiments of the disclosure.

Referring to FIGS. 2a and 2B, the transmission path 200 can be described as being implemented in a gNB, such as the gNB 102, and the reception path 250 can be described as being implemented in a UE, such as the UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to an radio frequency (RF) frequency for transmission via a wireless channel. The signal can also be filtered at a baseband before switching to the RF frequency.

The RF signal transmitted from the gNB 102 arrives at the UE 116 after passing through the wireless channel, and operations in reverse to those at gNB 102 are performed at the UE 116. The down-converter 255 down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of the gNBs 101-103 may implement a transmission path 200 similar to that for transmitting to UEs 111-116 in the downlink, and may implement a reception path 250 similar to that for receiving from the UEs 111-116 in the uplink. Similarly, each of UEs 111-116 may implement a transmission path 200 for transmitting to the gNBs 101-103 in the uplink, and may implement a reception path 250 for receiving from the gNBs 101-103 in the downlink.

Each of the components in FIGS. 2A and 2B can be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

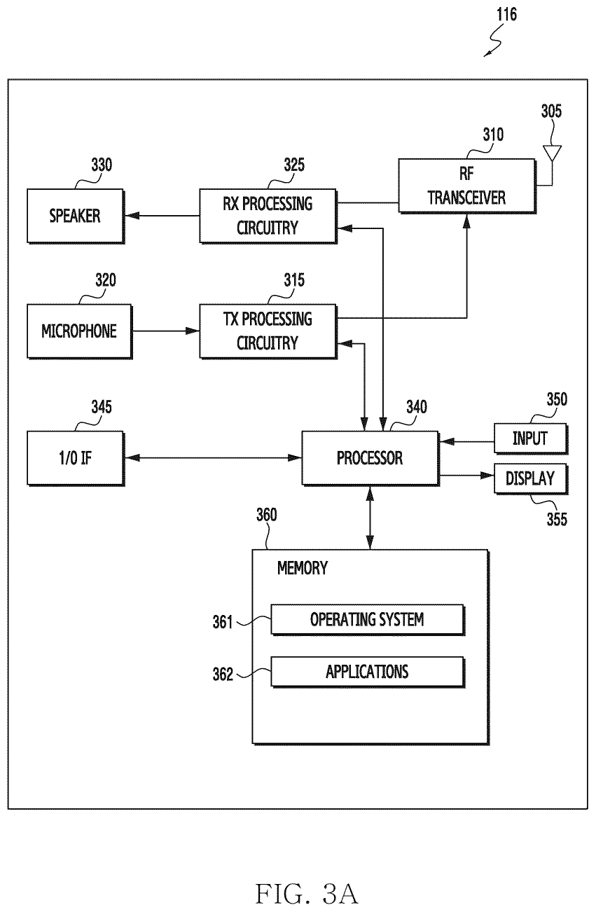

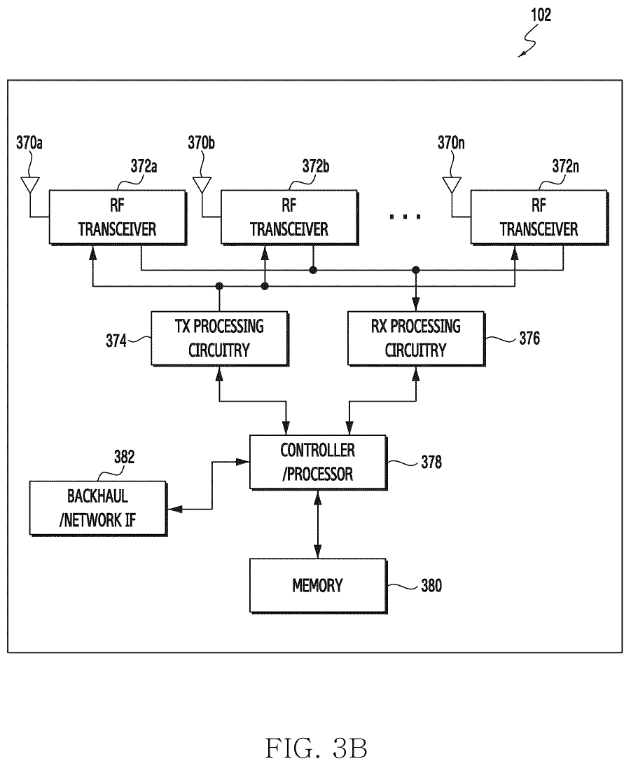

FIG. 3A illustrates an example UE according to an embodiment of the disclosure.

Referring to FIG. 3A, the UE 116 is for illustration only, and UEs 111-115 of FIG. 1 can have the same or similar configuration. However, a UE has various configurations, and FIG. 3A does not limit the scope of the disclosure to any specific implementation of the UE.

The UE 116 includes an antenna 305, a radio frequency (RF) transceiver 310, a transmission (TX) processing circuit 315, a microphone 320, and a reception (RX) processing circuit 325. The UE 116 also includes a speaker 330, a processor/controller 340, an input/output (I/O) interface 345, an input device(s) 350, a display 355, and memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of the UE 116. For example, the processor/controller 340 may control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of the UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include random access memory (RAM), while another part of the memory 360 can include flash memory or other read-only memory (ROM).

Although FIG. 3A illustrates an example of UE 116, various changes can be made to FIG. 3A. For example, various components in FIG. 3A can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3A illustrates that the UE 116 is configured as a mobile phone or a smart phone, the UEs can be configured to operate as other types of mobile or fixed devices.

FIG. 3B illustrates an example gNB according to embodiment of the disclosure.

The embodiment of the gNB 102 shown in FIG. 3B is for illustration only, and other gNBs of FIG. 1 can have the same or similar configuration. However, a gNB has various configurations, and FIG. 3B does not limit the scope of the disclosure to any specific implementation of a gNB. It should be noted that gNB 101 and gNB 103 can include the same or similar structures as gNB 102.

Referring to FIG. 3B, the gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. The gNB 102 also includes a controller/processor 378, memory 380, and a backhaul or network interface 382.

The RF transceivers 372a-372n receive an incoming RF signal from antennas 370a-370n, such as a signal transmitted by UEs or other gNBs. The RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of the gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows the gNB 102 to communicate with other devices or systems through a backhaul connection or through a network. The backhaul or network interface 382 can support communication over any suitable wired or wireless connection(s). For example, when the gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When the gNB 102 is implemented as an access point, the backhaul or network interface 382 can allow the gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an random access memories (RAM), while another part of the memory 380 can include flash memory or other read only memories (ROMs). In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of the gNB 102 (implemented using RF transceivers 372a-372n, TX processing circuit 374 and/or RX processing circuit 376) support aggregated communication with FDD cells and TDD cells.

Although FIG. 3B illustrates an example of the gNB 102, various changes may be made to FIG. 3B. For example, the gNB 102 can include any number of each component shown in FIG. 3A. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, the gNB 102 can include multiple instances of each (such as one for each RF transceiver).

In order to enhance the performance of a wireless communication system in a high carrier frequency (e.g., millimeter-wave high frequency range 2 FR2) scenario, a beam management mechanism is introduced for analog beamforming in the NR wireless communication system. Due to the characteristics of analog beamforming, for the measurement related to the radio resource management (RRM) requirement, the scheduling restriction will occur during measurement.

In a situation, a UE (also referred to as a terminal, a terminal device, etc.) may perform downlink (DL) reception by using one receive chain (Rx chain) based on one antenna panel equipped by the UE, and the intra-cell measurement behavior of the UE corresponding to the assumption based on one receive panel is: performing layer 1 measurement (L1 measurement, simply referred to as L1-measurement or layer-1 measurement) in a serving cell, where the serving cell includes a PCell, a PSCell or a SCell. The UE operates one Rx chain in a time instance to receive a reference signal (RS) for L1 measurement. For layer 3 measurement (L3 measurement or L3-measurement for short), the measurement scenario considered is intra-frequency measurement of a serving cell, which can be performed in a serving cell because there is only one serving cell, or it can be called single/same-frequency measurement of a serving cell. If two TRPs are deployed in the serving cell, it means that the two TRPs are on a same frequency carrier, and the two TRPs have the same center frequency and the same subcarrier spacing. For layer 3, at least two downlink reference signals comprise at least two downlink reference signals corresponding to at least two TRPs in one serving cell.

When the UE uses one Rx chain, the scheduling restriction requirement is also needed for the problem that the UE cannot perform simultaneous reception or transmission of an RS and a PDSCH in a scenario of simultaneous L1 measurement and PDSCH reception (that is, when the measured RS and the PDSCH collide on the same orthogonal frequency division multiplexing (OFDM) symbol). For example, with regard to FR2, for L1 measurement, due to the beam sweeping of SSB resources, the scheduling restriction is always needed on the SSB resource; and when the CSI-RS resource and the PDSCH/physical downlink control channel (PDCCH) are not of a QCL TypeD, the scheduling restriction is also always needed on the CSI-RS resource. When the RS used for L1 measurement and the PDSCH resource are overlapped, the UE performs L1 measurement at high priority and interrupts data reception. Therefore, the single-chain reception at least has the problems of low data rate and small capacity. When the UE performs TRP1 measurement, the data of TRP2 will be interrupted. Even if the link quality of the TRP2 is very good, the NW does not expect to schedule the PDSCH of the TRP2. Thus, the resources are utilized inefficiently. When the UE uses a Rx Chain, for L3 measurement performed in the serving cell, it occurs after L1 measurement filtering, and a measurement reported from L1 to L3 is the best among all receive beams. However, how to achieve averaging (i.e., filtering) to report RRM measurements depends on the UE implementation.

In a situation, the UE may perform a multiple receive chain (multi-Rx chain, multi-Rx) simultaneous DL reception operation. The Multi-Rx simultaneous reception means that the UE simultaneously receives different downlink signals from different directions corresponding to different TRPs or different cells by using the Multi-Rx chain. The simultaneously received signals are fully or partially overlapped in time domain. The granularity of time units in the time domain may be the granularity of OFDM symbols or other granularities. The simultaneously received downlink signals may be RSs used for layer 1 measurement (i.e., L1 measurement) of different TRPs for channel estimation, or may be RSs used for Layer 3 measurement (i.e., L3 measurement) of a same cell for channel estimation. The type of RSs includes at least one of SSBs and channel state information reference signals (CSI-RSs).

In an embodiment of the disclosure, the L1 measurement includes at least one of radio link monitoring (RLM), beam failure detection (BFD), candidate beam detection (CBD), L1-reference signal received power (L1-RSRP) measurement and L1-signal to noise and interference ratio (L1-SINR) measurement. The L3 measurement includes at least one of a SSB-based reference signal received power (SS-RSRP) measurement, a SSB-based signal to noise and interference ratio (SS-SINR) measurement, and a SSB-based reference signal receiving quality (SS-RSRQ) measurement. Multiple downlink channels that are simultaneously received may be channels of the same type, for example, data channels such as PDSCHs or PDCCHs, or may be a combination of PDSCHs and RSs. In the embodiment of the disclosure, the downlink reference signals may be downlink reference signals on which any L1 or L3 measurement scenario described above is based.

The downlink signals from at least two different directions can be received by using multiple Rx chains, so that the number of DL MIMO layers is increased to at most 4. Thus, the data throughput can be improved, the performance requirements of the UE can be improved and enhanced, and the scheduling restriction and the measurement restriction can also be alleviated.

The advantage of the Multi-Rx simultaneous reception is that new requirements can be introduced into the FR2-1 UEs with the multi-RX chain simultaneous DL reception capability in a single component carrier (CC) of single FR2-1 band to obtain at least one of improved radio frequency (RF), radio resource management and UE decoding performance, i.e., at least one of increasing the RF spherical coverage, improving the RRM performance, improving the decoding performance of at most 4 DL MIMO layers and other effects. It should be noted that in practical application scenarios, the UE may be configured with multiple CCs, including intra-band carrier aggregation and/or inter-band carrier aggregation, and the UE may also be configured with dual connectivity.

It is found that the improvement of the RRM requirements based on multi-RX chain can be independent of 4 layer MIMO, that is, the RRM requirements cannot be limited to 4 layer MIMO data transmission, and the downlink reception of reference signals of different quasi co-location (QCL) TypeD from different spatial directions (the direction can be represented by the angle of arrival (AoA)) at the same time should be taken into consideration. If QCL TypeD is configured (e.g., RRC configuration), the corresponding large-scale parameter is a spatial Rx parameter which is equivalent to an Rx beam.

For Multi-Rx simultaneous reception, the UE may report UE capability information to a network (NW) (e.g., a base station or a TRP) through an RRC signaling. The Multi-Rx can consider both a single downlink control information (DCI) mode and a multi-DCI mode.

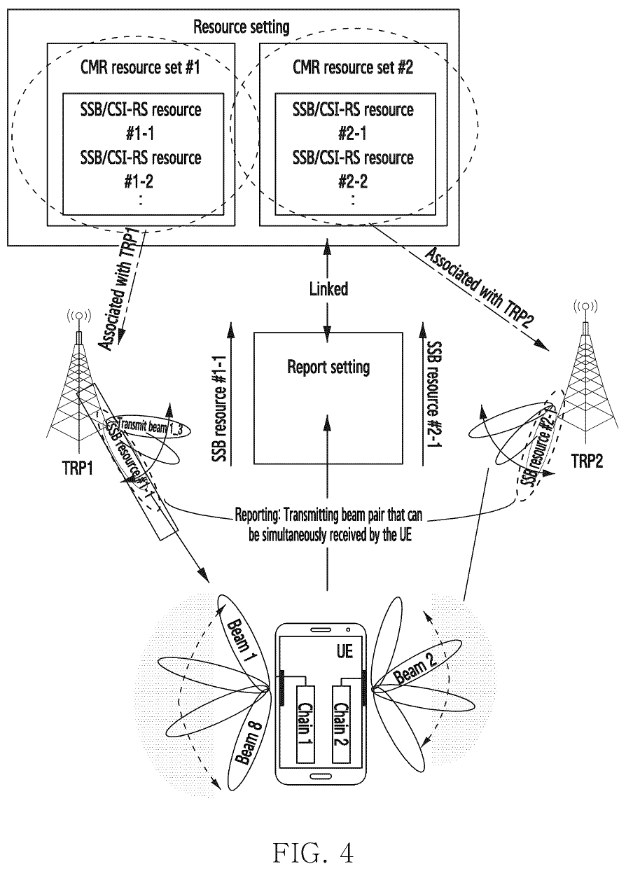

FIG. 4 shows a schematic diagram of a beam reporting framework based on group based beam reporting according to an embodiment of the disclosure.

The measurement (e.g., L1 measurement) of a set layer provided in the embodiment of the disclosure can utilize group based beam reporting (GBBR). Optionally, the GBBR may be group based second beam reporting, one report setting is linked to one channel measurement resource (CMR) setting, and one CMR setting includes two CMR resource sets. Each TRP-associated CMR resources is represented by a CMR resource set. The UE reports two different CSI-RS resource indexes/indicators (CRIs) or SSB resource indexes/indicators (SSBRIs) for the report setting in a single reporting instance (or a single reporting timing, a single time point), to indicate that the UE can simultaneously receive resources in different CMR resource sets from the NW. Referring to FIG. 4, the TRP1 and TRP2 are associated with the CMR resource set #1 and the CMR resource set #2, respectively, where #1-1, #1-2 and the like are the resource indexes of the RS resources in the resource set #1, and #2-1, #2-2 and the like are the resource indexes of the RS resources in the resource set #2. The UE may report the resource indexes corresponding to the two TRPs, for example, the SSB resource #1-1 and SSB resource #2-1 as shown, and the UE may perform simultaneous reception on the transmit beams corresponding to the two resource indexes.

The necessity of using the group based second beam reporting lies in that: firstly, the UE cannot distinguish the single TRP scenario without using this technology. This is because different transmit beams can come from a single TRP or multiple TRPs in the multi-TRP scenario. Secondly, the UE does not know the correspondence between beams and TRPs without using this technology. According to the reporting framework of the group based second beam reporting, the correspondence between different transmit beams and different TRPs can be known, and the UE can use an independent receive panel to simultaneously receive transmit beams from different TRPs.

In the embodiment of the disclosure, the Multi-Rx simultaneous downlink reception scenario should include the following three situations:
situation 1: simultaneous DL reception of PDSCHs and PDSCHs (also referred to as data+data), which may be called PDSCH+PDSCH for short;
situation 2: simultaneous DL reception of RSs and RSs used for L1/L3-measurement, which may be called RS+RS for short; and
situation 3: simultaneous DL reception of RSs used for L1-measurement and PDSCHs, which may be called RS+PDSCH for short.

It is found that, for the Multi-Rx simultaneous DL reception scenario, the UE implementation and the NW scheduling are limited, and the NW cannot accurately identify the behavior of the corresponding UE and will also limit the UE implementation.

Therefore, in order to improve the communication performance so that the FR2-1 UE (Multi-Rx UE) with higher capability can or may better support simultaneous downlink reception which may be one or more of simultaneous receptions in the above three situations, a new communication scheme is needed or the existing scheme needs to be optimized.

In order to solve or improve one or more of the existing problems, the embodiments of the disclosure provide a new scheme. This scheme may be executed by a UE or a network node (a network device or a network entity), and the scheme may be implemented based on communication interactions between the UE and the network node. The network node may be a base station, a TRP or a higher layer network node (e.g., a network controller or other higher layer entities). In the embodiments of the disclosure, the source of the information received from the network node by the UE may be the network node, or may be transmitted to the UE by another network node through this network node. For example, a higher layer network node transmits the information to the UE through the TRP or the base station.

The scheme provided in the embodiments of the disclosure is suitable for a multiple TRP (multi-TRP) scenario, and the multi-TRP may be an intra-cell or inter-cell multi-TRP, because multiple cells may be located on a same frequency carrier or different frequency carriers, and because the scheme provided in the embodiments of the disclosure is also suitable for intra-frequency or inter-frequency cell measurement scenarios. For only one cell, this serving cell is considered as single-frequency/intra-frequency deployment. The embodiments of the disclosure provide scenarios suitable for the above three simultaneous downlink reception situations. Optionally, the simultaneous reception scenario may include, but not limited to, intra-cell/serving cell simultaneous reception of RS+RS, intra-cell simultaneous reception of RS+PDSCH, intra-cell simultaneous reception of PDSCH+PDSCH, and inter-cell simultaneous reception of RS+RS used for BFD measurement.

The method provided in the embodiments of the disclosure may be described using a UE as the executive body. It should be understood that the steps involving information/signaling/message interaction may be described from the UE side or from the base station side. For example, the UE receiving UE capability enquiry information transmitted by the network node may also be described as that the network node transmits the UE capability enquiry information to the UE.

In addition, it is to be noted that the names or appellations of various information/messages/parameters involved in the embodiments of the disclosure are not unique, and the names or appellations of the information/messages/parameters can be altered as long as the functions of the information/messages/parameters, the contents contained in the information/messages/parameters or the explanations or descriptions of the information/messages/parameters can be corresponding or associated. For example, the reference signal resource in the embodiments of the disclosure may also be called a reference signal. For another example, the beam may also be called a spatial domain filter, a spatial domain transmission filter, a spatial domain transmit filter, etc. Some term names involved in the embodiments of the disclosure may adopt the term names that already exist in the communication standards, for example, reference signal or reference signal resource; while some term names may be newly added or defined term names. These newly added or defined term names may also adopt other names in future communication standards, or may be described in other ways (e.g., a paragraph of text description).

In the embodiments of the disclosure, the downlink reference signal may include, but not limited to, the CSI-RS or SSB, and may also be other reference signals newly defined in future (e.g., newly defined reference signals that can be used for L1/L3 measurement). In some descriptions, the reference signal may be a reference signal resource (a resource for transmitting a reference signal), and the reference signal resource may also be described as a reference signal. For example, the CSI-RS may be a CSI-RS resource, and the SSB may be a SSB resource.

In the embodiments of the disclosure, in an embodiment describing that one information includes multiple pieces of information (e.g., the RRC configuration information from the NW received by the UE), the multiple pieces of information may be simultaneously transmitted to the UE by the NW through one information/message/signaling, or some or all of the multiple pieces of information may be separately transmitted to the UE by the NW through multiple pieces of information/messages/signaling.

In some embodiments of the disclosure, the network node will be abbreviated as NW, and the reference signal will take SSB or CSI-RS as an example. In the absence of conflicts, the description of taking one downlink reference signal or reference signal resource (e.g., SSB or CSI-RS resource) as an example is also applicable to another downlink reference signal or reference signal resource (e.g., CSI-RS or CSI-RS resource). In the description of one information/configuration including information related to information b involved in the embodiments of the disclosure, this information/configuration may directly include the information b or the information of the information b, or include information that can be used to determine the information b. That is, this information/configuration includes an explicit or implicit indication of the information b.

In a scenario to which the embodiment of the disclosure is applied, the UE may be a UE that supports downlink simultaneous reception and has higher capability (which may be called a multi-RX chain enabled UE or Multi-Rx UE), or may not be a UE with higher capability. In order to satisfy the related requirements for L1/L3 measurement of the UE in various situations, for example, dealing with various possible conflicts and ensuring the requirements for measurement/evaluation accuracy, the embodiment of the disclosure provides the UE's new requirements on various intra-cell and inter-cell measurement and resource scheduling behaviors after new capabilities possibly supported by the UE are introduced, and also propose new definitions for the measurement period or evaluation period, the known TCI state condition and the resource scheduling restriction. For example, for the simultaneous downlink reception including downlink reference signal reception, in the process of performing reference signal based measurement, the UE needs to determine some parameters used for the process, for example, measurement period/delay or evaluation period/delay. The parameters to be determined in different measurement scenarios may be different. In the embodiments of the disclosure, an optional scheme for determining the related parameters of measurement delay and/or evaluation delay based on a first scaling factor (also referred to as a first time sharing ratio) and/or a beam sweeping factor is provided. The UE may determine the delays based on one or more of these factors, so that the UE may perform reference signal based measurement (e.g., L1 measurement) based on the determined period/measurement time/evaluation time or the like.

In the embodiments of the disclosure, for a FR2-1 UE (Multi-Rx UE) supporting higher capability, since for the L3 measurement performed in the serving cell, it occurs after L1 measurement filtering, and a measurement reported from L1 to L3 is the best among all receive beams, and how to achieve averaging (i.e., filtering) to report RRM measurements depends on the UE implementation. For the intra-cell/serving cell measurements, the embodiments of the disclosure focus on simultaneous L1 measurement of RS+RS, and the beam sweeping factor N1 discussed can be directly applied to simultaneous L3 measurement under the Multi-Rx UE, and consider dynamic intra-frequency/single-frequency serving cell L3 measurement period or shortened L3 measurement result reporting time based on N1. In the embodiments of the disclosure, for an FR2-1 UE (Multi-Rx UE) supporting higher capability, the capability may take the group based beam reporting (e.g., group based second beam reporting) as a prerequisite, and the UE can simultaneously measure overlapped RS resources in the time domain and can simultaneously receive RS+RS and RS+PDSCH, without considering the original UE behavior measurement restriction and scheduling restriction.

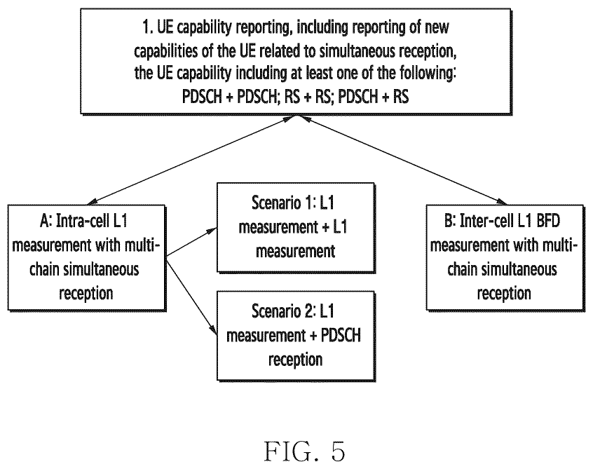

FIG. 5 shows several possible implementation scenarios included in the scheme provided according to an embodiment of the disclosure.

Referring to FIG. 5, an optional scheme provided by the disclosure may include at least one of the following aspects, wherein the aspects may be implemented independently, or different aspects may be implemented in combination if not conflicted.
1) In order to guarantee the simultaneous measurement of the UE under the multi-Rx operation and the implementability of simultaneous measurement and PDSCH reception, the UE may report to support a higher capability, and the NW may accurately configure the corresponding resource according to different UE capability reports. Optionally, this capability may be described as Multi-Rx DL simultaneous reception. Optionally, multiple UE new capabilities are designed, and each capability supports one RS/PDSCH combination. Optionally, the following two parameters (also referred to as information or information elements (IEs), etc.) may be newly added:
simultaneousReceptionDiffTypeDRS-r18, where this parameter (first information) is set as a first identifier, e.g., supported, indicating that the UE supports simultaneous RS+RS reception; and
simultaneousReceptionDiffTypeDRSData-r18, where this parameter (second information) is set as a second identifier, e.g., supported, indicating that the UE supports simultaneous RS+PDSCH reception.

Of course, if multiple simultaneous reception capabilities are supported simultaneously, a parameter indicator (combined indication information) may also be used to indicate that the UE supports the multiple simultaneous reception capabilities. For example, if the UE simultaneously supports the RS+RS simultaneous reception and RS+PDSCH simultaneous reception, the UE may report the simultaneousReceptionDiffTypeDRD set as a specific identifier or other forms of IEs. The forms of the first identifier, the second identifier and the specific identifier as described above will not be uniquely limited in the embodiment of the disclosure, and may be agreed identifiers in any form.
2) One or more of the reporting condition, reporting form and reporting content of new capabilities, and the relationship between new capabilities and existing capabilities.
3) New procedure of the interaction between the UE and the NW after new capabilities are introduced.
4) New definition of the UE L1 measurement behaviors/requirements after the Multi-Rx simultaneous reception and new capabilities are introduced. The L1 measurement behavior of the UE includes simultaneous L1 measurement and L1 measurement, and simultaneous L1 measurement and PDSCH reception.

The behaviors/requirements for the simultaneous L1 measurement and L1 measurement of the UE may be defined as that: the UE performs Rx beam pair sweeping for measurement by using the GBBR result. At the same time, the UE uses multiple panels to sweeps Rx beams directed to corresponding TRPs, so that the number of swept Rx beams may be decreased from N=8 to N1, where N1 is less than 8. Based on the latest time of reporting the measurement result, the UE adaptively reports the measurement result. The latest time is variable and related to N1. In the case of a known dual TCI state switching, the UE adaptively receives a TCI state switch command based on the longest time of reception of the TCI state switch command, where the longest time is variable and related to N1. In the case of an unknown dual TCI state switching, based on the latest time to finish the TCI state switching, the UE adaptively finishes the TCI state switching and uses a new TCI state to receive a PDCCH, where the latest time is variable and related to N1.

The behaviors/requirements for the simultaneous L1 measurement and PDSCH reception of the UE are defined as that: the NW configures PDSCH and RS scheduling resources for the UE according to the timing relationship, and the UE detects whether the two resources satisfy the timing relationship to ensure that the PDSCH and the RS can be received simultaneously. The NW may determine which RS and PDSCH are overlapped on the same OFDM symbol based on the timing relationship so as to configure simultaneous scheduling for the overlapped resources. The UE determines which RS and PDSCH are overlapped on the same OFDM symbol based on the timing relationship, and receives the two resources simultaneously.
5) New definition of the inter-cell UE L1 BFD measurement behaviors/requirements after the introduction of Multi-Rx simultaneous reception and new capabilities.

Optionally, the NW may configure multiple measurement gaps for multiple TRPs (e.g., multiple inter-cell TRPs) according to different beam link qualities. The UE autonomously determines BFD of two TRPs under different mutual time overlapping relationships, and configures a time sharing ratio (first time sharing ratio) between SSB-based measurement timing configuration (SMTC) and measurement gap (MG) based on the measurement time of the SSB. Based on different time sharing ratios and the reduced number N1 of Rx beam sweeping, the UE flexibly determines the advanced expiration timing of RLF declaration to perform BFD measurement and select the best candidate beam pair.

The optional implementation schemes of the above aspects will be described below in detail by specific embodiments. Optionally, the scheme provided in the embodiment of the disclosure may be based on at least one of the following hypotheses:
1) The number of antenna panels equipped on the UE are in one-to-one mapping to the number of receive chains, i.e., Rx chains; and for one antenna panel, there may be only one Rx beam (receive beam) for downlink reception.
2) The configuration of UE panels should follow an unknowable mode, that is, the UE panels need to adapt to different implementations. For example, three-panel implementation, back-to-back dual-panel implementation and the like should be supported.
3) The RRC connection mode is taken into consideration, that is, the UE is a UE in a connected state. 4) Intra-cell multi-TRP scenario. 5) Inter-cell multi-TRP scenario. 6) For the simultaneous DL reception, the group based second beam reporting is a prerequisite.

Optionally, in the embodiment of the disclosure, the Rx chain, Rx beam or panel may be interchanged.

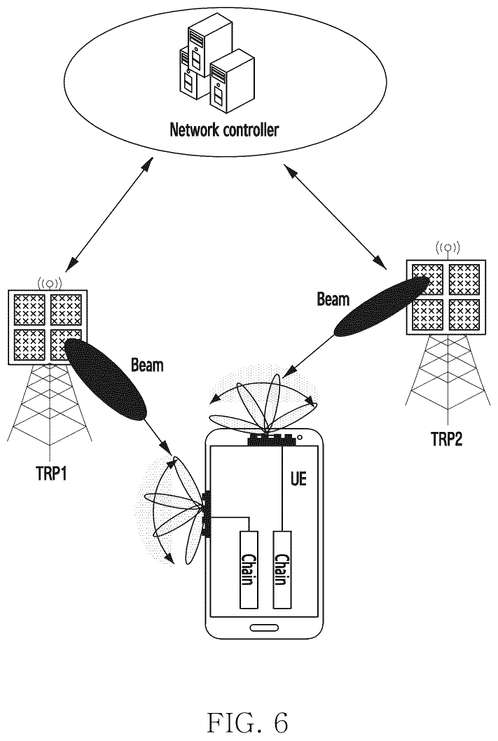

FIG. 6 shows a schematic diagram of a multi-Chain receiving scenario according to an embodiment of the disclosure.

Referring to FIG. 6, the simultaneous DL reception may be the multi-Rx/multi-panel simultaneous DL reception in the Multi-TRP transmission scenario. In the example of FIG. 6, the UE may correspond to two TRPs of the same cell, the NW may schedule resources from the two TRPs for the UE, and the UE may perform simultaneous DL reception on multiple chains (two receive chains are shown in FIG. 6). Of course, the scheme provided in the embodiment of the disclosure may also be limited to the above limitation. For example, the UE may also correspond to one base station, and the UE supporting the simultaneous reception may be that the UE may receive downlink information from the base station through two beams. In the embodiment of the disclosure, the network node may be a network controller or TRP in FIG. 6 or may be a network controller and a TRP. The network controller may be a higher layer network device, and may transmit information to the UE through the TRP to configure and schedule the UE.

Optionally, if the UE side can realize simultaneous reception (for example, at least one of simultaneous reception of at least two PDSCHs (PDSCH+PDSCH), simultaneous reception of at least two reference signals (RSs) (RS+RS), or simultaneous reception of at least one reference signal and at least one PDSCH (PDSCH+RS)), the UE may be configured with group based beam reporting, e.g., group based second beam reporting. For example, the corresponding related parameter (e.g., higher layer parameter groupBasedBeamReporting-r17) of the UE is configured as ‘enabled’, that is, the group based beam reporting is configured as enabled (started or effective, etc.).

When the UE is configured as the GBBR being started/enabled, there may be multiple CSI resource sets corresponding to the UE, e.g., two resource sets. Each resource set is associated with one TRP, and one CSI resource set includes at least one reference signal resource (e.g., SSB resource, CSI-RS resource). The UE may perform measurement and reporting based on this configuration, for example, transmitting a measurement report to the TRP or base station. This measurement report may include at least one beam index pair, i.e., a resource indication pair, for example, at least two SSBRIs, or at least two CRIs, or at least one CRI and at least one SSBRI. The at least two indexes in each beam index pair correspond to at least two different resource sets, that is, at least two CSI-RS resources from different resource sets are reported by two different CRIs or at least two SSB resources are reported by two different SSBRIs. The two CRIs/SSBRIs may be used for simultaneous downlink reception.

Optionally, the RS+RS in the embodiment of the disclosure may be simultaneous DL RS reception with different QCL TypeD, and the simultaneously received downlink RSs may be used for simultaneous intra-cell L1 measurement and/or inter-cell L1 measurement. The combination of the simultaneously received downlink RSs may include at least one of the following:
SSB+SSB, CSI-RS+CSI-RS, and SSB+CSI-RS.

Optionally, the RS+PDSCH in the embodiment of the disclosure may be SSB+PDSCH or CSI-RS+PDSCH. In addition, since the reference signals of the PDSCH and the PDCCH are DMRSs, the combination of RS+PDSCH may be expanded as SSB+PDSCH/PDCCH and CSI-RS+PDSCH/PDCCH.

In an optional embodiment of the disclosure, a design for optimizing NR air-interface UE capability reporting is provided, and the reporting of higher capabilities of the UE may be realized by newly adding IEs in the UE capability downlink. There may be one or more newly added IEs. For example, if the UE has at least one higher capability, each capability may correspond to one new IE (that is, each IE corresponds to one new UE capability conforming to one UE behavior), or multiple capabilities may correspond to one IE (that is, one IE corresponds to at least two UE capabilities, for example, two new UE capabilities or one new UE capability and one existing supported UE capability; and one UE capability conforms to one UE behavior). By reporting the UE capability information, the UE may allow the NW to fully understand the UE capabilities and reasonably configure the MIMO capabilities of the UE.

It is to be noted that, in actual implementations, even if the UE reports that it supports a higher capability, the configuration for the UE by the NW may or may not be associated with the reported higher capability. For example, although the UE supports simultaneous PDSCH+RS reception, the resource for PDSCH transmission and the RS resource configured for the UE by the NW may be non-overlapped in the time domain, so that the simultaneous reception of the data and the reference signal will not occur. In other words, time-domain overlapped resources or time-domain non-overlapped resources (e.g., TDMed resources) may be configured between RSs or between the RS and PDSCH. The non-overlapped resources may have no measurement/scheduling restriction, so the discussion based on overlapped resources will be given below. Here, the overlapped resources may mean that the downlink information (e.g., PDSCH and RS, or RS and RS) transmission resources are partially or fully overlapped in the time domain, for example, being overlapped on at least one time unit/time instance; for example, being at least partially overlapped in one OFDM symbol.

Optionally, based on the introduced new capabilities and considering the Multi-Rx simultaneous reception, the measurement behaviors and/or requirements of the UE need to be newly defined, including but not limited to, newly defining the intra-cell L1/L3 measurement behaviors/requirements of the UE and/or the inter-cell L1 BFD measurement behaviors/requirements of the UE.

For the intra-cell L1 measurement of the UE, referring to FIG. 5, the scenario in the embodiment of the disclosure includes at least one of simultaneous L1 measurement and L1 measurement, and simultaneous L1 measurement and PDSCH reception. The simultaneous L1 measurement and L1 measurement means that the UE expects to perform L1 measurement of two TRPs. The simultaneous L1 measurement and PDSCH reception means that the UE expects to perform L1 measurement of another TRP while it is performing PDSCH downlink reception of any one TRP. Different scenarios will be described below with reference to different embodiments respectively, and the related contents or same contents involved in different scenario embodiments can be combined with each other if not conflicted or contradicted. Different embodiments can be implemented separately or in combination. In an optional embodiment of the disclosure, for the simultaneous downlink reception behaviors of the UE, the L1 measurement requirements based on the downlink reference signal and the known/unknown dual transmission configuration indication (TCI) state switching requirements are conditionally expanded.

The technical solutions provided by the disclosure and the technical effects achieved by the technical solutions will be described below by various optional implementations. Similarly, the following implementations can be referred to, learned from or combined with each other if not conflicted or contradicted, and the same terms, similar characteristics, similar implementation steps or the like in different implementations will not be repeated. For the interaction steps between a UE and a NW, the corresponding solutions on the other side can be obtained based on the description of the solutions on one side. For example, from the description that the UE receives the configuration information, it can be concluded that the NW transmitted the configuration information. In an embodiment including a plurality of steps, if there is no clear chronological order for the plurality of steps, the implementation order of the plurality of steps will not be uniquely defined in the embodiment of the disclosure.

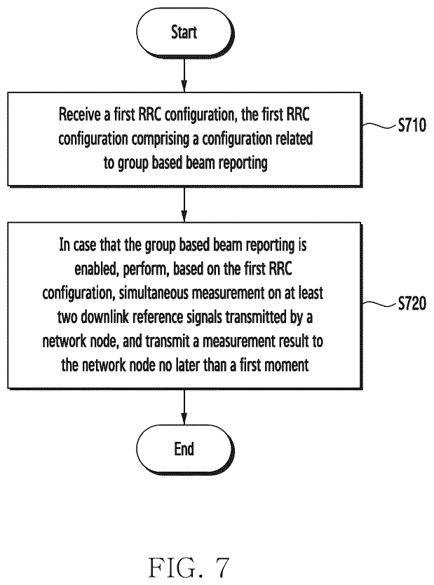

FIG. 7 shows a method executed by a UE according to an embodiment of the disclosure.

Referring to FIG. 7, the method may include the following steps.

In step S710, a first RRC configuration is received, the first RRC configuration comprising a configuration related to group based beam reporting.

In step S720, when the group based beam reporting is enabled, simultaneous measurement is performed on at least two downlink reference signals transmitted by a network node based on the first RRC configuration, and a measurement result is transmitted to the network node no later than a first moment.

Based on the scheme provided in the embodiment of the disclosure, the UE can perform beam group (the beam group includes at least two beams) based beam sweeping to perform measurement, so that the measurement speed can be expedited, and the corresponding measurement result can be transmitted to the network node earlier. Optionally, the measurement result includes a channel quality measurement result (beam quality), i.e., a measurement quantity, for example, an L1-RSRP value.

Optionally, before the UE transmits the measurement result, the method further includes:
performing measurement based on the first RRC configuration, and transmitting a measurement report based on the GBBR, wherein the measurement report includes at least one reference signal index pair and the corresponding measurement result, and each index pair includes at least two reference signal indexes corresponding to at least two TRPs.

Optionally, the at least two downlink reference signals include at least two downlink reference signals corresponding to at least two TRPs, and the at least two TRPs are at least two intra-cell TRPs or at least two inter-cell TRPs. Optionally, the performing, based on the first RRC configuration, simultaneous measurement on at least two downlink reference signals may include: performing, based on the first RRC configuration, simultaneous measurement of a set layer on the at least two downlink reference signals. Optionally, the set layer is a layer 1. The downlink reference signals are SSBs or CSI-RSs.

In the embodiments of the disclosure, the first RRC configuration may also be called RRC configuration information, and the NW may transmit multiple configurations to the UE through the RRC configuration. The first RRC configuration includes a configuration related to the group based beam reporting. Optionally, this configuration may include at least one of reference signal resource related information used for measurement and CSI reporting related information. The reference signal resource related information may also be called a reference signal resource configuration or other names, and the CSI reporting related information may also be called a CSI reporting configuration. The network side may provide the UE with the resource configuration used for CSI measurement and the reporting configuration used for CSI reporting. Optionally, the network may configure multiple SSB or CSI-RS resource sets for the UE through the RRC configuration; and the UE may perform downlink channel measurement according to the resources in the configured resource set before CSI reporting, and the UE may transmit a measurement to the network based on the channel measurement, wherein the measurement may include one or more reporting parameters. Different resource sets may correspond to different TRPs.

The RRC configurations (the first RRC configuration, and the second and third RRC configuration to be described below) described in the embodiment of the disclosure may be, but not limited to, RRC Reconfiguration information. The NW may provide the RRC configurations to the UE by transmitting or forwarding the RRC Reconfiguration information/message, and the UE may establish an RRC connection reconfiguration based on this configuration and may perform the corresponding behavior based on the configuration, for example, performing DL channel measurement and reporting, downlink information reception or the like.

After the UE receives the RRC configurations, if it is default that the UE supports GBBR, or the UE supports GBBR (it is default to support group based second beam reporting) and is configured with the GBBR being started/enabled (for example, “groupBasedBeamReporting-r17” is configured as started) by the NW, the UE performs L1 measurement based on the configuration from the NW. This L1 measurement starts from the reception of the downlink reference signal by the UE. The UE may perform beam sweeping based on the reference signal resource related information (e.g., the reference signal resource configuration) to obtain a measurement result, e.g., a measurement quantity. Optionally, the L1 measurement may be a periodic measurement.

The measurement report is a measurement report corresponding to the first cycle of the GBBR. After the UE receives the RRC configurations, the UE measures the channel quality by sweeping all receive beams, and transmits the corresponding measurement result to the network node. Through this report, the UE may inform the NW of at least two reference signal resources that are supported and can be simultaneously received on the downlink, which may include the measurement result corresponding to at least part of the configured resources. The UE may select which panel to face different TRPs, and inform the TRP that which pair of Tx beams from different TRPs can be received simultaneously. That is, the UE uses a multi-Rx operation. The measurement report includes measurement result reporting that can also be called GBBR. At least two RS resources corresponding to the index pair in this report are RS resources that can be simultaneously received by the UE and correspond to different TRPs.

After completing the reporting of the measurement result corresponding to the first cycle, the UE may perform simultaneous sweeping of multiple beams and perform simultaneous L1 measurement of two reference signal resources, wherein the simultaneous L1 measurement starts from the simultaneous reception of reference signal resources in two resource sets from two TRPs. Since the UE may simultaneously perform the measurement of at least two downlink reference signals corresponding to at least two TRPs, the corresponding measurement result can be transmitted to the network node more quickly. Optionally, the measurement result may be the differential measurement (e.g., differential RSRP value) of the beam.

In the embodiment of the disclosure, the first moment is the latest moment when the UE transmits the measurement result. This first moment is related to a beam sweeping factor. Optionally, the beam sweeping factor may be associated with at least one of the following:
the UE's capability whether to use at least two receive chains to simultaneously receive the at least two downlink reference signals; and
the UE's capability whether to support beam sweeping factor reduction.

Optionally, the transmitting a measurement result to the network node no later than a first moment comprises:
determining, by the UE according to the beam sweeping factor corresponding to at least one of the following capability information, to transmit the measurement result to the network node no later than the first moment:
the UE's capability whether to use at least two receive chains to simultaneously receive the at least two downlink reference signals; and
the UE's capability whether to support beam sweeping factor reduction.

In the embodiment of the disclosure, for a UE with enhanced capabilities, if the UE has the simultaneous downlink reception capability (e.g., the simultaneous RS and RS reception capability or the simultaneous RS reception capability), the UE may simultaneously perform simultaneous sweeping of multiple beams and simultaneously perform measurement on multiple downlink reference signals. Thus, the beam sweeping factor may be reduced. For example, the beam sweeping factor may be reduced from 8 to N1. Optionally, the value of the beam sweeping factor may depend on the UE implementation, and the UE may determine the value of the beam sweeping factor according to its own capability information. Optionally, the beam sweeping factor includes at least two candidate values, for example, multiple candidate values in a certain range; and the UE may autonomously determine to use which candidate value.

Optionally, the beam sweeping factor may be associated with at least one of the following:
the panel configuration of the UE; the UE simultaneously uses at least two active panels to receive at least two downlink reference signals; the spherical coverage of multiple receive panels; the full beam direction coverage of multiple receive panels; the category/type of the UE; and the type of the reference signal.

The beam sweeping factor is a parameter related to the L1 measurement delay related requirement, and is one of the parameters that have the greatest influence on the L1 measurement delay (e.g., L1-RSRP measurement delay). In the related art, in a scenario based on the assumption of one receive panel, the beam sweeping factor N is related to the type of the reference signal and the type of L1 measurement, and the beam sweeping factor is also a parameter related to the L3 measurement delay related requirement, and is one of the parameters that have the greatest influence on the L3 measurement delay (e.g., SS-RSRP measurement delay), as shown in Table A below.

TABLE A

| Type of the L1 measurement | |
|---|---|
| reference signal | Beam sweeping factor N |
| SSB resource | N = 8 |
| CSI-RS in the CSI-RS resource set | N = ceil(maxNumberRxBeam/ |
| configured with repetition on | Nᵣₑₛ_{_{—}}ₚₑᵣ_{_{—}}ₛₑₜ) |
| CSI-RS in the CSI-RS resource set not | N = 1 |
| configured with repetition on | |
| CSI-RS based on CBD | N = 1 |
| Type of the L3 measurement reference | Beam sweeping factor N |
| signal | |
| SSB resource | N = 8 |

where maxNumberRxBeam represents the maximum number of receive beams, and N_{res_per_set} represents the number of resources in the resource set. N=8 corresponding to the SSB resource is based on the assumption that the UE side can only be based on one panel reception.

In the process of performing L1 measurement by the UE, for the assumption based on one panel reception, the UE follows a single beam criterion (which may be abbreviated as per-beam basis) to sweep its Rx beams. That is, only one Rx beam can be swept at the same time, and the constant beam sweeping factor N=8 is used for measurement in a specified fixed and long measurement period.

When the UE uses one Rx chain, in the scenario of simultaneous L1 measurement and L1 measurement, when the reference signals used for measurement in the same serving cell are conflicted on the same OFDM symbol, in order to deal with the conflict and ensure the measurement accuracy requirement, the corresponding measurement restriction requirement is needed, for example, it is necessary to follow the minimum measurement delay requirement. One optional mode may be that the UE switches its Rx chains in a TDM manner and follows the single beam criterion to sweep its Rx beams, and the UE still uses the measurement RSRP based on the constant beam sweeping factor N=8 in a specified fixed and long measurement period.

However, the above sweeping mode will have the problems of low measurement accuracy and reduced throughput. The time between the UE performing measurement and the NW receiving the measurement report is very long. Due to the long report delay, the UE may be in a TCI state with low antenna gain, which is not the best TCI state.

In order to solve at least one of the above problems, for example, to shorten the measurement latency and/or finish the TCI state switching in advance to ensure the accuracy and/or throughput, faster beam switching is a desirable method, that is, the beam switching factor is reduced. In the scheme provided in the embodiment of the disclosure, faster beam switching may make the beam switching factor reduction possible through a multi-Rx chain operation. In the scheme provided in the embodiment of the disclosure, the UE perform per-group beam criterion (may be abbreviated as per-group basis) switching based on the result of GBBR. That is, the UE may perform beam switching by using a group consisting of beam pairs. One beam pair includes different beams from different panels directed to different TRPs.

Based on the GBBR measurement result report, the UE may know the association between Tx beams/SSB resources and TRPs, and may select different panels directed to different TRPs/direction to perform simultaneous reception. Optionally, the UE may simultaneously receive reference signal resource sets/groups (e.g., SSB resource sets/groups) transmitted from multiple TRPs by using the multi-Rx chain. The UE may sweep its Rx beams by using the per-group basis so as to realize faster beam sweeping, and simultaneously perform L1 measurement of at least two TRPs.

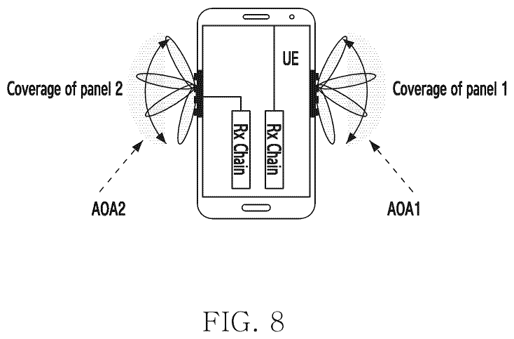

FIG. 8 shows a schematic diagram of principles of multi-panel based downlink reception according to an embodiment of the disclosure.

Referring to FIG. 8, for a UE that supports simultaneous downlink reception, the number of beams to be swept by the UE depends on the number of panels that the UE operates in a time instance (or a timing, a time point). Optionally, the number realized based on the RF panel may be 2, 3, or even more. The UE sweeps beam may be based on the per-group basis instead of the existing per-beam basis, so the number of swept Rx beams may be decreased from N to N1, where N1<8. The specific value of N1 may depend on the UE. For different UEs or different situations, the value of N1 may be varied. By taking the number of panels of the UE being 2 as an example, the value of N1 has the following possible situations:

Situation 1 (best situation): the spherical coverage of the two panels is not overlapped, and each panel may cover half of the full beam direction. At this time, N may be decreased to N/2 at most, that is, N1=4, as shown in FIG. 8.

Other situations: the panel configuration of the UE follows the uncertain mode, and the number of sweeping beams allocated to each panel may also be based on the implementation of the UE (of course, the number of beams corresponding to each panel may also be defined in other agreed ways). In this situation, N may be reduced to X, that is, N1=X, where X depends on the UE implementation or other agreed ways.

It is assumed that different TRPs are linked to different reference signal indexes, and by taking the SSB index as an example, the NW may identify the SSB index of each TRP. If the UE may support simultaneous DL signal reception by using multiple Rx chains, the UE Rx beam sweeping factor N during the reference signal based L1 measurement may be reduced to N1=max [N/2,X]. When the UE performs Rx beam pair sweeping for measurement by using the GBBR result, the UE may sweep Rx beams directed to the corresponding TRPs by using multiple panels at the same time, whereby the number of swept Rx beams may be decreased from N=8 to N1. Based on the latest time of measurement result reporting, the UE adaptively reports the measurement result. The latest time is variable and related to N1.

An embodiment of the disclosure further provides a method for determining how to use N1 to sweep Rx beams under a Multi-Rx chains operation. Optionally, how to perform beam sweeping is based on the UE implementation. Optionally, the UE may determine the specific value of N1; and the UE may determine which beam pair formed by multiple panels can be used for L1 measurement at one time instance. The number of beams included in the beam pair depends on the panels operated by the UE.

An embodiment of the disclosure further provides a method for designing the beam sweeping factor N1. Optionally, if the channel environment or the UE panel implementation is stable, N1 may be statically reported as the UE capability. Optionally, if the channel environment or the UE panel implementation is variable, N1 may be dynamically reported by the NW.

Optionally, the method may further include at least one of the following:

For a known TCI state (at least two TCI states are known), the UE receives a TCI state switch command within a first duration, the first duration being related to a beam sweeping factor.

If at least one of at least two TCI states is unknown, the UE receives a PDCCH based on a target TCI state no later than a second moment, the second moment being related to the beam sweeping factor. By taking two TCI states as an example, in the case of a known dual TCI state switching, based on the longest time (the first duration) for receiving the TCI state switch command, the UE may adaptively receive the TCI state switch command, where the longest time is variable and related to the beam sweeping factor (e.g., N1). Optionally, for the known dual TCI state switching, within X ms, the UE adaptively receives the dual TCI state switch command. Optionally, X=160*N/ms, where N1 is the beam sweeping factor. In the case of the known dual TCI state switching, the UE may receive a PDCCH based on the target TCI no later than a third moment.

In the case of the unknown dual TCI state switching, based on the latest time (second moment) to finish the TCI state switching, the UE may adaptively finish the TCI state switching and use a new TCI state (target TCI state) to receive a PDCCH, where the latest time is related to N1. Optionally, the second moment is related to a second duration, and the second duration is related to the beam sweeping factor (e.g., N1). That is, since the dual TCI state is unknown, the UE needs to take additional time (the second duration) to perform L1-RSRP measurement. The measurement delay is variable and related to N1.

In order to enable the UE to obtain the configuration information more suitable for its capabilities, the method may further include: transmitting UE capability information to the network node. Optionally, upon receiving a UE capability enquiry request from the network node, the UE may transmit the UE capability information to the network node.

Optionally, the UE capabilities may include at least one of the following:
information indicating the UE's capability to simultaneously receive at least two PDSCHs; information indicating the UE's capability to support simultaneous reception of at least two downlink reference signals; information indicating the UE's capability to support group based beam reporting; information indicating the UE's capability to support beam sweeping factor reduction; information indicating the UE's capability to support simultaneous reception of at least one downlink reference signal and at least one downlink data; and information indicating that the UE supports a concurrent measurement gap.

In the wireless communication system, in order to realize accurate and efficient coordination and communication, the NW should know the UE's feature/capabilities. The NW may enquire the UE capabilities by transmitting a UE capability enquiry request (for example, UE capability enquiry information or UE capability enquiry message, e.g., UE capability request information or UE capability enquiry information), and the UE may report its capability information (e.g., UE Capability Information) to the NW. After the NW has known the UE's feature, the NW may make correct scheduling for the UE. The NW may configure the UE (e.g., RRC configuration or RRC reconfiguration) based on the UE capability information reported by the UE. Optionally, the NW may transmit UE capability enquiry information to the UE through an RRC message/signaling, and the UE may report its capability information to the NW according to its feature through the RRC message/signaling.

In the embodiment of the disclosure, if the UE supports one or more simultaneous downlink reception capabilities, the UE capability information transmitted to the NW by the UE may include first indication information corresponding to the supported simultaneous reception capabilities. This indication information indicates that the UE supports at least one kind of simultaneous receptions.

Optionally, the UE capability information may include at least one of first information, second information or third information, wherein the first information is related to the UE's capability to simultaneously receive downlink reference signals, for example, indicating the UE's capability to simultaneously receive at least two downlink reference signals; the second information is related to the UE's capability to simultaneously receive downlink reference signals and PDSCHs, for example, indicating the UE's capability to simultaneously receive at least one downlink reference signal and at least one downlink data; and the third information is related to the UE's capability to simultaneously receive PDSCHs and PDSCHs, for example, indicating the UE's capability to simultaneously receive at least two PDSCHs. Optionally, the third information is a prerequisite for the first information and the second information. In other words, if the UE capability information includes the first information and/or the second information, the UE capability information must include the third information. Alternatively, if the UE capability information includes the first information and/or the second information, it implicitly indicates that the UE must support the capability corresponding to the third information. Since the RS based L1 measurement is to measure the channel quality used for data reception or beam management, it is unnecessary to allow RS simultaneous reception if the data simultaneous reception cannot be ensured.

Optionally, based on the separate design or combined design of new capabilities, the capability information may be reported separately or together. On the premise of reporting the PDSCH+PDSCH simultaneous downlink reception capability, for the separate design, the first information and the second information may be reported separately or together, meaning that the UE supports RS+RS simultaneous reception or RS+PDSCH simultaneous reception or both RS+RS simultaneous reception and RS+PDSCH simultaneous reception. Optionally, each capability may correspond to one respective capability information/information element. For the combined design, when the first information or the second information is reported, it means that the UE supports both RS+RS simultaneous reception and RS+PDSCH simultaneous reception.

The names of the first information and the second information will not be uniquely limited in the embodiment of the disclosure as long as they can represent the simultaneous reception capabilities of the UE. Theoretically, they may be any combination of one or more of characters, field, parameters or numerical values as long as both the network side and the UE know their meanings.

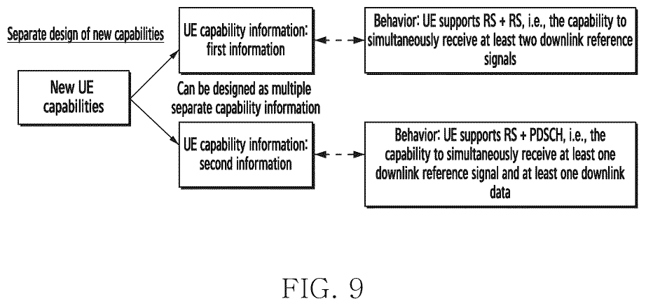

FIG. 9 shows a schematic diagram of a method of separately designing new capabilities according to an embodiment of the disclosure.

Referring to FIG. 9, each piece of capability information of the UE corresponds to one UE simultaneous reception capability conforming to one UE behavior. For example, the RS+RS capability, the RS+PDSCH capability and the PDSCH+PDSCH capability correspond to one capability information (e.g., one information element (IE) or field included in the UE capability information), respectively. Optionally, it may be designed that RS+RS corresponds to the first information and RS+PDSCH corresponds to the second information. If the UE has which simultaneous reception capability, the UE capability information may include the information element corresponding to this capability or the information element of this capability set as a specific identifier (e.g., supported). If the UE does not support this capability, the UE capability information may not include the information element corresponding to this capability or the information element of this capability including a default identifier (e.g., NULL) or set as other identifiers. If the UE simultaneously supports two or more simultaneous reception capabilities, the UE capability information includes multiple information elements corresponding to the at least two simultaneous reception capabilities, which indicate that the UE supports these capabilities.

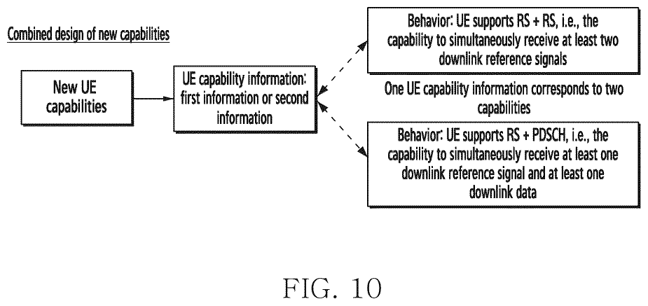

FIG. 10 shows a schematic diagram of principles of the combined design of new capabilities of the UE according to an embodiment of the disclosure.

Referring to FIG. 10, optionally, for the combined design of new capabilities, the information corresponding to multiple capabilities in the UE capability information may be combined indication information. Still by taking multiple simultaneous reception capabilities as an example, at least two of the multiple simultaneous reception capabilities may also correspond to one capability information/information element, and this information element may be set as a different identifier. Different identifiers indicate different simultaneous reception capabilities supported by the UE or the combination of multiple simultaneous reception capabilities supported by the UE. FIG. 10 shows a schematic diagram of a method of combined design of new capabilities, wherein one capability information may correspond to multiple UE simultaneous reception capabilities, and each reception capability conforms to one UE behavior. Optionally, it may be designed that both RS+RS and RS+PDSCH correspond to the first information or the second information.

Optionally, if the UE does not support simultaneous reception, the UE capability information may not include the information element corresponding to the corresponding capability or may include the information element set as a first identifier (e.g., a first value); if the UE supports only the RS+RS simultaneous reception, the RS+PDSCH simultaneous reception or the PDSCH+PDSCH simultaneous reception, this information element may be set as a second identifier, a third identifier or a fourth identifier. If the UE supports multiple simultaneous reception capabilities, this information element may be set as the corresponding identifier. For example, a fifth identifier indicates that the UE supports the RS+RS simultaneous reception and the RS+PDSCH simultaneous reception.

Optionally, the first information satisfies at least one of the following:
the capability to simultaneously receive downlink reference signals from different spatial directions; the capability to simultaneously receive downlink reference signals of different set types; the capability to simultaneously receive different downlink reference signals from the same cell; the capability to simultaneously receive downlink reference signals from different TRPs; the capability to simultaneously receive downlink reference signals from different TRPs of the same cell; the capability to simultaneously receive time-domain overlapped PDCCH/PDSCHs of different types (e.g., the capability to simultaneously receive time-domain overlapped PDCCH/PDSCHs with two QCL TypeD in the multi-TRP scenario); the capability to simultaneously receive downlink reference signals transmitted under one single-component carrier; the RF frequency range of the UE being the set frequency range; the UE being in the RRC connected state currently; the capability to simultaneously receive downlink reference signals used for measurement (e.g., L1 measurement) of the set layer; the capability to simultaneously receive PDCCH/PDSCHs from different TRPs; the UE's capability to support group based beam reporting in multiple TRPs; and the UE's capability to support beam sweeping factor reduction.

Optionally, the second information satisfies at least one of the following:
the capability to simultaneously receive downlink data and downlink reference signals from different spatial directions; the capability to simultaneously receive downlink data and downlink reference signals of different set types; the capability to simultaneously receive downlink data and downlink reference signals from the same cell; the capability to simultaneously receive downlink data and downlink reference signals from different TRPs; the capability to simultaneously receive downlink data and downlink reference signals from different TRPs of the same cell; the capability to simultaneously receive downlink data and downlink reference signals transmitted under one single-component carrier; the RF frequency range of the UE being the set frequency range; the UE being in the RRC connected state currently; the capability to simultaneously receive downlink reference signals used for measurement of the set layer; the capability to simultaneously receive downlink data and downlink reference signals used for measurement of the set layer; and the UE's capability to support group based beam reporting in multiple TRPs.

Optionally, the set types may include different quasi co-location (QCL) TypeD. The set frequency range may include a frequency range FR2, e.g., FR2-1.

It is to be noted that, when the multiple simultaneous reception capabilities use different set values of the same information (e.g., information element) to indicate different simultaneous reception capabilities or the combination of multiple simultaneous reception capabilities, and if the UE capability information reported by the UE includes multiple simultaneous downlink reception capabilities, e.g., RS+RS and RS+PDSCH, at least one item satisfied by the first information and the second information may be included in the same information, and the same information may satisfy at least one item in the combined set of at least one item satisfied by the first information and the second information. In other words, different simultaneous downlink reception capabilities may correspond to different parameter configurations, or may correspond to the same parameter configuration. Optionally, the simultaneous downlink reception may be downlink signal reception of RSs that correspond to the same serving cell, come from different spatial directions, and have different QCL TypeD, or may be downlink reception in a scenario where the UE operates in the FR2-1 frequency band.

Optionally, the first information may be a newly added IE. The name of this IE will not the disclosure. For example, it may be be limited in simultaneousReceptionDiffTypeDRS-r18 (or other names or appellations), hereinafter referred to as IE A. Optionally, this IE may be defined as follows:

| | | | | |
|---|---|---|---|---|
| simultaneousReceptionDiffTypeDRS-r18 | Band | No | Not | FR2 |
| Indicates the support of FR2-1 UEs with simultaneous | | | applicable | only |
| DL reception from different directions with different | | | (N/A) | |
| QCL TypeD RSs assumptions on a single component | | | | |
| carrier for intra-cell scenario in RRC_CONNECTED | | | | |
| state, including the support of | | | | |
| Simultaneous DL reception of reference signals (RSs), | | | | |
| including the following combinations: SSB + | | | | |
| SSB; CSI-RS + CSI-RS; SSB + CSI-RS | | | | |

where No indicates that this IE is an optional information element. If the UE does not support the simultaneous RS+RS downlink reception, the UE capability information reported by the UE may not include this IE. Band represents per-band reporting. FR2 only indicates that this IE is only applicable to the FR2 frequency band.

Optionally, the second information may also be a newly added IE, for example, simultaneousReceptionDiffTypeDRSData-r18, hereinafter referred to as IE B. This IE may be defined as follows:

| | | | | |
|---|---|---|---|---|
| simultaneousReceptionDiffTypeDRSData-r18 | Band | No | N/A | FR2 |
| Indicates the support of FR2-1 UEs with simultaneous | | | | only |
| DL reception from different directions with different | | | | |
| QCL TypeD RSs assumptions on a single component | | | | |
| carrier for intra-cell scenario in RRC_CONNECTED | | | | |
| state, including the support of | | | | |
| Simultaneous DL reception of data and RS, including | | | | |
| the following combinations: SSB + PDSCH/PDCCH; | | | | |
| CSI-RS + PDSCH/PDCCH | | | | |

Optionally, if the UE supports the simultaneous downlink reception of RS+RS of different QCL TypeD from different directions (for example, the UE capability information includes simultaneousReceptionDiffTypeDRS-r18 set as “supported”) or the simultaneous downlink reception of RS+PDSCH, it may also indicate that the UE supports at least one of the following:

the group based L1-RSRP reporting enhancement capability/reporting enhancement capability in the multi-TRP scenario, for example, which may be indicated by the information element mTRP-GroupBasedL1-RSRP-r17; the capability to simultaneously receive time-domain overlapped PDCCHs of two QCL TypeD in the multi-TRP scenario, for example, which may be indicated by the information element mTRP-PDCCH-TwoQCL-TypeD-r17; the concurrent measurement gap capability, for example, which may be indicated by the information element concurrentMeasGap-r17; the group based beam reporting capability (e.g., the RSRP reporting capability of a group formed by at least two reference signals), for example, which may be indicated by the information element groupBeamReporting; the RSRP reporting capability of a group formed by two reference signals, for example, supporting groupBeamReporting; and the simultaneous reception of concurrent reference signals (e.g., SSBs) of different subcarrier spacing types and data, for example, which may be represented by the information element simultaneousRxDataSSB-DiffNumerology or other information.

In other words, when the UE has the capability to simultaneously receive at least two downlink reference signals or the capability to simultaneously receive at least one downlink reference signal and at least one downlink data, it may indicate that the UE also supports the combination of one or more of the above listed auxiliary capabilities. Optionally, the capability to simultaneously receive time-domain overlapped PDCCHs of two QCL TypeD in the multi-TRP scenario may be applicable to UEs having the capability to simultaneously receive at least two downlink reference signals, and the capability of simultaneous reception of concurrent reference signals (e.g., SSBs) of different subcarrier spacing types and data may be applicable to UEs having the capability to simultaneously receive reference signals and data.

Optionally, for the third information indicating that the UE supports simultaneous downlink reception of at least two pieces of downlink data, this information may also be a newly added IE or adopt the existing IE.

The UE may report its capability information according to its capabilities through an RRC signaling. For example, the capability reporting of the UE with a higher capability may be realized by the newly added IE or by redefining the existing IE. For example, if the UE supports the simultaneous reception of at least two reference signals, the UE may transmit, to the NW, information indicating this simultaneous reception capability, for example, the newly added IE A set as “supported”. If the UE reports this capability, it indicates the UE is a UE that supports Multi-Rx simultaneous DL reception. Optionally, the prerequisite for the UE to support this capability may include at least one of the following:
group based beam reporting; simultaneous downlink reception reporting of at least two PDSCHs; supporting the simultaneous L1 measurement based on RSs of the same type; and supporting the simultaneous L1 measurement based on RSs of different types.

Optionally, for a UE that supports the RS+RS simultaneous downlink reception, the UE can receive a CSI-RS/SSB used for L1 measurement in physical resource blocks (PRBs) overlapped with SSBs/CSI-RSs in the same time domain resource (e.g., OFDM symbol), or the UE can simultaneously use a SSB/CSI-RS for L1 measurement on the same OFDM symbol without considering measurement conflicts. Optionally, if the UE does not report the information indicating that it supports the RS+RS simultaneous reception capability, it means that UE cannot perform RS+RS simultaneous reception, and the UE's behaviors can follow the existing measurement restriction to deal with the RS sharing conflict.

Similarly, if the UE supports the simultaneous reception of PDSCHs and reference signals, the UE may include the information indicating this capability in the reported signaling configuration, for example, the newly added IE B set as “supported”. If the UE reports this capability, it means that the UE is a UE that supports the Multi-Rx simultaneous DL reception. The prerequisite may be the group based beam reporting (group based second beam reporting), the simultaneous downlink reception reporting of at least two PDSCHs, and the simultaneous reception based on RSs used for L1 measurement. For a UE that supports this capability, when the RSs used for measurement and PDSCHs are conflicted in the time domain (e.g., the same OFDM symbol), the scheduling restriction on the SSB resource/CSI-RS resource may not be taken into consideration. If the information element is not reported, it means that the UE cannot perform simultaneous reception of RS+PDSCH, and the UE's behaviors may follow the existing scheduling restriction to deal with the transmission conflict between RSs and PDSCHs. The UE follows the existing method for dealing with the conflict in simultaneous transmission of DL signals/channels from different TRPs, for example, the existing method for dealing with the conflict between PDCCHs/PDSCHs and CSI-RSs.

In the embodiment of the disclosure, the effect of designing new capabilities of the UE is to provide a prerequisite to ensure that the UE that supports the multi-Rx operation can support simultaneous L1 measurement and simultaneous L1 measurement and PDSCH reception. The NW may realize accurate corresponding resource scheduling based on the function to be realized.

In the embodiment of the disclosure, the UE capability information may further include capability information indicating that the UE supports the concurrent measurement gap. Optionally, in the inter-cell scenario, if the UE capability information includes the capability to simultaneously receive at least two downlink reference signals, the UE capability information further includes information indicating that the UE supports the concurrent measurement gap. In other words, when the UE supports the simultaneous downlink reception of at least two reference signals, the UE also supports the concurrent measurement gap. Optionally, supporting the concurrent measurement gap includes at least one of the following:
supporting the concurrent measurement gap between multiple receive chains/multiple panels/multiple beams; and supporting the concurrent measurement gap of a single receive chain/panel/beam.

By reporting the UE capability information, the NW may know whether the UE supports the concurrent measurement gap configuration. For example, in the inter-cell scenario, the UE supports the concurrent measurement gap, and the reported UE capability information may further include information indicating that the UE supports the concurrent measurement gap, for example, the second indication information. The specific form of the second indication information will not be limited in the embodiment of the disclosure. If the UE reports this information, the NW may configure one or more measurement gap configurations for the UE. Optionally, if the UE capability information reported by the UE includes the information indicating that the UE has the capability to simultaneously receive at least two reference signals, for example, the first information, the UE capability information may also not include additional information for indicating that the UE supports the concurrent measurement gap because the NW may know according to the first information that the UE supports the concurrent measurement gap.

Optionally, the UE capability information further includes capability information indicating that the UE supports beam sweeping factor reduction. Optionally, if the UE capability information includes the capability to simultaneously receive at least two downlink reference signals and the reference signals are configured as SSBs or CSI-RSs, the UE capability information further includes information indicating that the UE supports beam sweeping factor reduction. That is, when the UE supports the simultaneous downlink reception of at least two reference signals, the UE also supports beam sweeping factor reduction, and the number of reduced beam sweeping factors is N1.

Optionally, by reporting the UE capability information, the NW may know whether the UE supports beam sweeping factor reduction, and know the maximum number N1 of swept Rx beam pairs that can be supported by the UE in the multi-Rx operation. For example, in a case where the channel environment or the UE panel implementation is stable, the UE supports the simultaneous RS+RS reception capability, and the reported UE capability information may further include information indicating the UE supports beam sweeping factor reduction, for example, indication information a (the form of this information will not be uniquely limited in the disclosure). If the indication information also indicates the maximum number N1 of swept Rx beam pairs that can be supported by the UE that supports the multi-Rx operation. The specific form of the indication information a will not be limited in the embodiment of the disclosure. The NW may know the maximum number N1 of swept Rx beam pairs of the UE that supports the multi-Rx operation according to the indication information a.

In the embodiment of the disclosure, the UE capability information further includes related information indicating that the UE supports GBBR, for example, indication information b indicating that the UE supports GBBR. The specific form of the indication information b will not be limited in the embodiment of the disclosure. If the UE reports this information, the NW may know whether the UE supports GBBR. Optionally, the NW may configure a measurement resource parameter corresponding to GBBR for the UE. Optionally, if the UE capability information includes the first information and/or the second information, the UE capability information further includes GBBR, and the enabling of the GBBR capability is a prerequisite for the UE to support the RS+RS simultaneous reception and/or RS+PDSCH simultaneous reception. In other words, if the UE supports the RS+RS simultaneous reception and/or RS+PDSCH simultaneous reception, the UE must support the GBBR capability. Alternatively, if the capability information reported by the UE includes the first information and/or the second information, it may implicitly indicate that the UE supports the GBBR capability.

In the embodiment of the disclosure, if the UE reports to the NW at least one of the first information, the second information, the third information, the capability information indicating the UE supports beam sweeping factor reduction, and the capability information indicating that the UE supports GBBR, the UE is a UE with higher capabilities. Each of such capability information may be indicated separately, or two or more pieces of capability information may be indicated jointly.

Optionally, the specific content of the RRC configuration transmitted to the UE by the NW may depend on the NW, and the configuration may be a configuration matched with or not matched with the capability information reported by the UE. It should be understood that the RRC parameter and CSI resource configuration (CSI-ResourceConfig, i.e., reference signal resource configuration) in the RRC configuration should indicate to transmit which type of reference signals, SSBs or CSI-RSs. In a case where multiple resource sets are configured for the UE, the reference signals in different resource sets may be of the same type or different types. Based on the RRC configuration, the UE may receive downlink reference signals on corresponding resources to perform measurement, and then transmit a measurement result to the NW.

Based on the scheme provided in the embodiment of the disclosure, for a UE that has the RS+RS simultaneous downlink reception capability, for example, in the intra-cell scenario, the UE may simultaneously perform new behaviors of L1 measurement based on at least two downlink reference signals. Optionally, the UE may perform Rx beam pair sweeping for measurement by using the GBBR result. The UE may simultaneously sweep Rx beams directed to corresponding TRPs by using multiple panels. The number of swept Rx beams may be decreased from N=8 to N1 (N1<8). The effect of this method is that: based on the variable N1, the UE may report the result at different times, thus realizing flexibility. That is, based on the latest time of reporting the measurement result (not later than the first time), the UE may adaptively report the measurement result. The latest time is variable and related to N1. The effect of this method is that the measurement result is reported in advance, thus ensuring the measurement accuracy. Optionally, the UE may adaptively reduce the latest time to start reporting the measurement result based on GBBR. Therefore, based on the scheme provided in the embodiment of the disclosure, the beam sweeping can be expedited, and the measurement delay can be shortened, thereby providing a support for finishing the TCI state switching in advance to ensure the accuracy and/or throughput.

For a UE with an enhanced PDSCH+RS simultaneous reception capability, in the scenario 2 shown in FIG. 5, an embodiment of the disclosure provides a method executed by a UE. This method may include the following steps.

In step S1110, a second RRC configuration is received, the second RRC configuration comprising information related to resource scheduling.

In step S1120, when a resource scheduled by the second RRC configuration satisfies a first condition related to scheduling, downlink reference signals and PDSCHs are simultaneously received.

The first condition is related to an overlapping situation of the downlink reference signal and the physical downlink shared channel in time domain. This overlapping situation is the overlapping situation of downlink reference signal resources and PDSCH resources in time domain.

Optionally, the downlink reference signal resources and PDSCH resources include: downlink reference signal resources and PDSCH resources corresponding to at least two TRPs. Optionally, the downlink reference signal resources are reference signal resources used for measurement of the set layer, for example, downlink reference signal resources used for L1 measurement, which may refer to the related description in the above embodiment. The downlink reference signals may include SSBs or CSI-RSs. Similarly, the at least two TRPs may be multiple TRPs in a serving cell, or may be multiple TRPs between serving cells.

For a new requirement for the UE's new behavior of simultaneously performing measurement of the set layer based on at least one downlink reference signal and receiving at least one downlink data in the intra-cell, this method in this embodiment of the disclosure proposes the above new technical solution. Optionally, the NW may configure, based on different timing relationships (overlapping situations) and for the UE, simultaneous scheduling of PDSCHs and RS resources that are overlapped on the same time instance (e.g., the same OFDM symbol). Based on the configuration from the NW, the UE may detect whether at least two resources overlapped on the same OFDM symbol satisfies a timing relationship/first condition, to ensure that PDSCHs and RSs can be simultaneously received. For the convenience of description, in some of the following embodiments, the description will be given by taking the time instance being an OFDM symbol as an example.

The method provided in the embodiment of the disclosure has the following effect: by taking TRP1 and TRP2 as an example, when the UE performs measurement of TRP1, the NW may dynamically schedule resources used for downlink reception of the TRP2, so that the throughput performance can be improved and the effective utilization of resources can be realized. Specifically, based on the method, the UE may simultaneously receive downlink reference signals and PDSCHs on downlink reference signal resources and PDSCH resources that satisfy the above timing relationship (first condition), thereby improving the utilization of system resources. Satisfying the timing relationship may include: downlink reference signal resources and PDSCH resources corresponding to at least two TRPs being at least partially overlapped in the time domain.

Optionally, the first condition may include at least one of the following:
item a: downlink reference signals and PDSCHs are at least partially overlapped in the time domain;
item b: when the second RRC configuration is related to single downlink control information (DCI), downlink reference signal resources and a same PDSCH resource scheduled by the single DCI are located at a same time instance, and the same PDSCH resource includes different parts of the same PDSCH resource corresponding to at least two TRPs; and
item c: when the second RRC configuration is related to multiple DCI, downlink reference signal resources and different PDSCH resources corresponding to different TRPs are located at a same time instance.

Optionally, the item a may be a prerequisite for a resource to satisfy the first condition, that is, satisfying the timing relationship must include the item a.

Optionally, the timing relationship refers to the timing overlapping relationship between PDSCHs and RSs used for L1 measurement on one OFDM symbol. The timing relationship will affect the correct scheduling of resources on the NW side and the successful reception of resources on the UE side. On the NW side, the time relationship is to ensure that simultaneous scheduling is applicable to PDSCH resources of one TRP and RS resources used for L1 measurement, which are overlapped on one OFDM symbol. On the UE side, the timing relationship is to ensure that simultaneous reception is applicable to two resources (a PDSCH and a RS resource used for L1 measurement) overlapped on the same OFDM symbol to realize UE simultaneous measurement and PDSCH reception.

In an optional embodiment of the disclosure, the set layer measurement of at least one downlink reference signal and the reception of at least one downlink data under multiple DCI (mDCI) and single DCI (sDCI) with the multi-Rx operation are considered, the downlink simultaneous reception corresponding to mDCI being the item c and the downlink simultaneous reception corresponding to sDCI being the item b.

For the above item b, there may be only one downlink data (i.e., PDSCH) (the PDSCH scheduled by single DCI), and different parts of the downlink data may be transmitted on multiple different TRPs. By taking two TRPs as an example, the part 1 of the PDSCH is transmitted by the TRP1, the part 2 of the PDSCH is transmitted by the TRP2, and the downlink reference signal is transmitted by the TRP2. It is assumed that the resource of the part 1 of the PDSCH and the resource of the downlink reference signal are overlapped in the time domain. At this time, if the resource of the part 1 of the PDSCH, the resource of the part 2 of the PDSCH and the resource of the downlink reference signal are located at the same time instance, for example, in the same OFDM symbol, it can be considered that the resource of the part 1 of the PDSCH and the resource of the downlink reference signal satisfy the first condition, i.e., satisfying the timing relationship.

For the item c, there are multiple PDSCHs (multiple PDSCHs scheduled by multiple DCIs). By taking two PDSCHs as an example, PDSCH1 is transmitted by the TRP1, PDSCH2 is transmitted by the TRP2, and the downlink reference signal is transmitted by the TRP1. It is assumed that the resource of the PDSCH2 and the resource of the downlink reference signal are overlapped in the time domain. At this time, if the resource of the PDSCH2 and the resource of the downlink reference signal are located at the same time instance, it can be considered that the resource of the PDSCH1 and the resource of the downlink reference signal satisfy the timing relationship.

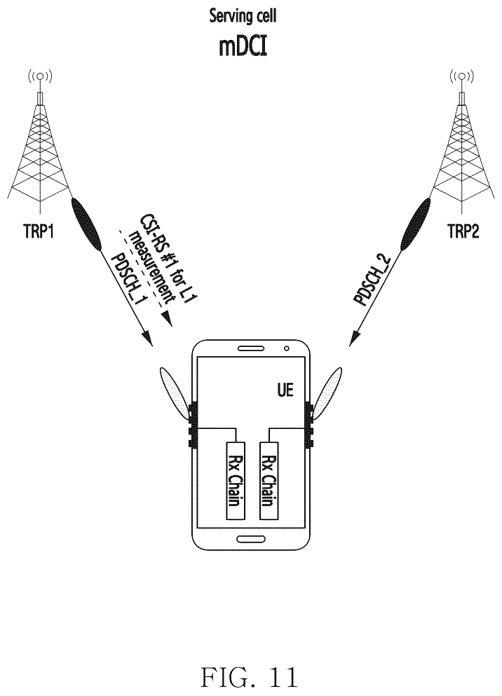

FIG. 11 shows a scenario of simultaneous L1 measurement and PDSCH reception under an intra-cell mDCI multi-TRP multi-Rx chain operation according to an embodiment of the disclosure.

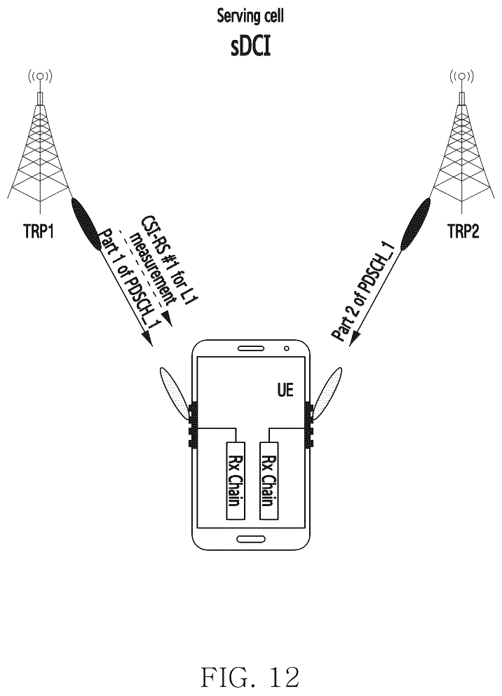

FIG. 12 shows a scenario of simultaneous L1 measurement and PDSCH reception under an intra-cell sDCI multi-TRP multi-Rx chain operation according to an embodiment of the disclosure.

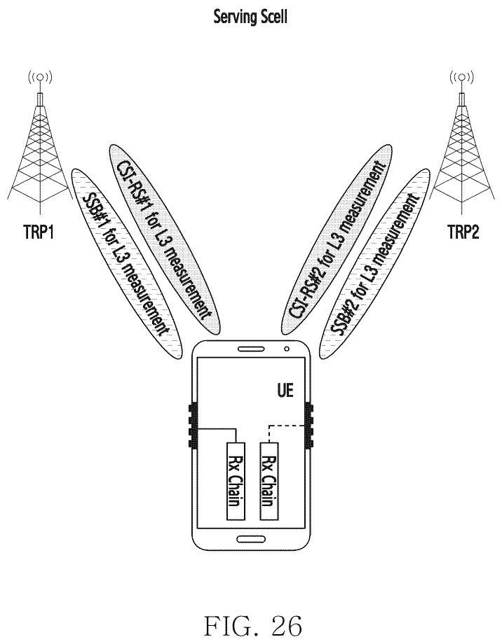

FIG. 26 shows a schematic diagram of principles of simultaneous L3 measurement under an intra-cell/serving cell multi-TRP multi-Rx simultaneous reception according to an embodiment of the disclosure.

As an example, the set layer measurement of at least one downlink reference signal and the reception of at least one downlink data under mDCI and sDCI are as shown in FIGS. 11 and 12.

Referring to FIG. 11, for the mDCI, the UE in the multi-Rx operation expects to simultaneously perform L1 measurement of the TRP1 when performing the downlink PDSCH_2 reception of the TRP2.

Referring to FIG. 12, for the sDCI, the UE in the multi-Rx operation expects to simultaneously perform L1 measurement of the TRP1 when performing the downlink reception of the part 2 of PDSCH_1 of the TRP2.

The embodiment of the disclosure provides different timing restrictions to ensure that the simultaneous L1 measurement and PDSCH reception is suitable for the design method of sDCI and mDCI. Optionally, for the sDCI, since only one PDSCH is transmitted from the network side, each TRP only transmits a part of the same PDSCH. Optionally, the design principle may be that the timing relationship should restrict the RS and two parts of the same PDSCH to be on the same OFDM symbol. Optionally, for the mDCI, two PDSCHs are transmitted from the network side, and each TRP transmits a different PDSCH. Optionally, the timing relationship restrictions corresponding to L1-RSRP measurement and RLM/BFD may be different, and the time allocation of TDMed for RLM resources needs to be avoided. Optionally, the design principle may be that: the timing relationship should restrict two PDSCHs and the reference signal used for calculating L1-RSRP, i.e., the RS used for measurement, as well as two PDSCHs and the reference signal used for calculating RLM. Optionally, for the reference signal used for RLM measurement, the timing relationship should restrict the RS used for RLM from one TRP and the PDSCH from another TRP to be on the same OFDM symbol.

Based on the restriction of the timing relationship, the NW may schedule the UE based on the restriction. Upon receiving the configuration from the NW, the UE may determine, based on the restriction, whether there is a resource satisfying the timing relationship in the configuration; and if so, the UE may perform RS and PDSCH simultaneous reception on the resource satisfying the timing relationship.

Optionally, the method further includes: ensuring other necessary restriction conditions for L1 measurement and PDSCH simultaneous reception, for example, the required mTRP deployment condition and the required QCL restriction. Optionally, the second RRC configuration may further include at least one of the following:
multi-TRP related information corresponding to the simultaneous reception of downlink reference signals and PDSCHs, for example, multi-TRP deployment condition related information corresponding to the RS and PDSCH simultaneous reception, which may also be called mTRP deployment indication restriction; and
QCL requirement related information, for example, different QCL requirement information corresponding to the RS and PDSCH simultaneous reception, which may also called the required QCL restriction.

Optionally, for the mTRP deployment indication restriction, the restriction may be a prerequisite for the applicability of the timing relationship. Optionally, the design principle of the restriction may be the combination of the DCI indication and the group based second beam reporting. The DCI indication determines whether the received PDSCH is one PDSCH or two PDSCHs, and the group based second beam reporting obtains beam pairs which can be simultaneously received. The UE may determine, based on the restriction and the first condition, whether there is a resource satisfying the timing relationship.

Optionally, for the required QCL restriction, the QCL restriction is used for establishing the relationship between the RS used for measurement and the PDSCH pair. Optionally, the design principle of the QCL restriction may be that the RS configured for measurement and the simultaneously received PDSCH pair use a default QCL restriction.

In the above optional embodiment of the disclosure, for the simultaneous L1 measurement and PDSCH reception behaviors of the UE in the intra-cell, the requirements for PDSCH and RS resource scheduling configuration is conditionally expanded. The NW configures PDSCH and RS scheduling resources for the UE according to the timing relationship, and the UE detects whether the two resources satisfy the timing relationship (the first condition) to ensure that the PDSCH and the RS can be simultaneously received. Optionally, the NW may determine based on the timing relationship which RS and PDSCH are overlapped on the same OFDM symbol so as to configure simultaneous scheduling for the overlapped resources. The UE determines based on the timing relationship which RS and PDSCH are overlapped on the same OFDM symbol, and receives the two resources simultaneously.

Similar to the RS+RS simultaneous downlink reception, optionally, before the step S1110, the method may further include: transmitting UE capability information to the network node.

The description of each piece of information included in the UE capability information may refer to the description of the UE capability information in the above embodiment.

For the L3 measurement scenario with multiple TRPs in the service cell, as shown in FIG. 26, the reference signals that are simultaneously measured can be either SSB+SSB or CSI-RS+CSI-RS. As described above, the L3 measurement will occur after L1 measurement filtering, and a measurement reported from L1 to L3 is the best among all receive beams, and how to achieve averaging (i.e., filtering) with multiple samples to report RRM measurements depends on the UE implementation. For the L3 measurement period, one of the most important influential parameters is M_{meas_period_w/o_gaps} or M_{meas_period with_gaps}, which denotes the total number of samples supported during the measurement period without gap configured in the same frequency and with gap configured in the same frequency, respectively, and is related to the beam sweeping factor and the number of samples, and for UE type focused in the embodiment (Power Class 3, PC3), its value is fixed value of 24. Since the beam sweeping factor has been enhanced from N to N1 (N1<8), for PC3, the above two values can be changed to dynamic M_{meas_period_w/o_gaps}=M_{meas_period with_gaps}=3*N1, and the UE can adaptively start the reporting of L3 measurement results in advance based on reported capability information on the beam sweeping factor reduction.

For a BFD scenario in the L1 measurement scenario, the configuration mode between multiple Rx chains may have more diverse and complex conflict situation, including conflicts corresponding to the same TRP and conflicts corresponding to different TRPs. For example, there may be conflicts among the reference signal resource, SMTC occasion (SMTC window) and measurement gap configuration of one chain, or conflicts between any two or three chains, etc. Therefore, in the multi-TRP (taking two TRPs as an example) RS+RS downlink simultaneous reception scenario, in order to accurately detect a beam failure event of two TRPs, it is necessary to provide a corresponding conflict solution. In view of the above problem, an embodiment of the disclosure provides a new communication method. The method may be executed by a UE, and may include the following steps.

In step S1310, a third RRC configuration is received, the third RRC configuration being related to BFD measurement of a set layer.

In step S1320, when the third RRC configuration includes multiple measurement gap related information, a first scaling factor is determined based on the multiple measurement gap related information, the first scaling factor being related to a time domain overlapping situation of at least one of the following information:
a measurement gap occasion, a SSB-based measurement timing configuration (SMTC) window, and a SSB occasion used for BFD.

In step S1330, a link quality evaluation time based on corresponding downlink reference signals from at least two TRPs is determined based on the first scaling factor and/or a beam sweeping factor.

In the embodiment of the disclosure, the same parameter may be abbreviated in uppercase or lowercase. For example, SSB may also be written as ssb, and SMTC may also be written as smtc.

Optionally, the method may be applied to an inter-cell L1 BFD measurement scenario, and the at least two TRPs are multiple TRPs between serving cells. The first time sharing ratio is a first time sharing ratio related to multi-Rx chain multi-TRP transmission. In other words, when the UE simultaneously receives RSs used for L1 BFD measurement corresponding to multiple TRPs, since the BFD measurement related parameters (downlink reference signal resources, MGs and SMTCs) corresponding to the multiple TRPs may be overlapped, a new time sharing ratio is needed to determine the link quality evaluation time corresponding to each TRP. In some of the following embodiments, the description will be given by taking two TRPs and two serving cells as an example.

In order to better satisfy the BFD requirements in the multi-TRP scenario, in the method provided in the embodiment of the disclosure, a new time sharing ratio parameter (first time sharing ratio) is defined to reflect and adapt to the mutual overlapping situation of BFD-SSBs, SMTCs and MGs of different TRPs. The UE may adaptively determine link quality evaluation times corresponding to different TRPs based on this time sharing ratio, and perform BFD corresponding to each TRP based on the determined evaluation time.

The “multiple measurement gap related information” is information related to the first scaling factor. If the RRC configuration from the NW received by the UE includes the information, then for the RS+RS simultaneous reception, the UE may calculate the first scaling factor based on the information and then determine the link quality evaluation time corresponding to each TRP, i.e., the time to perform BFD by the UE. The name of the “multiple measurement gap related information” will not be limited in the embodiment of the disclosure. The information may include information related to multiple MG parameters and related SSB-based SMTCs. For different overlapping conditions of time associated with BFD, the first scaling factor may be different, and the information carried in the multiple measurement gap related information may also be different. Thus, the NW may configure different contents for the UE based on different overlapping situations through the information, and the UE may calculate the corresponding first scaling factor according to the content carried in the information.

The optional implementation of calculating the first scaling factor according to the information in the RRC configuration will be explained in the following embodiments.

For the inter-cell L1 BFD measurement of the UE, in an optional embodiment of the disclosure, the NW may configure multiple measurement gaps (MGs) for multiple inter-cell TRPs according to different beam link qualities. The UE autonomously determines the time sharing ratio (i.e., the first time sharing ratio) among the BFDs, SSB-based measurement timing configurations (SMTCs) and MGs of two TRPs under different mutual timing overlapping relationships. Based on different time sharing ratios and the number of beam sweeping, the UE flexibly determines the advanced expiration timing of radio link failure (RLF) declaration to perform BFD measurement and select the best candidate beam pair. It is to be noted that, for the inter-cell, the UE will have multiple serving carrier frequencies, and MGs are used for inter-frequency measurement and gap-considering intra-frequency measurement.

Optionally, in the embodiment of the disclosure, the UE may adopt a per-group basis beam sweeping mode, and the number of beam sweeping may be the reduced number N1 of Rx beam sweeping. Correspondingly, the UE may determine the link quality evaluation time based on the first time sharing ratio and the beam sweeping factor N1.

The description of the beam sweeping factor N1 may refer to the related description in the above embodiment of RS+RS simultaneous reception and will not be repeated here.

Optionally, the multiple measurement gap related information is related to the beam link quality.

Optionally, the first time sharing ratio is associated with at least one of the following:
the measurement gap (MG) configurations of at least two TRPs; the SSB-based timing configurations (SMTCs) of at least two TRPs; the reference signal time configurations associated with BFD measurement of the set layer of at least two TRPs; the mutual overlapping situation of time occasions of reference signals associated with BFD measurement of the set layer from at least two TRPs; the mutual overlapping situation of time occasions of the reference signal associated with BFD measurement of the set layer from one TRP and the SMTCs and MGs of other TRPs; whether the UE supports the concurrent measurement gap; the UE simultaneously uses at least two active panels to receive at least two downlink reference signals; the UE simultaneously uses at least two active panels to receive at least one downlink reference signal and at least one downlink data; and the overlapping situation among the measurement timing configuration occasions, reference signal resources used for measurement and measurement gaps corresponding to multiple receive chains.

Correspondingly, the “multiple measurement gap related information” may carry the information related to at least one of the above items, and the UE may calculate the first time sharing ratio (i.e., the first scaling factor) based on at least one of the above information configured by the NW. In the application, the name of the “multiple measurement gap related information” will not be limited. Some or all of the information used for calculating the first time sharing ratio can be obtained from the information or calculated according to the information contained in the gap related information. Alternatively, some of the information used for calculating the first time sharing ratio may be obtained based on the gap related information, while some of the information is agreed parameters or values.

In the embodiment of the disclosure, the time sharing ratio (e.g., the first time sharing ratio, the second time sharing ratio, or the third time sharing ratio), i.e., the scaling factor, may be used to determine the measurement period and/or evaluation period designed in the L1 BFD measurement scenario. When there is a conflict (e.g., partially or fully overlap in the time domain) in configuration mode among the reference signal resource used for measurement, the measurement timing configuration occasion (taking SMTC occasion as an example hereinafter, which may also be referred to as SMTC) and the MG corresponding to the L1 BFD measurement, the UE may apply different time sharing ratios to prolong the measurement period or evaluation period so as to deal with the conflict.

Optionally, the time domain overlapping situation related to BFD measurement may include at least one of the following:
the time domain overlapping situation of the measurement gap occasion, the SMTC window and the SSB occasion used for BFD that are configured for a same TRP by the network node;
the time domain overlapping situation of SSB occasions used for BFD that are configured for the at least two TRPs by a network node; and
the time domain overlapping situation of a SSB occasion used for BFD that is configured for one TRP by a network node and measurement gap occasions and SMTC windows that are configured for other TRPs by the network node.

That is, the overlapping situations in the embodiment of the disclosure include the time domain overlapping situation of related parameters (one or more of the measurement gap occasion, the SMTC window and the SSB occasion used for BFD) associated with one TRP, the time domain overlapping situation of the same related parameters of different TRPs, and the time domain overlapping situation of differed related parameters of different TRPs.

Optionally, considering concurrent MG conflicts, i.e., multiple MG conflicts, the possible measurement behaviors of the UE may include: optionally, multiple concurrent MG scenarios are configured, but the UE only performs measurement in the MG scenario with a higher priority and the MG scenarios with lower priorities need to be abandoned; and optionally, multiple concurrent MG occasions are configured, and the UE may perform measurement in two MG scenarios.

As an optional scheme, in the inter-cell, the UE simultaneously perform measurement (e.g., L1 measurement) of a set layer based on at least two downlink reference signals may include: based on the newly defined different time sharing ratio (first time sharing ratio, denoted by P_{TRP_1}) and N1, the UE flexibly determines the advanced expiration time of RLF declaration to perform BFD measurement and select the best beam pair. Optionally, the value range of the first time sharing ratio may be ½ to 1. Considering the multi-Rx simultaneous reception condition, the BFD measurement can be shortened by reducing the value of P_{TRP_1}. Different possible overlapping situations will be specifically described below by specific embodiments.

The optional implementations of the multiple measurement gap configurations in BFD measurement scenarios in the RS+RS simultaneous reception (i.e., simultaneously performing L1 measurement corresponding to different TRPs), RS+PDSCH simultaneous reception and downlink reference signal simultaneous reception scenarios in the disclosure will be specifically described below.

An optional embodiment of the communication method provided in the embodiment of the disclosure will be described below.

Optionally, a UE capability enquiry request transmitted by a network node is received; and in response to the request, a UE reports UE capability information. The UE capability information may include the related information of at least one of the UE capabilities described in the above embodiment.

Optionally, the UE receives RRC configuration information. The configuration information may include at least one of a first RRC configuration, a second RRC configuration and a third RRC configuration. Optionally, the RRC configuration information may include, but not limited to, information related at least one of the following:
an group based beam reporting (group based second beam reporting) capability start indication, for example, the information element “groupBasedBeamReporting-r17” being configured as enabled/started; a reference signal resource configuration; a CSI reporting configuration; a PDSCH resource configuration; a PDCCH resource configuration; multiple measurement gap related information (e.g., at least two measurement gap configurations, at least two SSB-based measurement timing configuration occasions); and a beam sweeping factor reduction indication.

Optionally, the NW may also perform configuration for the UE without UE reporting. For example, the NW has obtained the capability information of the UE when the UE established a connection with the NW last time, and the NW has also stored the capability information of the UE, so that the NW may perform configuration without capability reporting of the UE. If the UE does not support simultaneous downlink reception, the NW should not theoretically configure the UE with resources used for different downlink information reception which are overlapped in the time domain. Optionally, if the UE supports one or more downlink simultaneous receptions and the resources corresponding to the downlink simultaneous reception in the resources configured for the UE by the NW are overlapped in the time domain, the UE may perform simultaneous reception on the overlapped time domain resource; and if these resources are not overlapped, the UE normally receives downlink information according to the configured resources.

Optionally, if the UE supports certain simultaneous downlink reception but the UE only supports simultaneous reception in a case where the resources are partially overlapped, the UE may further report corresponding information to the NW, and inform, through the information, the NW that it only supports simultaneous reception in the case where the resources are partially overlapped, or simultaneous reception in the case where the resources are fully overlapped, or supports the both situations.

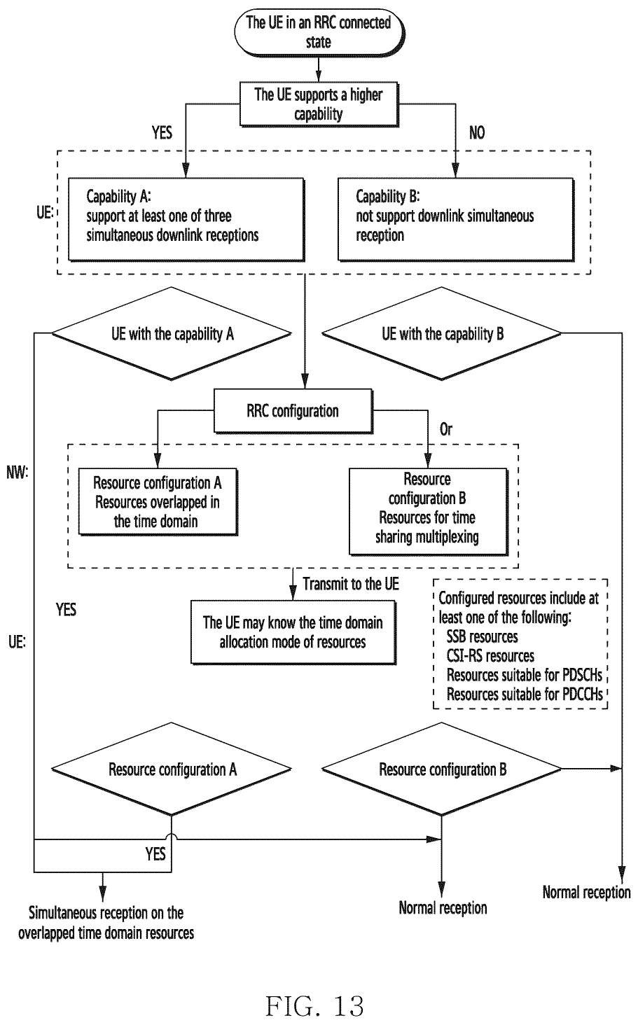

FIG. 13 shows a schematic diagram of principles of receiving downlink information by the UE according to an embodiment of the disclosure. Referring to FIG. 13, for a UE in a RRC connected state, the UE may report its capability information to the NW; for a UE that supports a higher capability, for example, a UE having a capability A, the NW may configure a resource configuration A matched with the capability A for the UE, or may allocate a resource configuration B to the UE; and for a UE that does not support higher capabilities, for example, a UE having a capability B, the NW should allocate the resource configuration B to the UE. For the UE configured with the resource configuration A and having the capability A, on the overlapped time domain resources, the UE may perform simultaneous downlink reception. In other cases, the UE may perform normal reception based on the configuration.

In the embodiment of the disclosure, the RRC configuration information transmitted to the UE by the NW may further include at least one of the group based beam reporting capability start indication, the beam sweeping factor reduction indication, a least two measurement gap configurations or at least two measurement timing configuration occasions. If there is one measurement gap configuration, the measurement gap configuration is applicable to multiple receive chains for simultaneous reception. Alternatively, if there are multiple measurement gap configurations, multiple receive chains for simultaneous reception may correspond to respective measurement gap configurations, or the UE may autonomously determine that the multiple receive chains use the same measurement gap configuration. Similarly, if there is one measurement timing configuration occasion (e.g., SMTC occasion), the one SMTC occasion is applicable to multiple receive chains for simultaneous reception. Alternatively, if there are multiple SMTC occasions, multiple receive chains for simultaneous reception correspond to independent SMTC occasions, or UE may autonomously determine that the multiple receive chains use the same measurement gap configuration.

Optionally, if there are multiple measurement gap configurations and/or SMTC occasions, the measurement gap configurations and/or SMTC occasions corresponding to multiple receive chains for simultaneous reception may depend on the UE. For example, the NW configures two SMTC occasions, i.e., SMTC1 and SMTC2. The UE may perform simultaneous reception on two chains, i.e., chain1 and chain2, and the UE may autonomously determine that which SMTC is used for chain 1 and which SMTC is used for chain 2.

Optionally, the method further includes at least one of the following:
simultaneously receiving at least two downlink reference signals from the network node; simultaneously receiving at least one downlink reference signal and at least one PDSCH from the network node; for intra-cell, simultaneously performing measurement of a set layer based on at least two downlink reference signals; for intra-cell, simultaneously performing measurement of a set layer based on at least one downlink reference signal and reception of at least one PDSCH; and for inter-cell, simultaneously performing measurement (e.g., L1 measurement) of a set layer based on at least two downlink reference signals.

For the simultaneous downlink reception including the RS used for L1 measurement, based on the scheme provided in the disclosure, the UE may determine at least one of the following based on the time sharing ratio and/or beam sweeping factor:
channel quality measurement delay; RLM evaluation delay; BFD evaluation delay; CBD evaluation delay; the longest time to receive the TCI state switch command for the known TCI state; and the time to finish the TCI state switching for the unknown TCI state.

For the measurement result reporting of L1 measurement, the latest time of measurement result reporting is affected by the channel quality measurement delay. The delay can be shortened by the variable and reduced N1 (N1<8), and the UE can adaptively start result reporting in advance based on the reported beam sweeping factor reduction capability information.

In order to satisfy the measurement delay requirements of UEs with different capabilities, an L1 measurement delay related requirement based on the reference signal is newly defined in the embodiment of the disclosure. When performing L1 measurement, the UE may determine the measurement period (e.g., the measurement period corresponding to L1-RSRP) or evaluation period (e.g., the evaluation period of RLM or the evaluation period of BFD, etc.) by using the beam sweeping factor N1 determined based on the newly defined mode. Since N1 is variable, the above periods are dynamic.

Optionally, for a UE that supports simultaneous reception, when the downlink reference signal based by the L1 measurement is a synchronization signal block (SSB), the value of the beam sweeping factor corresponding to the downlink reference signal depends on the UE. When the UE does not have the simultaneous reception capability, N₁=N, and N may be determined through the above Table A based on at least one of the type of the reference signal or the type of the L1 measurement. In other words, the value of the beam sweeping factor may be a fixed value determined based on the above Table A, or may be the variable N₁ determined by the beam sweeping factor reduction capability of the UE. By using the newly defined scheme, the measurement period of SSB-based L1 measurement, the evaluation period of SSB-based RLM and the evaluation period of SSB-based BFD are associated with N₁, and the measurement/evaluation delay will be effectively reduced and flexible.

As an optional scheme, for a UE with a higher capability, by taking L1-RSRP measurement as an example, the measurement period T_{L1-RSRP_Measurement_Period_SSB} of SSB-based L1 measurement may be updated as T_{L1-RSRP_Measurement_Period_SSB} new and may be determined based on Table 1.1 below; the evaluation periods T_{Evaluate_out_SSB_new} and T_{Evaluate_in_SSB_new} of the SSB used for RLM may be determined based on Table 1.2 below; the evaluation period T_{Evaluate_BFD_SSB_new} of the SSB used for BFD may be determined based on Table 1.3 below; and the evaluation period T_{Evaluate_CBD_SSB_new} of the SSB used for CBD may be determined based on Table 1.4 below. Optionally, in the following tables, the beam sweeping factor N₁=max (N/2, X).

TABLE 1.1

| Configuration | T_{L1-RSRP}_{_{—}}_{Measurement}_{_{—}}_{Period}_{_{—}}_{SSB}_{_{—}}_{new} (ms) |
|---|---|
| non-DRX | max(T_{Report}, ceil(M*P*N₁)*T_{SSB}) |
| DRX cycle ≤ 320 ms | max(T_{Report}, ceil(1.5*M*P*N₁)*max(T_{DRX}, |
| | T_{SSB})) |
| DRX cycle > 320 ms | ceil(1.5*M*P*N₁)*T_{DRX} |

where T_{SSB} (also written as T_{ssb}) represents the period configured for the SSB for L1-RSRP measurement; non-DRX indicates that the UE is not configured with discontinuous reception (DRX) or the UE does not support DRX, DRX cycle is a DRX period, and T_{DRX} represents the length of the DRX period. T_{Report} represents the period configured for reporting, i.e., the report period; and M is a parameter related to whether to restrict the channel measurement in the time domain, P is a scaling factor used for the RLM requirement, and Ceil (i) represents an operation of rounding up the number i.

TABLE 1.2

| Configuration | T_{Evaluate}_{_{—}}ₒᵤₜ_{_{—}}_{SSB}_{_{—}}_{new} (ms) | T_{Evaluate}_{_{—}}ᵢₙ_{_{—}}_{SSB}_{_{—}}_{new} (ms) |
|---|---|---|
| no DRX | Max(200, Ceil(10 × P × N₁) × T_{SSB}) | Max(100, Ceil(5 × P × N₁) × |
| | | T_{SSB}) |
| DRX cycle ≤ 320 ms | Max(200, Ceil(15 × P × N₁) × | Max(100, Ceil(7.5 × P × N₁) × |
| | Max(T_{DRX}, T_{SSB})) | Max(T_{DRX}, T_{SSB})) |
| DRX cycle > 320 ms | Ceil(10 × P × N₁) × T_{DRX} | Ceil(5 × P × N₁) × T_{DRX} |

where T_{SSB} represents the period configured for the SSB for RLM, and T_{DRX} represents the length of the DRX cycle.

TABLE 1.3

| Configuration | T_{Evaluate}_{_{—}}_{BFD}_{_{—}}_{SSB}_{_{—}}_{new} (ms) |
|---|---|
| no DRX | Max(50, Ceil(5 × P × N₁) × T_{SSB}) |
| DRX cycle ≤ 320 ms | Max(50, Ceil(7.5 × P × N₁) × Max(T_{DRX}, T_{SSB})) |
| DRX cycle > 320 ms | Ceil(5 × P × N₁) × T_{DRX} |

where T_{SSB} represents the period configured for the SSB for BFD.

TABLE 1.4

| Configuration | T_{Evaluate}_{_{—}}_{CBD}_{_{—}}_{SSB}_{_{—}}_{new} (ms) |
|---|---|
| non-DRX, | Max(25, Ceil(3 × P × N₁ × P_{CBD}) × T_{SSB}) |
| DRX cycle ≤ 320 ms | |
| DRX cycle > 320 ms | Ceil(3 × P × N₁ × P_{CBD}) × T_{DRX} |

where T_{SSB} represents the period configured for the SSB for CBD, and P_{CBD} represents the number of frequency bands in which the UE only performs CBD for the SCell.

In an optional embodiment of the disclosure, for a new requirement for the UE's new behavior of simultaneously performing L1 measurement based on at least two downlink reference signals, the method provided in the embodiment of the disclosure provides a design method of adaptively reducing the longest period of time (i.e., the first duration) to receive the dual TCI state switch command with regard to a known dual TCI state. By taking SSB resources as an example, optionally, the longest period of time starts from the transmission time of the last SSB resource used for beam measurement, and the length depends on the beam sweeping factor. In the case of the reduced beam sweeping factor N1 (N1<8), the longest period of time may be dynamically shortened based on the reported beam sweeping factor reduction capability information. Based on the variable shortened longest period of time, the UE may finish the dual TCI state switching in advance and then quickly perform PDCCH reception by using the selected Rx beam.

The scheme provided in the embodiment of the disclosure also provides a design method of adaptively shortening the latest time to finish the dual TCI state switching with regard to an unknown TCI state (for example, one TCI state is unknown or a dual TCI state is unknown). For the known TCI state switching, the UE needs to perform additional beam sweeping and L1-RSRP measurement to find an available and accurate Rx beam. The measurement delay is T_{L1-RSRP_Measurement_Period_SSB}, i.e., the second duration. By using the variable and reduced N1 (N1<8), the UE may reduce T_{L1-RSRP_Measurement_Period_SSB} to T_{L1-RSRP_Measurement_Period_SSB_new}, quickly and adaptively find an accurate Rx beam pair to finish the dual TCI state switching, and receive PDCCHs by using a new dual TCI state.

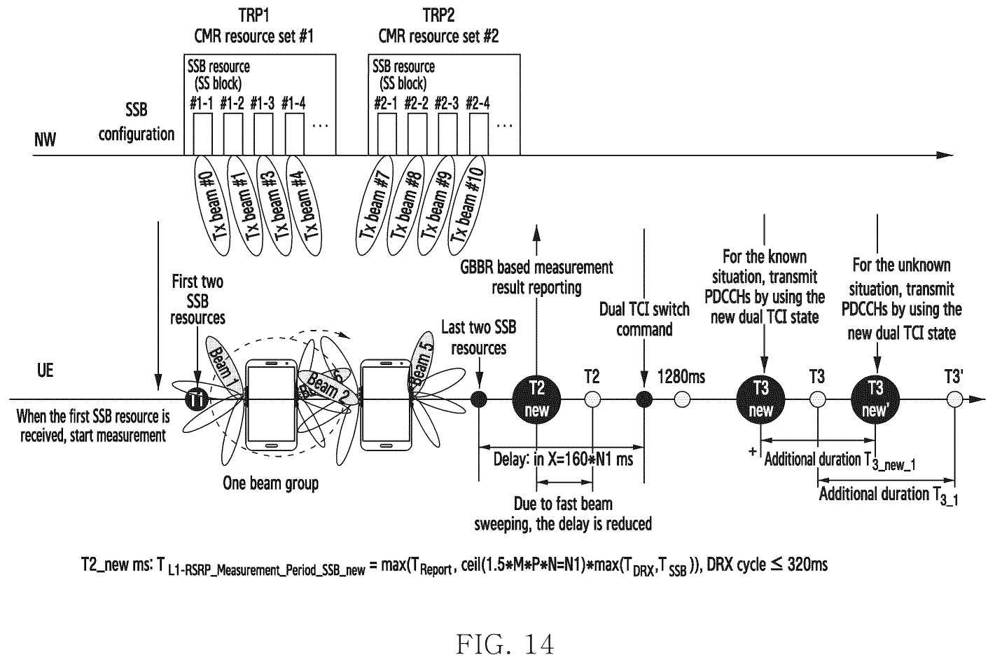

FIG. 14 shows a schematic timeline diagram of simultaneous L1 measurement based on SSB under an intra-cell multi-TRP multi-Rx chain operation according to an embodiment of the disclosure.

Referring to FIG. 14, for a UE with a higher capability, by taking L1-RSRP measurement as an example, FIG. 14 shows a schematic diagram of a new timeline of performing simultaneous L1-RSRP measurement on two TRPs based on SSB based on fast beam sweeping. Referring to FIG. 14, CMR1 resource set #1 is a SSB resource set associated with the TRP1, CMR1 resource set #2 is a SSB resource set associated with the TRP1, and each resource set includes at least one SSB resource. Based on the SSB configuration in the RRC configuration, the UE may know the CMR1 resource set #1 and the CMR1 resource set #2, where #1-1, #1-2 and the like are the indexes of the SSB resources in the CMR1 resource #1, and #2-1, #2-2 and the like are the indexes of the SSB resources in the CMR1 resource #2. In combination with the beam sweeping factor N1 determined based on the new mode proposed in the embodiment of the disclosure and the measurement period of SSB-based L1-RSRP measurement determined based on Table 1.1, the new requirement for the UE's new behavior of simultaneously performing L1 measurement based on at least two downlink reference signals may include:

The latest time to start measurement result reporting is reduced from the fixed long T_{L1-RSRP_Measurement_Period_SSB} (i.e., T₂ shown in the figure) to the variable short T_{L1-RSRP_Measurement_Period_SSB_new} (i.e., T_{2_new} shown in the figure), that is, the UE may transmit the measurement result no later than T_{2_new}.

The longest period of time to receive the dual TCI state switch command is reduced from the fixed long 1280 ms to 160*N1 ms (the first duration).

Regarding the latest time to finish the TCI state switching and receive the PDCCH in the new TCI state (i.e., the target TCI state), for the known TCI state, the latest time is reduced from fixed T₃ to T_{3_new} as shown in the figure; while for the unknown TCI state, the latest time is reduced from fixed T₃′ to T_{3_new}′ as shown in the figure. Particularly, the additional duration for L1-RSRP measurement is reduced from fixed T_{3_1} to variable T_{3_new_1} (the second duration).

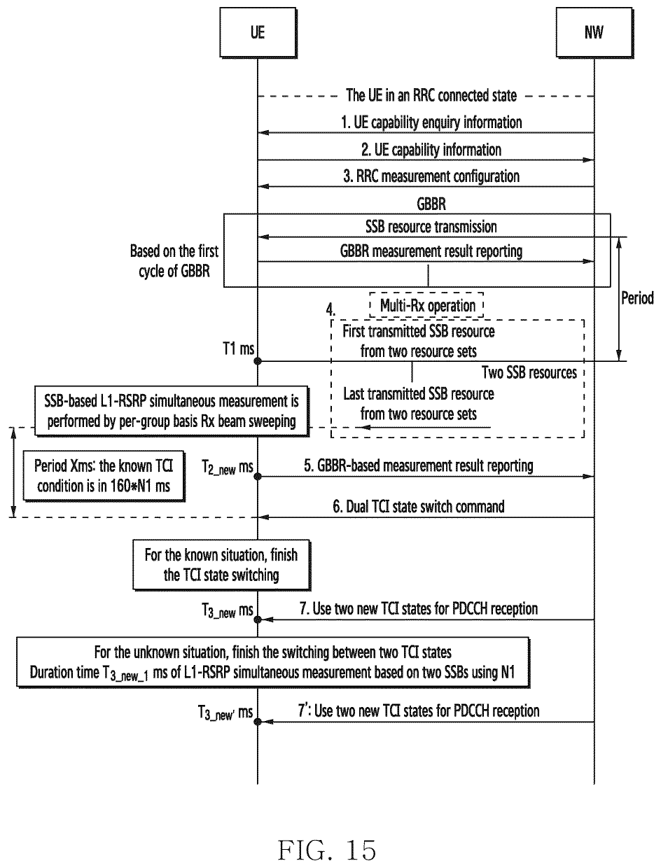

FIG. 15 shows a schematic diagram of principles of simultaneous L1 measurement based on SSB under an intra-cell multi-TRP multi-Rx chain operation according to an embodiment of the disclosure.

In a scenario of simultaneously performing L1 measurement and L1 measurement, the scheme provided in the disclosure will be described below in detail by an optional embodiment. As an example, FIG. 15 shows an overall signal flowchart of the communication between a gNB and a UE in this embodiment. Optionally, in describing an actual implementation or scheme process, the implementation process may include some or all of the following steps.

Referring to FIG. 15, the embodiment may include the following steps.

In step 1, the NW transmits UE capability enquiry information.

In step 2, the UE reports static capability information. The reported UE capability information may include, but not limited, the information of the UE's capability to support beam sweeping factor reduction, the information of the UE's capability to support GBBR, the first information and the third information.

In step 3, the NW configures a measurement parameter, that is, the NW transmits a first RRC configuration, i.e., the RRC measurement configuration shown in FIG. 15. The configured measurement parameter may include, but not limited, a GBBR parameter (e.g., indication information of GBBR enabled), a parameter for the SSB or CSI-RS used for measurement, a CSI reporting parameter or the like.

Upon receiving the measurement parameter, based on the first cycle and period of GBBR, the UE receives a SSB resource based on the configuration, i.e., receiving a SSB and performing measurement, and reports a measurement result to the NW, i.e., transmitting a measurement report. After transmitting the GBBR measurement report, the UE may select a panel to face different TRPs, and then inform the TRP which pair of TX beams from different TRPs can be simultaneously received, that is, the UE uses a multi-Rx operation.

In step 4, in the shown T₁ ms, the UE starts to use two reference signal measurement resources to perform simultaneous L1 measurement. The measurement starts from the simultaneous reception of reference signal resources in two resource sets from two TRPs. The UE performs beam sweeping by using N1 reduced in a per-group basis manner, so as to measurement the channel qualities of two TRPs. Optionally, the reference signal measurement resources may be SSBs, and the channel qualities of the two TRPs may be measured by L1-RSRP.

In step 5, in T_{2_new} ms, the UE adaptively reports the measurement result based on GBBR, i.e., the measurement result corresponding to the simultaneous L1 measurement. Optionally, the UE may transmit the best measurement result, e.g., differential L1-RSRP measurement result, and adaptively report it no later than T_{2_new} ms.

The differential L1-RSRP measurement result includes: the RSRP value corresponding to the index of the best beam (e.g., the beam index corresponding to the maximum RSRP value), and differential RSRP values corresponding to other beam indexes.

In step 6, in X ms, the UE adaptively receives a dual TCI state switch command. Optionally, X=160*N1 ms.

In step 7, when the TCI state is known, the UE uses a new TCI state in T_{3_new} to receive a PDCCH.

In step 7′, when the TCI state is unknown, the UE adaptively uses a new TCI state in T_{3_new}′ to receive a PDCCH. The UE takes an additional duration T_{3_new_1} to perform L1-RSRP measurement. The measurement delay is variable and related to N1.

With reference to Table 1.1, an embodiment of the disclosure further provides a new requirement for the UE's behavior of simultaneously performing L1 measurement based on at least two downlink reference signals under intra-cell. In a case where the UE is defaulted to support the group based beam reporting capability (e.g., the group based second beam reporting capability) or the UE is configured with enabled group based beam reporting (groupBasedBeamReporting-r17=‘enabled’):

the UE can perform L1-RSRP measurement based on SSB resources from two configured resource sets q̅_{0,0} and q̅_{0,1}. For a UE that supports the beam sweeping factor reduction capability and the capability to simultaneously receive at least two pieces of downlink data (i.e., the third information) and uses a multi-Rx operation, the sweeping factor is N1. The measurement period T_{L1-RSRP_Measurement_Period_SSB} of FR2 is enhanced to T_{L1-RSRP_Measurement_Period_SSB_new} (i.e., Table 1.1). The value of N1 may depend on the UE implementation.

Optionally, if the following condition is satisfied, the dual TCI state is known:
the RS resource pair configured for the dual TCI state is in the last 160*N1 ms.

Optionally, if the target TCI state is unknown and when a PDSCH carrying an MAC-CE activation command is received in a slot n, the UE can receive the PDSCH in the target TCI state of the serving cell in a first slot where the TCI state switchingoccurs. That is, the UE receives the PDCCH in the target TCI in a first slot after a slot length of slot n+T_{HARQ}+3Nₛₗₒₜ^{subframe,μ}+T_{L1-RSRP_new}+TOᵤₖ*(T_{first-SSB}+T_{SSB-proc})/NR.

T_{L1-RSRP_new} is the beam refinement time/beam optimization time (i.e., the second duration) in the FR2, and is defined as T_{L1-RSPR_Measurement_Period_SSB_new} in Table 1.1.

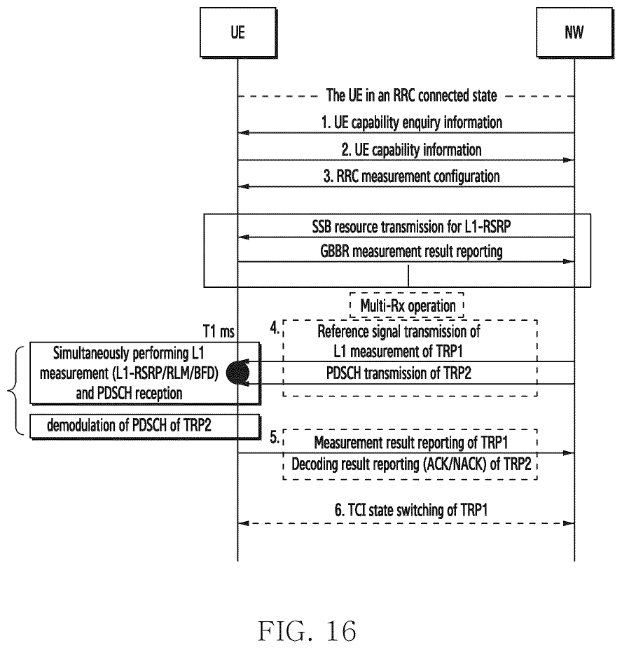

In a scenario of simultaneously performing L1 measurement and PDSCH reception, the scheme provided in the disclosure will be described below in detail by an optional embodiment. FIG. 16 shows an overall signal flowchart of the communication between a gNB and a UE according to an embodiment of the disclosure. Referring to FIG. 16, the embodiment may include the following steps.

In step 1, the NW transmits a UE capability enquiry.

In step 2, the UE reports static capability information. The reported UE capability information may include, but not limited to, the information of the UE's capability to support GBBR capability, the second information and the third information.

In step 3, based on a timing relationship, the NW configures PDSCHs and RS resources scheduled simultaneously, that is, the NW transmits a second RRC configuration to the UE. Optionally, the configuration may include resources satisfying a first condition, i.e., resources satisfying the timing relationship. The configured measurement parameter may further include: a GBBR parameter, an mTRP deployment configuration parameter, etc.

Similar to the process shown in FIG. 15, based on the first cycle and period of GBBR, the UE performs measurement and reporting. After the GBBR measurement reporting, the UE may select a panel to face different TRPs and then inform the TRP which pair of Tx beams from different TRPs can be simultaneously received, that is, the UE uses a multi-Rx operation. The UE may select a panel to perform L1 measurement of TRP1 and another panel to perform PDSCH reception of TRP2.

In step 4, in the shown T1 ms, based on the RS and PDSCH resources satisfying the timing relationship, the UE perform simultaneous L1-RSRP measurement and PDSCH reception.

Specifically, in the step 4, the UE needs to detect whether the two resources satisfy the timing relationship, i.e., determining whether there are an RS resource and a PDSCH resource that satisfy the timing relationship in the resources configured by the NW.
If so: the UE simultaneously receives an RS resource of TRP1 and a PDSCH of TRP2 on the resources satisfying the timing relationship. Based on the two received resources, the UE may perform L1 measurement of TRP1 and simultaneously receive and decode the PDSCH of TRP2.
If not: the UE may perform L1 measurement of TRP1 at the highest priority and interrupt the data reception of TRP2.

In step 5, the UE simultaneously reports the measurement result of TRP1 and the decoding result of TRP2.

Optionally, in the step 5, on the basis that the UE simultaneously performs L1 measurement and PDSCH reception successfully, the UE reports the measurement result of TRP1 and the decoding result of PDSCH of TRP2. For example, the NACK reported through a physical uplink control channel (PUCCH) indicates decoding failure, or reported ACK indicates successful reception.

In step 6, the TCI state of TRP1 is switched. If the channel quality of TRP1 is changed, the UE starts to use a new TCI state of TRP1 for reception.

Next, an embodiment of the disclosure further provides a new requirement for the UE's behavior of simultaneously performing measurement of a set layer based on at least one downlink reference signal and reception of at least one downlink data under intra-cell. Optionally, the new requirement satisfies the following higher layer applicability:

PCell in a single-carrier operation mode of a standalone (SA) NR.

Optionally, in a SDCI mode, when UE configured with twoQCLTypeDforPDCCHRepetition-r17 of ‘fdmSchemeA’ or ‘fdmSchemeB’ or mTRP-PDCCH-TwoQCL-TypeD-r17 or configured to support singleDCI-SDM-scheme-r16 and configured groupBasedBeamReporting-r17 as “enabled”; or, in a mDCI mode, when the UE that supports multiDCI-MultiTRP-r16 is configured with different CORESETPoolIndex and configured groupBasedBeamReporting-r17 as “enabled”, the scheduling restriction related to the UE's behavior of simultaneously performing measurement of a set layer based on at least one downlink reference signal and reception of at least one downlink data under intra-cell may be defined as the following (by taking the reference signal being a CSI-RS and the L1 measurement being L1 RLM measurement and L1-RSRP measurement as an example; the UE in the following situations refers to a UE that supports simultaneousReceptionDiffTypeDRSData-r18 (i.e., the simultaneous reception of downlink reference signals and downlink data):

### With Regard to L1 RLM Measurement:

Situation 1: For the FR2-1 sDCI, the UE is configured to receive two PDSCH transmission occasions (or called two occasions of one PDSCH) from different QCL sources on a PCell. When at least one of the following conditions is satisfied, since it is an RLM operation based on the CSI-RS, there is no scheduling restriction for reception of PDSCH occasions:
The CSI-RS resource is not in the CSI-RS resource set with repetition ON;
The CSI-RS has same QCL source as the active TCI state of one of the PDSCH occasions and has different QCL-TypeD from the other PDSCH occasion;
The CSI-RS and both occasions of the PDSCH are on the same OFDM symbol(s); and
Resources of the active TCI states for the PDSCH have been reported as a resource group in Rel-17 group-based L1-RSRP report.

Note: two PDSCH occasions means two parts of the same PDSCH. For example, the part 1 of the PDSCH and the part 2 of the PDSCH described in the above embodiment.

Situation 2: For the FR2-1 mDCI, the UE is configured to receive two PDSCHs from different QCL sources on a PCell. When the following conditions are satisfied, since it is an RLM operation based on the CSI-RS, there is no scheduling restriction for reception of two PDSCH occasions:
The CSI-RS is not in a CSI-RS resource set with repetition ON,
The CSI-RS has same QCL source as the active TCI state of one of the PDSCHs and has different QCL-TypeD from the other PDSCHs (in the UE active BWP),
The CSI-RS and only one of the PDSCHs with different QCLed typeD are on the same OFDM symbol(s),
Resources of the active TCI states for the PDSCH have been reported as a resource group in Rel-17 group-based L1-RSRP report.

### With Regard to L1-RSRP Measurement:

Situation 1: For the FR2-1 sDCI, the UE is configured to receive two PDSCH transmission occasions (or two occasions of one PDSCH) from different QCL sources on a PCell. When at least one of multiple conditions (the multiple conditions are the same as the conditions in the situation 1 of the L1 RLM measurement) is satisfied, since it is an L1-RSRP operation based on the CSI-RS, there is no scheduling restriction for reception of PDSCH occasions.

Situation 2: For the FR2-1 mDCI, the UE is configured to receive two PDSCHs from different QCL sources on a PCell. When the following conditions are satisfied, since it is an L1-RSRP operation based on the CSI-RS, there is no scheduling restriction for reception of two PDSCH occasions:
CSI-RS is not in a CSI-RS resource set with repetition ON,
The CSI-RS has same QCL source as the active TCI state of one of the PDSCH occasions and has different QCL-TypeD from the other PDSCH occasion,
The CSI-RS and both occasions of the PDSCH are on the same OFDM symbol(s),
Resources of the active TCI states for the PDSCH have been reported as a resource group in Rel-17 group-based L1-RSRP report.

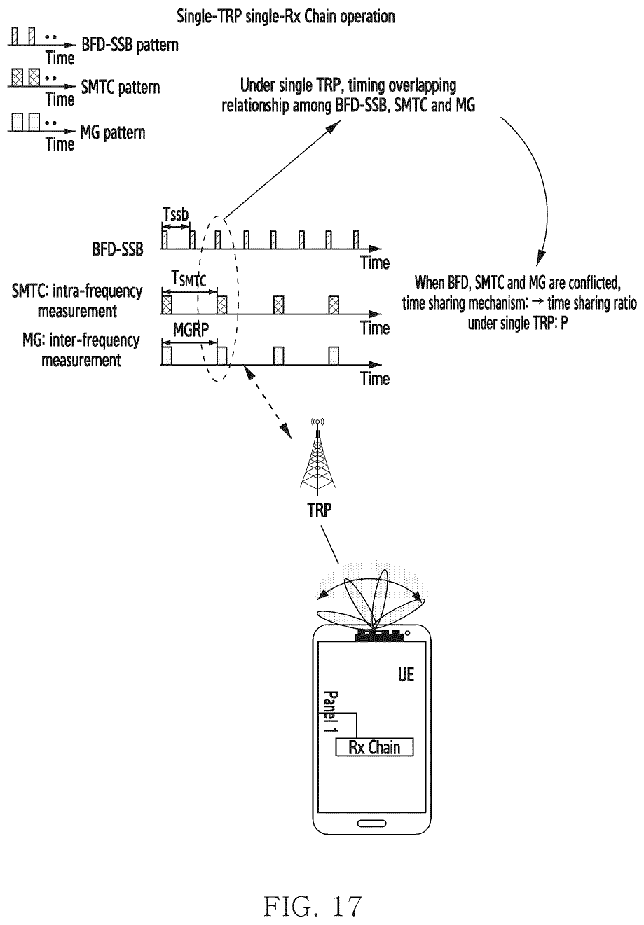

FIG. 17 shows a schematic diagram of principles of the time overlapping relationship among BFD-SSB, SMTC and MG and the corresponding time sharing ratio under an inter-cell single-TRP single-Rx chain operation according to an embodiment of the disclosure.

Referring to FIG. 17, with regard to the L1 BFD measurement, when the UE performs L1 BFD measurement under inter-cell and an MG is configured, the RS resource used for BFD is overlapped with the MG. When BFD is performed, there may be various timing overlapping relationships (time domain overlapping situations) among the SSB used for BFD (BFD-SSB for short), the SMTC window (SMTC occasions, which may also be directly called SMTC) and the MG, thus resulting in different time sharing ratio mechanisms for SSB-based BFRD measurement and affecting the UE BFD measurement behavior. The SMTC is intra-frequency measurement without gap. The UE BFD measurement behavior under single-TRP single-Rx chain is shown in FIG. 17. Based on the assumption that the UE side can only receive based on one panel, the timing overlapping relationship under single-TRP is the timing overlapping relationship among the BFD-SSB, the SMTC window and the MG under single-TRP. If there is a conflict in configuration mode among the measurement period configuration, the SMTC and the measurement gap MGP of the reference signal used for L1 BFD, the UE BFD measurement behavior under different timing overlapping relationships is that: the UE sweeps Rx beams by using a beam sweeping factor N=8 and prolongs the evaluation period to deal with the conflict by applying a scaling factor or scaling factor P, and detects a beam failure in the evaluation period to ensure the measurement accuracy. The scaling factor P is time sharing ratio of a single-TRP. Hereinafter, the scaling factor P used in the scenario based on the assumption of single-TRP single-panel reception is called a second time sharing ratio or second scaling factor.

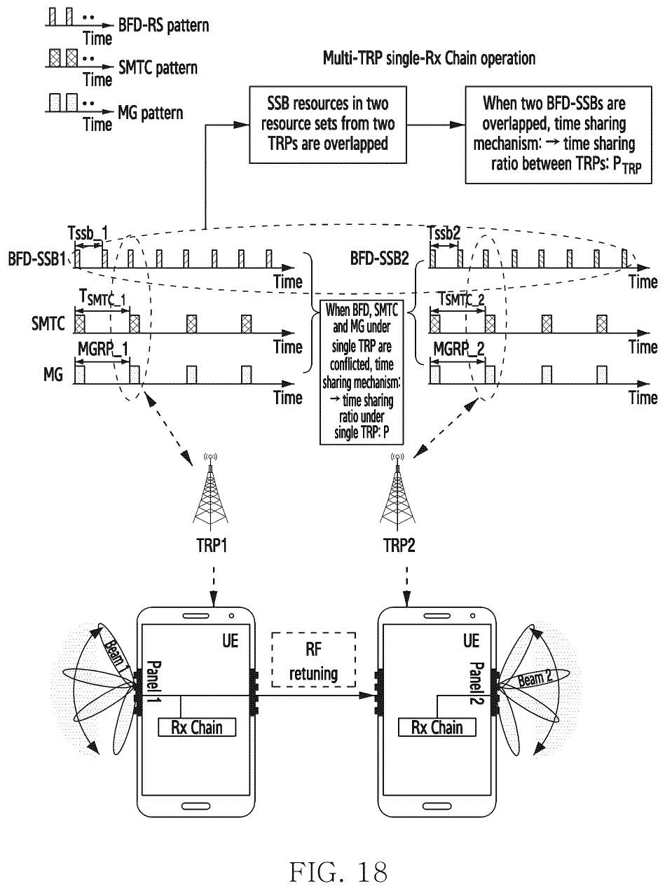

FIG. 18 shows a schematic diagram of principles of the time overlapping relationship among BFD-SSB, SMTC and MG and the corresponding time sharing ratio under an inter-cell multi-TRP single-Rx chain operation according to an embodiment of the disclosure.

Referring to FIG. 18, the UE BFD measurement behavior under multi-TRP single-Rx chain is shown in FIG. 18. Based on the existing assumption that the UE side can only receive based on one panel, the timing overlapping relationship under multi-TRP is the timing overlapping relationship among the BFD-SSB, the SMTC window and the MG under single-TRP, and the timing overlapping relationship between BFD-SSBs under two TRPs. If there is a conflict in configuration mode among the measurement period configuration, the SMTC and the measurement gap MGP of the reference signal used for L1 BFD, the UE BFD measurement behavior under different timing overlapping relationships is that: the UE switches Rx chains in a TDM manner and sweeps Rx beams in a per-beam basis manner (the beam sweeping factor N=8), prolongs the evaluation period to deal with the conflict by jointly using scaling factor P and P_{TRP}, and detects a beam failure of two TRPs in the evaluation period to ensure the measurement accuracy. P_{TRP}=2 is the time sharing ration between two TRPs when the BFD SSBs from two TRPs are overlapped on one OFDM symbol. Hereinafter, the time sharing ratio P_{TRP} used in the scenario based on the assumption of multi-TRP single-panel reception is called a third time sharing ratio or third scaling factor, and the value range of the third time sharing ratio is 1 to 2.

The main problems in the above scenarios are as follows. Firstly, the existing MG configuration only defines a single MG parameter without considering the difference of link quality. However, multiple MG parameters need to be defined to reflect the real overall link quality to ensure the evaluation accuracy. Due to the inappropriate MG configuration, the BFD-SSB measurement occasion of any TRP will be missed, thus resulting in inaccurate measurement, wrong evaluation and reduction in link quality evaluation accuracy. Secondly, the PDCCH or data is transmitted wrongly. Long evaluation latency and slow best candidate beam selection will affect the BFD request time, so that the PDCCH will not be transmitted by the best beam of any TRP and the accuracy of subsequent data transmission cannot be ensured.

In an optional embodiment of the disclosure, under inter-cell, the UE simultaneously performs measurement of a set layer based on at least two downlink reference signals. The set layer may be multiple MGs configured for inter-cell TRPs according to different beam qualities by the BFD UE. The UE autonomously determines the time sharing ratio among BFDs, SMTCs and MGs of two TRPs under different mutual timing overlapping relationships (time domain overlapping situations). The method may include a method of defining different time sharing ratios between two TRPs under four typical mutual timing overlapping relationships. The effect of the method lies in the flexible BFD-RS measurement scenario, so that the overall link quality and the evaluation accuracy can be reflected correctly.

If an FR2 multi-Rx UE with a higher capability is considered, the BFD RSS, MGs and SMTCs configured for two Rx chains by the NW may be independent. At this time, there may be a mode conflict between the two Rx chains. In the case of a multi-TRP multi-MG configuration, the timing overlapping relationship among BFD-RSs, SMTCs and MGs may include: the BFD-RS, SMTC and MG under a single TRP being individually overlapped; multiple SSBs used for BFD under TRPs being overlapped; and the BFD-RSs, SMTCs and MGs under multiple TRPs being mutually overlapped.

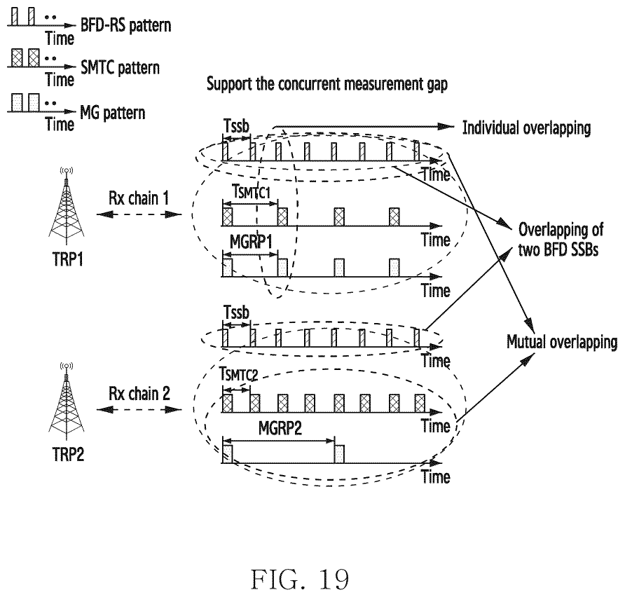

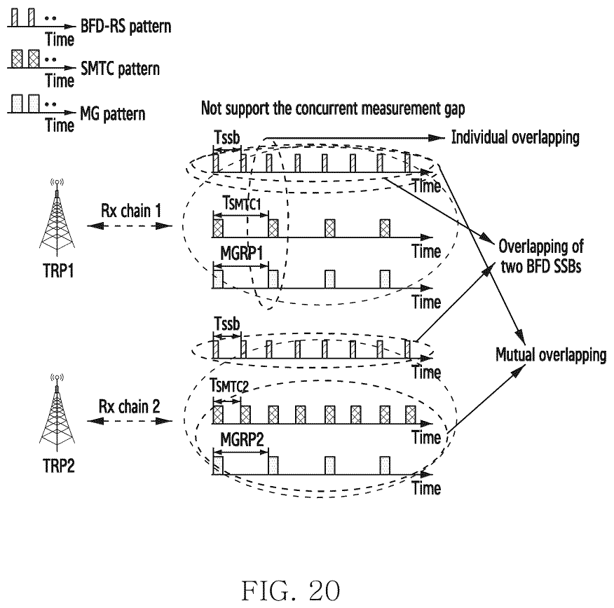

By taking the SSB being the used measurement reference signal as an example, FIG. 19 shows a scenario of individual overlapping and mutual overlapping considering a multi-MG configuration according to an embodiment of the disclosure, and FIG. 20 shows a scenario of individual overlapping and mutual overlapping without considering a multi-MG configuration according to an embodiment of the disclosure. Considering the multi-GM configuration can also be called supporting the concurrent measurement gap. In this configuration, the NW configures different MG parameters for different TRPs (corresponding to different Rx chains), and the MG parameters may include the periodicity, offset, duration or the like of the MG. Not considering the multi-GM configuration can also be called not supporting the concurrent measurement gap. In this configuration, the NW configures the same MG parameter for different TRPs, and the MG parameter may include the periodicity, offset, duration or the like of the MG. Referring to FIG. 19, there is a new timing overlapping relationship among BFD-SSBs, SMTCs and MGs of multiple TRPs. Referring to FIG. 19, the SSB used for BFD configured for TRP1 (corresponding to the receive chain 1) by the NW is not only overlapped with the SMTC and MG of this TRP, and also is overlapped with the SMTC and MG configured for another TRP. This new timing overlapping relationship between TRPs is called a mutual timing overlapping relationship.

Based on different timing overlapping relationships/combinations among BFD-SSBs, SMTCs and MGs from different TRPs, there are four typical mutual timing overlapping situations with or without supporting the multi-MG configuration.

It is to be noted that the L1 measurement is based on the reference signal SSB or CSI-RS. For the evaluation of RLM/BFD, compared with the period range of the SSB, the period range of the CSI-RS is shorter than that of the SSB. In the embodiment of the disclosure, regardless of the L1-RSRP measurement and L1-SINR measurement based on the SSB/CSI-RS or the evaluation of RLM/BFD based on the SSB/CSI-RS, the NW may configure denser SSBs/CSI-RSs or a longer SMTC periodicity. Since the analysis of the SSB and the CSI-RS is similar, by taking SSB-based RLM as an example, possible situations of the configuration combination of the SSB used for RLM, the SMTC occasion and the MG will be analyzed and explained below. Subsequently, schemes for determining the measurement/evaluation period of the reference signal suitable various situations are given. Illustrations of the conflict (gap sharing) among the three configuration modes are provided below. For the situation 1, there is only one illustration; while for the situation 2/3/4, only one illustration is provided since there are many mode conflicts.

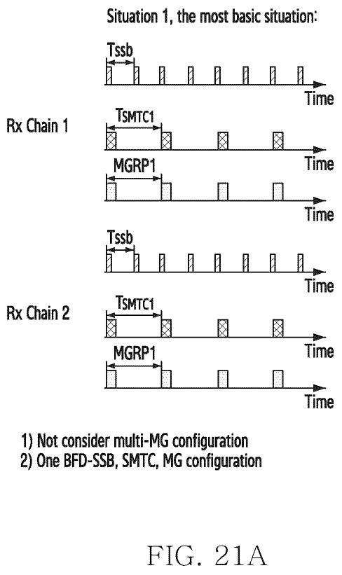

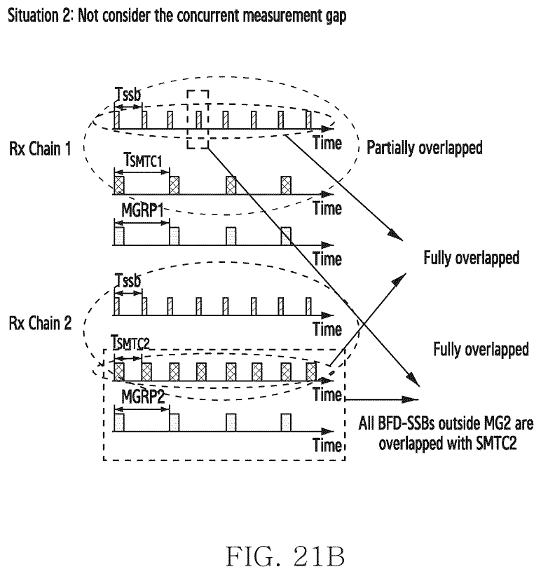

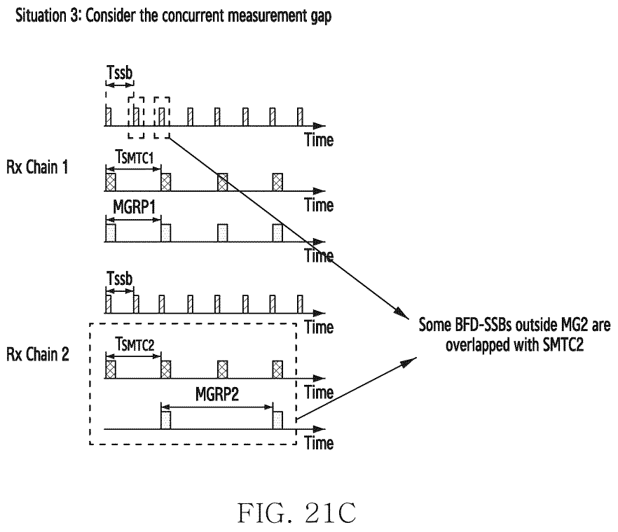

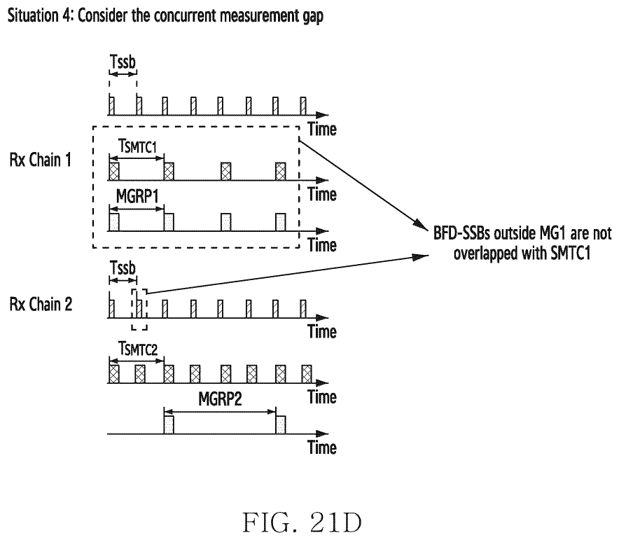

FIGS. 21A, 21B, 21C and 21D are schematic diagrams of several configuration modes according to various embodiments of the disclosure.

Referring to FIGS. 21A to 21D, four possible situations between multi-chain configurations supporting the Multi-Rx operation will be described below. These situations are all based on the intra-cell assumption. Also, it is assumed that the RLM SSB configured by the NW is the same (the same periodicity) and the SSB periodicity is a set duration (e.g., 20 ms), and it may also be assumed that all CCs in the FR2 have the same SMTC offset. Hereinafter, whether the UE supports the concurrent measurement gap (or concurrent measurement gap configuration) will be described by taking whether the UE supports concurrentMeasGap-r17 as an example. In FIGS. 21A to 21D, the horizontal axis represents the time domain (Time), the legends corresponding to Tssb are configuration examples of the SSB resource, and the legends corresponding to T_{SMTC} are configuration examples of the SMTC occasion.

Situation 1: This situation is the most basic situation. As shown FIG. 21A, the NW configures one type of SMTC (SMTC1) parameters for two TRPs, and the UE does not support the concurrent measurement gap, e.g., concurrentMeasGap-r17. That is, one type of MG parameters (MGRP1) is configured. In this case, two chains (receive chain 1 and receive chain 2 in the figure) of the UE correspond to the same SMTC and the same measurement gap.

Situation 2: The NW configures different types of SMTC parameters (SMTC1 and SMTC2) for two TRPs. However, the UE does not support concurrentMeasGap-r17, that is, the UE does not support the concurrent measurement gap. One type of MG parameters are configured (MGPR1 and MGRP2 are the same). Referring to FIG. 21B, the UE is configured with one time gap configuration, and two receive chains use one measurement gap configuration. In this example, for the receive chain 1, the reference signal resource (taking the SSB resource used for BFD as an example) is partially overlapped with the SMTC1 occasion and fully overlapped with the SMTC2 occasion of the chain 2. For the chain 1, all SSB resources outside the measurement gap MG2 are overlapped with the SMTC2 window; while for the chain 2, the SSB resource used for BFD is fully overlapped with the SMTC2 occasion and partially overlapped with the SMTC1 occasion, and all SSB resources outside the measurement gap MG1 are not overlapped with the SMTC1 occasion.

Situation 3: the NW configures different types of SMTC parameters for two TRPs (SMTC1 and SMTC2 are different), and the UE supports concurrentMeasGap-r17. Optionally, the NW may provide multiple measurement gaps (MGs or MGPs for short) through an RRC message, that is, there may be multiple different types of MG configurations. Referring to FIG. 21C, in this example, the UE corresponds to two SMTCs and two MGPs, the chain 1 corresponds to SMTC1 and the measurement gap MG1 (the measurement gap repetition period MGRP1 shown in the figure), and the chain 2 corresponds to SMTC2 and the measurement gap MG2. In this example, the SSB resource of the chain 1 is partially overlapped with the SMTC1 occasion of the chain and also partially overlapped with the SMTC2 occasion of the chain 2; and some SSB resources outside the measurement gap MG2 are overlapped with the SMTC2. For the chain 2, the SSB is partially overlapped with the SMTC2 occasion of the chain and the SMTC1 occasion of the chain 1; and SSBs outside the measurement gap MG1 are not overlapped with the SMTC1 occasion of the chain 1.

Situation 4: the NW configures the same type of SMTC parameters for TRPs, and the UE supports concurrentMeasGap-r17, referring to FIG. 21D. In this example, the UE corresponds to one type of SMTC parameters and two types of MG parameters, the chain 1 corresponds to SMTC1 and the measurement gap MG1 (the measurement gap repetition period MGRP1 shown in the figure), and the chain 2 corresponds to SMTC1 and the measurement gap MG2. For the chain 1, the SSB is partially overlapped with the SMTC1 occasion of the chain and fully overlapped with the SMTC2 occasion of the chain 2; and all SSBs outside the measurement gap MG2 are overlapped with the SMTC2. For the chain 2, the SSB is fully overlapped with the SMTC2 occasion of the chain and partially overlapped with the SMTC1 occasion of the chain 1; and SSB resources outside the measurement gap MG1 are not overlapped with the SMTC1 occasion.

It should be understood that, the above four situations provided in the embodiment of the disclosure are only some of possible situations, and there may be more other situations based on the configuration of the NW, possibly including the conflict among the reference signal resource, the SMTC occasion (SMTC window) and the measurement gap configuration of one chain, or the conflict between any two or all of three chains.

In order to accurately detect a beam failure event of two TRPs, a new time sharing ratio parameter needs to be defined to reflect and adapt to the mutual overlapping situation of BFRD-SSBs, SMTCs and MGs of different TRPs. In view of this problem, a new first time sharing ratio P_{TRP_1} is introduced in the scheme provided in the embodiment of the disclosure to deal with the conflict among the three configurations of Rx chains.

Optionally, first time sharing ratio P_{TRP_1} may be inferred based on different timing overlapping states.

Optionally, for the above situation 2, i.e., the situation shown in FIG. 21B or a partial overlapping situation, P_{TRP_1} may be defined as a third value and may be calculated according to the following equation:

$${P}_{TRP \_ 1} = ( 1 / ( 1 - {T}_{SSB} / {T}_{SMTCperiod} ) + {P}_{sharing factor} / ( 1 - {T}_{SSB} / MGRP ) ) \qquad Equation 1$$

where the item 1/(1−T_{SSB}/T_{SMTCperiod}) is obtained according to the BFD-SSB 2 (the SSB resource associated with the TRP2) being partially overlapped with the SMTC1 and partially overlapped with the MG1; and the item P_{sharing factor}/(1−T_{SSB}/MGRP) is obtained according to the BFD-SSB1 (the SSB resource associated with the TRP1) being fully overlapped with the SMTC2 and partially overlapped with the MG2. T_{SMTCperiod} represents the shortest SMTC periodicity in all carrier components in the same FR2 frequency band, P_{sharing factor} represents a sharing factor among the BFD-RS resource occasion, the SMTC occasion and the MG, and MGRP represents the measurement gap repetition period.

For the situation 3, P_{TRP_1} may be defined as a fourth value and may be calculated according to the following equation:

$${P}_{TRP \_ 1} = ( 1 / ( 1 - {T}_{SSB} / {T}_{SMTCperiod} ) + 1 / ( 1 - {T}_{SSB} / {T}_{SMTCperiod} ) ) \qquad Equation 2$$

For the situation 4, P_{TRP_1} may be defined as a fifth value and may be calculated according to the following equation:

$${P}_{TRP \_ 1} = ( 1 / ( 1 - {T}_{SSB} / MGRP - {T}_{SSB} / {T}_{SMTCperiod} ) + {P}_{sharing factor} / ( 1 - {T}_{SSB} / MGRP ) ) . \qquad Equation 3$$

For BFD, the UE performs SSB measurement in the evaluation period based on the reference signal to evaluate or monitor whether the downlink radio link qualities of two TRPs are lower than the determined threshold. When the evaluation time expires, based on the measurement result, the UE determines whether there is a radio link failure (RLF). The evaluation period is related to the first time sharing ratio P_{TRP_1} determined based on the newly defined mode provided in the embodiment of the disclosure and the beam sweeping factor N1 determined based on the newly defined mode.

For a multi-TRP application scenario, the method of calculating the first time sharing ratio related to multi-TRP multi-chain reception may include, but not limited to, the above calculation scheme provided in the disclosure. For the UE and the NW, the calculation method may be predetermined. For a UE that supports RS+RS simultaneous reception, the UE include multiple BFD measurement related parameters associated with multiple TRPs in the received RRC configuration; and when the MGs, SMTCs and SSB resources corresponding to different TRPs are overlapped, the UE may calculated the first time sharing ratio according to the configuration and the predetermined calculation method, then determines the evaluation time corresponding to each TRP based on the first time sharing ratio, and performs BFD measurement in the corresponding time.

For the above different mutual timing overlapping situations, an embodiment of the disclosure provides the following new requirement definitions of the evaluation period based on the reference signal (taking simultaneous L1 BFD measurement as an example). The method of determining the evaluation period of the reference signal in the SSB-based BFD scenario will be described below with reference to Tables 1 to 2. For Tables 1 to 2, when the UE supports simultaneous downlink reception, N^{Note2}=N₁. Optionally, N₁=max [N/2, X]. If the UE does not support simultaneous downlink reception, N^{Note2}=N, i.e., N determined according to Table A based on the type of the reference signal and the type of L1 measurement. The meanings of other parameters in the tables may refer to the explanations of the same parameters in the above embodiment.

When the UE does not support concurrentMeasGap-r17 and there is no smtc2 in MeasObjectNR, that is, when the NW configures one type of BFD-SSB parameters, one type of SMTC occasion parameters and one type of MG parameters for multiple TRPs, this situation may be regressed to a situation where two SSB resources in the two resource sets q̅_{0,0} and q̅_{0,1} are overlapped on the same OFDM symbol. The measurement period of the SSB used for BFD may be determined based on Table 1 below.

TABLE 1

| Configuration | T_{Evaluate}_{_{—}}_{BFD}_{_{—}}_{SSB}_{_{—}}_{new} (ms) |
|---|---|
| no DRX | Max(50, Ceil(5 × P × N^{Note2} × P_{TRP}_{_{—}}₁) × T_{SSB}) |
| DRX cycle ≤ 320 ms | Max(50, Ceil(7.5 × P × N^{Note2} × P_{TRP}_{_{—}}₁) × |
| | Max(T_{DRX}, T_{SSB})) |
| DRX cycle > 320 ms | Ceil(5 × P × N^{Note2} × P_{TRP}_{_{—}}₁) × T_{DRX} |

For Table 1, the value of P_{TRP_1} may be defined as a first value, e.g., 1; otherwise, the value of P_{TRP_1} is a second value, e.g., 2.

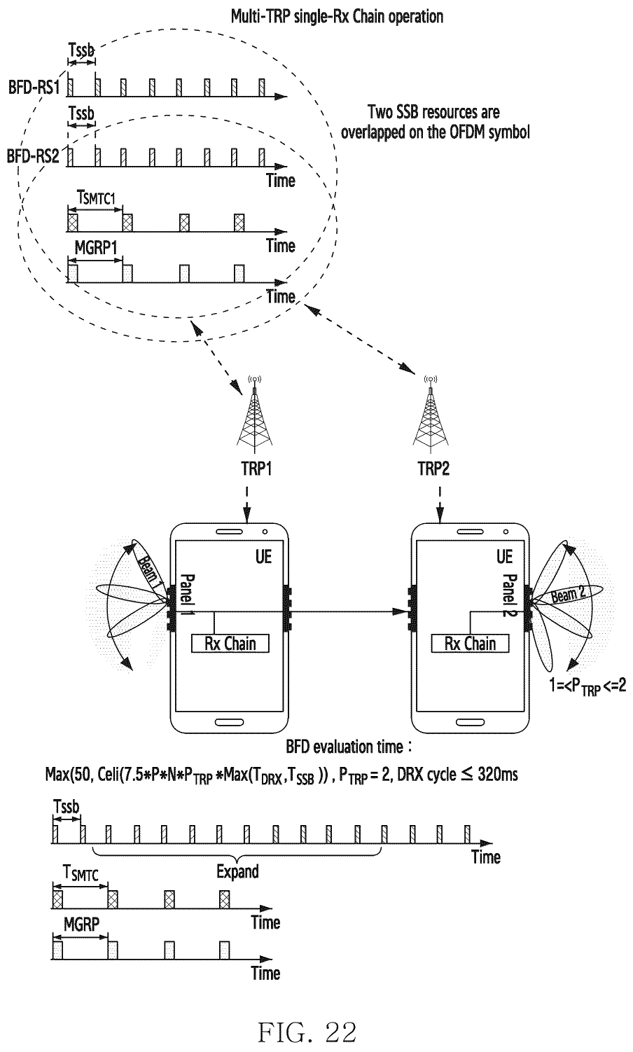

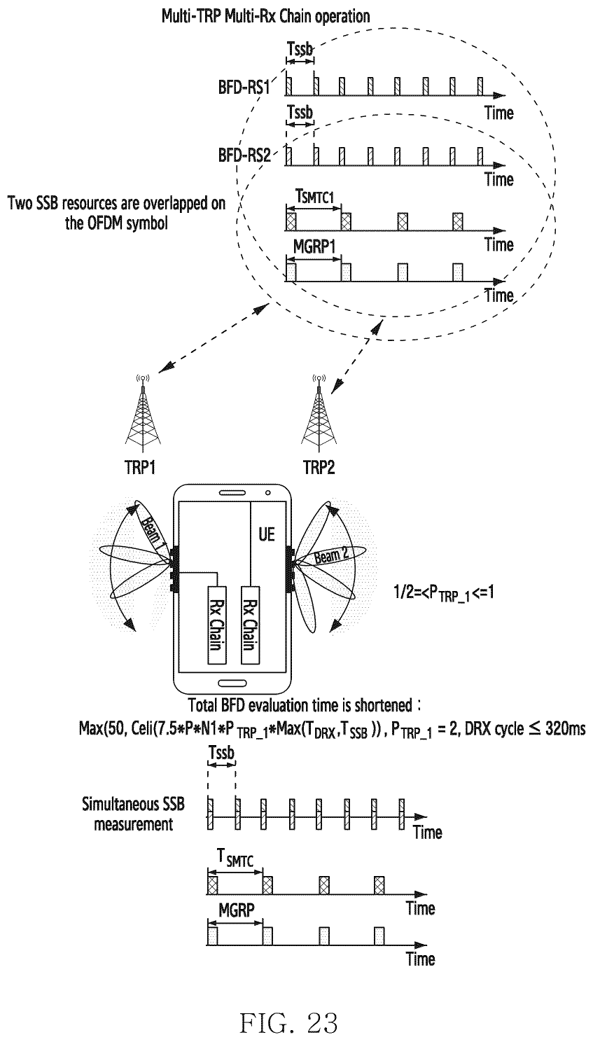

The explanation of defining the value of P_{TRP_1} as the first value (e.g., 1) will be given below with reference to FIGS. 22 and 23. Based on the GBBR reporting, the UE knows the relationship between TRPs and SSB resources, and then may select different panels to correspond to different TRPs for simultaneous reception. Along with the multi-Rx operation, the UE reports the capability to support simultaneous reception of at least two downlink reference signals, and the network simultaneously transmits two BFD SSB resources from two TRPs. The UE may use multiple Rx chains to simultaneously detect BFD SSBs that satisfy different timing overlapping conditions (different timing overlapping situations) and come from corresponding TRPs. Since the UE may perform simultaneous reception on time-domain overlapped resources (OFDM symbols) based on multiple chains and two panels may perform simultaneous processing, the time can be reduced, the first time sharing ratio P_{TRP_1} reflecting the mutual timing overlapping relationship between two TRPs can be reduced. In other words, P_{TRP_1} is less than the original third time sharing ratio P_{TRP}. Further, the overlapping situation of two SSB resources that are overlapped on the same OFDM symbol and come from two resource sets q̅_{0,0} and q̅_{0,1} should be defined as P_{TRP_1}=1.

FIGS. 22 and 23 show the evolution of the time sharing ratio from P_{TRP} to P_{TRP_1} with considering multiple Rx chains simultaneous reception according to various embodiments of the disclosure. Referring to FIG. 22, two BFD SSBs are overlapped in the time domain. However, since the UE can only receive SSBs by using a single panel, in order to measure the link qualities of two TRPs, the detection time of the BFD SSBs needs to doubled, and the time sharing ratio is 2 in the worst case. Referring to FIG. 23, two BFD SSBs are overlapped in the time domain. However, since the UE can simultaneously use two panels for BFD SSB reception and may perform simultaneous measurement, the detection time is not doubled, and the time sharing ratio is 1 in the worst case.

When the UE supports concurrentMeasGap-r17 and there is smtc2 in MeasObjectNR, that is, when there is SMTC2, the measurement period of the SSB used for BFD may be determined based on Table 2 below.

TABLE 2

| Configuration | T_{Evaluate}_{_{—}}_{BFD}_{_{—}}_{SSB}_{_{—}}_{new} (ms) |
|---|---|
| no DRX | Max(50, Ceil(5 \acute{ } P \acute{ } N^{Note2}*P_{TRP}_{_{—}}₁) \acute{ } T_{SSB}) |
| DRX cycle ≤ 320 ms | Max(50, Ceil(7.5 \acute{ } P \acute{ } N^{Note2}* P_{TRP}_{_{—}}₁) \acute{ } |
| | Max(T_{DRX}, T_{SSB})) |
| DRX cycle > 320 ms | Ceil(5 \acute{ } P \acute{ } N^{Note2}* P_{TRP}_{_{—}}₁) \acute{ } T_{DRX} |

For Table 2, if the UE supports downlink simultaneous reception, the value of P_{TRP_1} may be defined as ½×P_{Rx2_case2}; otherwise, the value of P_{TRP_1} is P_{Rx2_case2}. The P_{Rx2_case2} may be applied to a scenario where there may be a configuration conflict in the above situation 3 or 4. Optionally, this value is related to the configuration conflict among BFD-SSB resources, SMTCs and MGs of two chains.

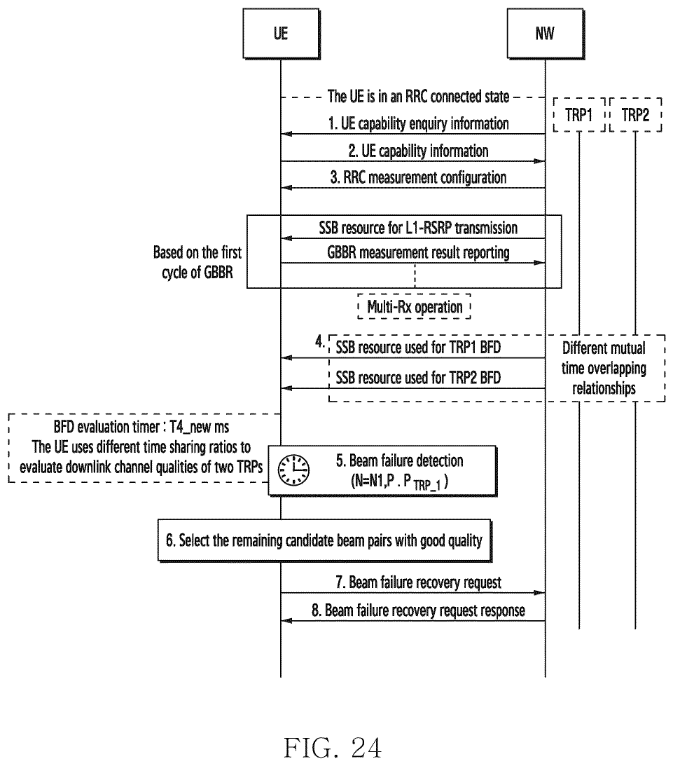

An optional embodiment of the disclosure further provides a process of new BFD simultaneous measurement based on a new time sharing ratio P_{TRP_1} under inter-cell. As an optional implementation of the embodiment of the disclosure, FIG. 24 shows a schematic diagram of a SSB-based BFD process, showing an overall signal flowchart of the communication between a gNB and a UE according to an embodiment of the disclosure. Referring to FIG. 24, the embodiment may include the following steps.

In step 1, the NW transmits UE capability enquiry information.

In step 2, the UE reports static capability information. The reported UE capability information may include, but not limited to, the information of the UE's capability to support GBBR, the information of the UE's capability to support beam sweeping factor reduction, the first information and the third information.

In step 3, the NW performs measurement parameter configuration, that is, the NW transmits an RRC configuration to the UE. The resource configuration configured for the UE by the NW may include, but not limited to, at least one of the RS resource for BFD measurement and multiple measurement gap related information. The multiple measurement gap related information includes multiple MG parameters (concurrentMeasGap) and corresponding SMTC parameters (smtc1 and smtc2).

Based on the first cycle and period of GBBR, after the GBBR measurement reporting, the UE may select a panel to face different TRPs and then inform the TRP which pair of Tx beams from different TRPs can be simultaneously received, and the UE may select one panel to perform L1 measurement of TRP1 and another panel to perform L1 measurement of TRP2. In other words, the UE uses a multi-Rx operation.

In step 4, the NW transmits different SSB resources of multiple TRPs under multiple MG parameters with different mutual timing overlapping relationships.

In step 5, the UE performs L1 measurement requiring beam sweeping N1 by using different time sharing ratios corresponding to different timing relationships.

Based on the newly defined method of dealing with the configuration conflict among the period of the reference signal, the SMTC occasion and the measurement gap configuration suitable for one chain and multiple receive chains provided in the embodiment of the disclosure, the UE may determine the evaluation period corresponding to each TRP and may perform periodic evaluation based on the evaluation period and an evaluation timer. Optionally, the UE performs BFD measurement by combining N based on the per-group basis sweeping with the time sharing ratio P and the new first time sharing ratio P_{TRP_1}. Along with the simultaneous reception, the value of P_{TRP_1} reflecting the mutual timing overlapping situation between TRPs can be reduced, so that the evaluation time can be reduced. The UE takes the reduced evaluation time (e.g., T_{Evaluate_BFD_SSB_new} newly defined in Table 1 or 2, corresponding to T_{4_new} shown in FIG. 24) to perform beam failure SSB detection of the two TRPs. Under the new timing overlapping relationship, it is estimated or monitored in T_{4_new} ms whether the downlink channel qualities of the two TRPs are lower than a specific threshold.

Optionally, if the reference signal resource used for BFD is a SSB resource, the evaluation period T_{Evaluate_BFD_SSB} corresponding to BFD may be determined by using the tables for evaluation period determination suitable for the BFD scenario in the above embodiments. If the reference signal resource used for BFD is a CSI-RS resource, the CSI-RS evaluation period T_{Evaluate_BFD_CSI-RS} corresponding to BFD may be determined by using the tables suitable for the BFD scenario in this embodiment and following embodiments.

In step 6, the UE selects another candidate beam pair with good quality.

In step 7, the UE transmits a beam pair recovery request.

In step 8, the NW transmits a BFR response.

An operation scheme for determining the measurement period or evaluation period of the reference signal in various L1 measurement scenarios based on the CSI-RS will be described below.

Tables 3 to 5 are methods of determining the evaluation period of the reference signal in the CSI-RS-based BFD scenario. For the CSI-RS-based BFD scenario, when the UE does not support concurrentMeasGap-r17 and there is no SMTC2 in MeasObjectNR, or when the UE supports concurrentMeasGap-r17 and there is no SMTC2 in MeasObjectNR, the measurement period of the CSI-RS used for BFD may be determined by Table 3. When the UE supports concurrentMeasGap-r17 and there is SMTC2 in MeasObjectNR, the measurement period of the SSB used for CSI-RS may be determined by Table 4 below. When the UE supports concurrentMeasGap-r17 and there is s SMTC in MeasObjectNR, the measurement period of the SSB used for CSI-RS may be determined by Table 5 below. T_{CSI-RS} in Tables 3 to 5 is the period of the CSI-RS resource used for BFD.

TABLE 3

| Configuration | T_{Evaluate}_{_{—}}_{BFD}_{_{—}}_{CSI-RS}_{_{—}}_{new} (ms) |
|---|---|
| no DRX | Max(50, Ceil(M_{BFD} × P × N × P_{TRP}_{_{—}}₁ × P_{BFD}) × |
| | T_{CSI-RS}) |
| DRX cycle ≤ | Max(50, Ceil(1.5 × M_{BFD} × P × N × P_{TRP}_{_{—}}₁ × P_{BFD}) × |
| 320 ms | Max(T_{DRX}, T_{CSI-RS})) |
| DRX cycle > | Ceil(M_{BFD} × P × N × P_{TRP}_{_{—}}₁ × P_{BFD}) × T_{DRX} |
| 320 ms | |

Where P_{BFD} represents the number of frequency bands in which the UE only performs BFD for the SCell. If the CSI-RS resource used for BFD in the resource set q̅₀ is transmitted on a bandwidth of ≥24 PRBs at a density of 3, M_{BFD}=10. For Table 3, when the UE supports simultaneous downlink reception (e.g., supporting simultaneousReceptionDiffTypeDRS-r18), the value of P_{Rx} is defined as a sixth value; otherwise, the value of P_{Rx} is a seventh value.

TABLE 4

| Configuration | T_{Evaluate}_{_{—}}_{BFD}_{_{—}}_{CSI-RS}_{_{—}}_{new} (ms) |
|---|---|
| no DRX | Max(50, Ceil(M_{BFD} × P_{TRP}_{_{—}}₁ × N × P_{BFD}) × T_{CSI-RS}) |
| DRX cycle ≤ | Max(50, Ceil(1.5 × M_{BFD} × P_{TRP}_{_{—}}₁ × N × P_{BFD}) × |
| 320 ms | Max(T_{DRX}, T_{CSI-RS})) |
| DRX cycle > | Ceil(M_{BFD} × P_{TRP}_{_{—}}₁ × N × P_{BFD}) × T_{DRX} |
| 320 ms | |

For Table 4, when the UE supports simultaneous downlink reception (e.g., supporting simultaneousReceptionDiffTypeDRS-r18), the value of P_{TRP_1} is defined as ½×P_{Rx2_case3}; otherwise, the value of P_{TRP_1} is P_{Rx2_case3}. The value of P_{Rx2_case3} may be related to the configuration conflict among the CSI-RS resources used for BFDs, SMTCs and MGs of two Chains.

TABLE 5

| Configuration | T_{Evaluate}_{_{—}}_{BFD}_{_{—}}_{CSI-RS}_{_{—}}_{new} (ms) |
|---|---|
| no DRX | Max(50, Ceil(M_{BFD} × P_{TRP}_{_{—}}₁ × N × P_{BFD}) × T_{CSI-RS}) |
| DRX cycle ≤ | Max(50, Ceil(1.5 × M_{BFD} × P_{TRP}_{_{—}}₁ × N × P_{BFD}) × |
| 320 ms | Max(T_{DRX}, T_{CSI-RS})) |
| DRX cycle > | Ceil(M_{BFD} × P_{TRP}_{_{—}}₁ × N × P_{BFD}) × T_{DRX} |
| 320 ms | |

For Table 5, when the UE supports simultaneous downlink reception, the value of P_{TRP_1} is defined as ½×P_{Rx2_case4}; otherwise, the value of P_{TRP_1} is P_{Rx2_case4}. The value of P_{Rx2_case4} may be related to the configuration conflict among the CSI-RS resources used for BFDs, SMTCs and MGs of two Chains.

For the above Tables 1 to 5, in the inter-cell scenario, upon receiving the configuration from the NW, the UE may simultaneously receive at least two downlink reference signals from the network node based on the configuration; may determine, based on the configuration from the NW, whether to support DRX, and determine to use which table, the value of the first time sharing ratio and the value of N^{note2} according to the reference signal resource related configuration, the SMTC occasion related configuration (how many SMTCs are configured) and the measurement gap related configuration (how many measurement gaps are configured) in the configuration as well as the related content in the UE capability (e.g., whether to support simultaneous reception, whether to support the concurrent measurement gap, and the number of UE active panels, i.e., whether the UE can simultaneously use two panels for downlink reception); and may calculate the measurement period and the evaluation period based on the determined values and tables, and thus may perform periodic measurement according to the measurement period and perform periodic evaluation according to the evaluation period.

In addition, even if the UE have multiple panels and have higher capabilities, for example, the simultaneous downlink capability (e.g., supporting the simultaneous downlink reception of reference signals of different DCL TypeD from different directions), in some scenarios, the UE may not be able to perform simultaneous reception. For example, in some cases, multiple panels (or multiple receive chains) of the UE may not be able to operate simultaneously. In other words, the UE may have only one panel for downlink reception, that is, the UE has only one active panel. At this time, the UE should also consider this factor during the measurement process based on the reference signal and the determination of the measurement period and the evaluation period. For example, the UE satisfies the condition of operating few panels simultaneously (or the UE satisfy the condition of being unable to simultaneously activate multiple panels to operate). For example, the electric quantity of the UE is less than a threshold, or the operating mode of the UE is a specific mode (power saving mode). At this time, the UE has one operating panel. In this situation, the UE may determine the measurement period and the evaluation period by the existing handling method based on the single-panel assumption.

Optionally, in a situation where the UE has a higher capability but may not be able to perform simultaneous reception, the number of panels of the UE that are currently in an active state or whether the UE satisfies a condition of activating multiple panels can be further considered. This condition may be agreed. In other words, whether multiple panels of the UE can simultaneously operate currently can also be interpreted as the number of receive chains of the UE that are currently in an active state. If the UE has the simultaneous downlink reception capability but multiple panels of the UE cannot simultaneously operate normally at present due to other factors, optionally, the UE may return to the mode based on the single-receive chain/single-panel assumption (the UE capability is regressed to the single-panel reception capability), and the UE may perform the corresponding operation according to the scheduling restriction or measurement restriction of the UE measurement behavior based on the single-panel assumption.

Optionally, if the UE does not satisfy the condition of operating at least two panels simultaneously, the UE cannot perform simultaneous downlink reception at this time, and the UE may perform the corresponding operation based on the existing scheduling restriction requirement based on one receive panel assumption. Not satisfying the condition of operating at least two panels simultaneously may mean that the UE supports simultaneous downlink reception but does not satisfy this condition, or may mean that the UE has only one receive panel. If the UE may perform simultaneous downlink reception on multiple chains currently and the resources used for downlink information transmission are overlapped in the time domain, the UE may perform multi-Chain simultaneous reception on the overlapped resources based on the scheme provided in the embodiment of the disclosure.

An embodiment of the disclosure provides a new communication scheme in a scenario where the UE may support a higher capability. Based on the newly defined improvements of the UE in the measurement/evaluation behavior requirement provided in the optional embodiment of the disclosure (e.g., the newly defined improvement of the related requirement of the reference signal based L1 measurement delay, the newly defined improvement of the reference signal based evaluation period requirement or the like in the above embodiment), regardless of a UE that supports a higher capability or a UE that does not support a higher capability, the measurement/evaluation requirement of the UE can be satisfied.

The newly defined improvements of the UE in the measurement/evaluation behavior requirement provided in the optional embodiment of the disclosure can better solve the conflicted configuration problems between chains and in chains when the UE with a higher capability supports multi-panel/multi-Chain simultaneous reception, so that the evaluation period requirement and the measurement period requirement can be satisfied regardless of the conflicts among RS resources, MGPs and SMTC occasions in chains or the conflicts among RS resources, MGPs and SMTC occasions between chains. Moreover, in a scenario of supporting multi-Rx UE multi-AoA simultaneous reception, the new measurement restriction and scheduling restriction are more applicable.

Optionally, when the UE performs CSI measurement and reporting, the measurement period in which the UE performs CSI measurement may be determined by the existing method of determining CSI measurement period, or the measurement period to be used in the CSI measurement and reporting process may be determined by the above newly defined scheme for determining the channel quality measurement period provided in the disclosure, for example, the methods of determining the measurement period in the SSB/CSI-RS based L1 measurement process included in the above tables such as Tables 1 to 5, Table 1.1, Table 1.2 and Table 1.3.

An embodiment of the disclosure further provides a method executed by a network node in a wireless communication system. The method may comprise steps of: transmitting a UE capability inquiry request to a UE; and receiving UE capability information transmitted by the UE, and performing radio resource control (RRC) configuration based on the UE capability information, wherein the UE capability information includes information related to at least one of the following:
the capability to simultaneously receive at least two downlink reference signals; the capability to simultaneously receive at least one downlink reference signal and at least one downlink data; the capability to simultaneously receive at least two PDSCHs; the UE's capability to support beam sweeping factor reduction; and the UE's capability to support GBBR.

Based on the same principle as the method executed by the UE provided in the embodiments of the disclosure, an embodiment of the disclosure further provides a method executed by a network node. The method may comprise steps of:
transmitting a first RRC configuration to a UE, the first RRC configuration comprising a configuration related to group based beam reporting; and
in case that the group based beam reporting of the UE is enabled, transmitting at least two downlink reference signals, and no later than a first moment, receiving a measurement result obtained by performing simultaneous measurement on the at least two downlink reference signals based on the first RRC configuration by the UE.

An embodiment of the disclosure further provides a method executed by a network node. The method may comprise steps of:
transmitting a second RRC configuration to a UE, the second RRC configuration comprising information related to resource scheduling; and when a resource scheduled by the second RRC configuration satisfies a first condition related to scheduling, simultaneously transmitting a downlink reference signal and a physical downlink shared channel.

An embodiment of the disclosure further provides a method executed by a network node. The method may comprise steps of:
transmitting a third RRC configuration to a UE, the third RRC configuration being related to beam failure detection (BFD) measurement of a set layer; wherein, when the third RRC configuration includes multiple measurement gap related information, a link quality evaluation time based on corresponding downlink reference signals from at least two TRPs is determined based on a first time sharing ratio and/or a beam sweeping factor N1; wherein the first time sharing ratio is determined based on the multiple measurement gap related information, and the first scaling factor is related to a time domain overlapping situation of at least one of the following information:
a measurement gap occasion, a SSB-based measurement timing configuration (SMTC) window, and a SSB occasion used for BFD.

An embodiment of the disclosure further provides a user equipment (UE), comprising: at least one transceiver; and at least one processor coupled to the at least one transceiver, wherein the at least one processor is configured to perform any method executed by the user equipment provided in the embodiments of the disclosure.

An embodiment of the disclosure further provides a network node, comprising: at least one transceiver; and at least one processor coupled to the at least one transceiver, wherein the at least one processor is configured to perform any method executed by the network node provided in the embodiments of the disclosure.

Based on the methods provided in the embodiments of the disclosure, an embodiment of the disclosure further provides an electronic device, comprising: a processor; and optionally a transceiver and/or memory coupled to the processor, wherein the processor is configured to perform the steps of the method provided in any one of the optional embodiments of the disclosure. Optionally, the electronic device may be a terminal device or a network node.

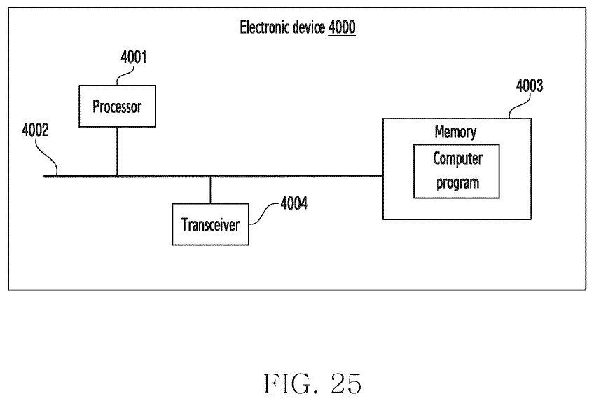

FIG. 25 shows a schematic structure diagram of an electronic device to which the solution according to an embodiment of the disclosure.

Referring to FIG. 25, the electronic device 4000 shown in FIG. 25 may include a processor 4001 and memory 4003. The processor 4001 is connected to the memory 4003, for example, through a bus 4002. Optionally, the electronic device 4000 may further include a transceiver 4004 that can be used for data exchange, for example, transmission and reception of data, between the electronic device and other electronic device. It should be noted that, in practical applications, the number of transceiver 4004 is not limited to one, and the structure of the electronic device 4000 does not constitute any limitations to the embodiments of the disclosure. Optionally, the electronic device may be a network node (e.g., base station) or a terminal.

The processor 4001 may be a central processing unit (CPU), a general-purpose processor, a digital signal processor (DSP), an application specific integrated circuit (ASIC), or a field programmable gate array (FPGA), or other programmable logic devices, transistor logic devices, hardware components, or any combination thereof. It may implement or execute various example logical blocks, modules and circuits described in connection with the disclosure. The processor 4001 may also be a combination for realizing computing functions, for example, a combination of one or more microprocessors, a combination of a DSP and a microprocessor, etc. The processor 4001 according to an embodiment of the disclosure may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The bus 4002 may include a path to transfer information between the components described above. The bus 4002 may be a peripheral component interconnect (PCI) bus, or an extended industry standard architecture (EISA) bus, etc. The bus 4002 may be an address bus, a data bus, a control bus, etc. For ease of presentation, the bus is represented by only one thick line in FIG. 25. However, it does not mean that there is only one bus or one type of buses.

The memory 4003 may be, but not limited to, read only memories (ROMs) or other types of static storage devices that can store static information and instructions, random access memories (RAMs) or other types of dynamic storage devices that can store information and instructions, may be electrically erasable programmable read only memories (EEPROMs), compact disc read only memories (CD-ROMs) or other optical disk storages, optical disc storages (including compact discs, laser discs, discs, digital versatile discs, blue-ray discs, etc.), magnetic storage media or other magnetic storage devices, or any other media that can carry or store desired program codes in the form of instructions or data structures and that can be accessed by computers.

The memory 4003 is used to store computer program for executing the solutions of the disclosure, and is controlled by the processor 4001. The processor 4001 is used to execute the computer program stored in the memory 4003 to implement the solution provided in any method embodiment described above.

According to embodiments, a method performed by a user equipment (UE) in a wireless communication system, may comprise receiving, a radio resource control (RRC) configuration, the RRC configuration comprising a configuration related to a group based beam reporting. The method may comprise in case that the group based beam reporting is enabled, performing, based on the RRC configuration, simultaneous measurement on at least two downlink signals transmitted by a network node. The method may comprise transmitting a measurement result to the network node before a time instance.

In an embodiment, the time instance may be related to a beam sweeping factor.

In an embodiment, the transmitting of the measurement result to the network before the time instance may comprise determining, according to the beam sweeping factor corresponding to at least one of capability information, to transmit the measurement result to the network node before the time instance. The capability information may comprise information whether to use at least two receive spatial domain filters to simultaneously receive the at least two downlink reference signals. The capability information may comprise information whether to support beam sweeping factor reduction.

In an embodiment, the performing, based on the RRC configuration, of the simultaneous measurement on the at least two downlink signals may comprise performing, based on the RRC configuration, simultaneous measurement of a set layer on the at least two downlink signals.

In an embodiment, the set layer may be layer 1 or layer 3

In an embodiment, the method may comprise at least one of for a known transmission configuration indication (TCI) state, receiving a TCI state switch command within a first duration, the first duration being related to a beam sweeping factor or if at least one of at least two TCI states is unknown, receiving a downlink control channel based on a target TCI state before another time instance after the time instance, the other time instance being related to the beam sweeping factor.

In an embodiment, the beam sweeping factor may comprise at least two candidate values.

In an embodiment, for layer 1, the at least two downlink signals may comprise at least two downlink signals corresponding to at least two transmission/reception points (TRPs), the at least two TRPs being at least two intra-cell TRPs or at least two inter-cell TRPs. For layer 3, the at least two downlink signals may comprise at least two downlink reference signals corresponding to at least two TRPs in one serving cell. The downlink signals may be synchronization signal blocks (SSBs) or channel state information reference signals (CSI-RSs).

In an embodiment, the method may further comprise transmitting UE capability information to the network node. The UE capability information may comprise at least one of information to indicate that the UE supports simultaneous reception of the at least two downlink signals, information to indicate that the UE supports the group based beam reporting, information to indicate that the UE supports a beam sweeping factor reduction, information to indicate that the UE supports simultaneous reception of at least one downlink signal and at least one physical downlink shared channel, or information to indicate that the UE supports a concurrent measurement gap (CMG).

According to embodiments, a user equipment (UE) may comprise at least one transceiver. The UE may comprise memory, including one or more storage mediums, storing instructions. The UE may comprise at least one processor. The instructions, when executed by the at least one processor individually or collectively, may cause the UE to receive, a radio resource control (RRC) configuration, the RRC configuration comprising a configuration related to a group based beam reporting. The instructions, when executed by the at least one processor individually or collectively, may cause the UE to, in case that the group based beam reporting is enabled, perform, based on the RRC configuration, simultaneous measurement on at least two downlink signals transmitted by a network node. The instructions, when executed by the at least one processor individually or collectively, may cause the UE to transmit a measurement result to the network node before a time instance.

According to embodiments, one or more non-transitory computer-readable storage mediums storing one or more computer programs including instructions that, when individually or collectively executed by at least one processor of a user equipment (UE), may cause the UE to receive, a radio resource control (RRC) configuration, the RRC configuration comprising a configuration related to a group based beam reporting. The one or more non-transitory computer-readable storage mediums storing one or more computer programs including instructions that, when individually or collectively executed by the at least one processor, may cause the UE to, in case that the group based beam reporting is enabled, perform, based on the RRC configuration, simultaneous measurement on at least two downlink signals transmitted by a network node. The one or more non-transitory computer-readable storage mediums storing one or more computer programs including instructions that, when individually or collectively executed by the at least one processor, may cause the UE to transmit a measurement result to the network node before a time instance.

According to embodiments, a method performed by a user equipment (UE) in a wireless communication system, may comprise receiving a radio resource control (RRC) configuration comprising information related to resource scheduling. The method may comprise simultaneously receiving a downlink reference signal and a physical downlink shared channel in a time instance when the downlink reference signal is at least partially overlapped with the physical downlink shared channel.

In an embodiment, the simultaneously receiving the downlink reference signal and the physical downlink shared channel may be performed if a condition is satisfied, the condition comprising at least one of downlink reference signal resources are at least partially overlapped with physical downlink shared channel resources in the time domain; when the RRC configuration is related to single downlink control information (DCI), the downlink reference signal resources and same physical downlink shared channel (PDSCH) resources scheduled by the single DCI are located at a same time instance, and the same PDSCH resources comprise different parts of the same PDSCH resource corresponding to at least two transmission/reception points (TRPs); or when the RRC configuration is related to multiple DCI, the downlink reference signal resources and different PDSCH resources corresponding to different TRPs are located at a same time instance.

In an embodiment, the RRC configuration further comprises at least one of related information of multiple TRPs corresponding to the downlink reference signal and the physical downlink shared channel that are received simultaneously; or quasi co-location (QCL) requirement related information.

In an embodiment, the method may further comprise transmitting UE capability information to a network node. The UE capability information may comprise at least one of capability information to indicate that the UE supports simultaneous reception of at least two downlink reference signals, information to indicate that the UE supports a group based beam reporting, information to indicate that the UE supports beam sweeping factor reduction, information to indicate that the UE supports simultaneous reception of at least one downlink reference signal and at least one physical downlink shared channel, or information to indicate that the UE supports a concurrent measurement gap (CMG).

According to embodiments, a user equipment (UE) may comprise at least one transceiver. The UE may comprise memory, including one or more storage mediums, storing instructions. The UE may comprise at least one processor. The instructions, when executed by the at least one processor individually or collectively, may cause the UE to receive a radio resource control (RRC) configuration comprising information related to resource scheduling. The instructions, when executed by the at least one processor individually or collectively, may cause the UE to simultaneously receive a downlink reference signal and a physical downlink shared channel in a time instance when the downlink reference signal is at least partially overlapped with the physical downlink shared channel.

According to embodiments, one or more non-transitory computer-readable storage mediums storing one or more computer programs including instructions that, when individually or collectively executed by at least one processor of a user equipment (UE), may cause the UE to receive a radio resource control (RRC) configuration comprising information related to resource scheduling. The one or more non-transitory computer-readable storage mediums storing one or more computer programs including instructions that, when individually or collectively executed by the at least one processor, may cause the UE to instructions, simultaneously receive a downlink reference signal and a physical downlink shared channel in a time instance when the downlink reference signal is at least partially overlapped with the physical downlink shared channel.

According to embodiments, a method executed by a user equipment (UE) in a wireless communication system, may comprise receiving a radio resource control (RRC) configuration, the RRC configuration being related to beam failure detection (BFD) measurement of a set layer. The method may comprise, in case that the RRC configuration comprises multiple measurement gap related information, determining a scaling factor based on the multiple measurement gap related information, the scaling factor being related to a time domain overlapping situation of at least one of a measurement gap occasion, a synchronization signal block (SSB)-based measurement timing configuration (SMTC) window, or a SSB occasion used for BFD. The method may comprise determining based on the scaling factor and a beam sweeping factor, a link quality evaluation time based on corresponding downlink reference signals from at least two transmission/reception points (TRPs).

In an embodiment, the multiple measurement gap related information may be related to a beam link quality. The time domain overlapping situation may comprise at least one of a time domain overlapping situation of the measurement gap occasion, the SMTC window and the SSB occasion used for BFD that are configured for a same TRP by a network node; a time domain overlapping situation of SSB occasions used for BFD that are configured for the at least two TRPs by a network node; or a time domain overlapping situation of a SSB occasion used for BFD that is configured for one TRP by a network node and measurement gap occasions and SMTC windows that are configured for other TRPs by the network node.

According to embodiments, a user equipment (UE) may comprise at least one transceiver. The UE may comprise memory, including one or more storage mediums, storing instructions. The UE may comprise at least one processor. The instructions, when executed by the at least one processor individually or collectively, may cause the UE to receive a radio resource control (RRC) configuration, the RRC configuration being related to beam failure detection (BFD) measurement of a set layer. The instructions, when executed by the at least one processor individually or collectively, may cause the UE to, in case that the RRC configuration comprises multiple measurement gap related information, determine a scaling factor based on the multiple measurement gap related information, the scaling factor being related to a time domain overlapping situation of at least one of a measurement gap occasion, a synchronization signal block (SSB)-based measurement timing configuration (SMTC) window, or a SSB occasion used for BFD. The instructions, when executed by the at least one processor individually or collectively, may cause the UE to determine based on the scaling factor and a beam sweeping factor, a link quality evaluation time based on corresponding downlink reference signals from at least two transmission/reception points (TRPs).

According to embodiments, a method performed by a user equipment (UE) in a wireless communication system, may comprise receiving, by the UE, a radio resource control (RRC) configuration, the RRC configuration comprising a configuration related to a group based beam reporting. The method may comprise in case that the group based beam reporting is enabled, performing, by the UE, based on the RRC configuration, simultaneous measurement on at least two downlink reference signals transmitted by a network node. The method may comprise transmitting, by the UE, a measurement result to the network node no later than a first moment.

In an embodiment, the first moment may be related to a beam sweeping factor.

In an embodiment, the transmitting of the measurement result to the network node no later than the first moment may comprise determining, by the UE according to the beam sweeping factor corresponding to at least one of the following capability information, to transmit the measurement result to the network node no later than the first moment. The following capability information may comprise UE's capability whether to use at least two receive chains to simultaneously receive the at least two downlink reference signals, and the UE's capability whether to support beam sweeping factor reduction.

In an embodiment, the performing, based on the RRC configuration, of the simultaneous measurement on the at least two downlink reference signals may comprise performing, based on the RRC configuration, simultaneous measurement of a set layer on the at least two downlink reference signals.

In an embodiment, the set layer may be layer 1 or layer 3.

In an embodiment, the method may further comprise at least one of for a known transmission configuration indication (TCI) state, receiving a TCI state switch command within a first duration, the first duration being related to a beam sweeping factor; or if at least one of at least two TCI states is unknown, receiving a downlink control channel based on a target TCI state no later than a second moment, the second moment being related to the beam sweeping factor.

In an embodiment, the beam sweeping factor may be associated with the UE's capability whether to use at least two receive chains to simultaneously receive the at least two downlink reference signals. The beam sweeping factor may be associated with the UE's capability whether to support beam sweeping factor reduction.

In an embodiment, the beam sweeping factor may comprise at least two candidate values.

In an embodiment, for layer 1, the at least two downlink reference signals may comprise at least two downlink reference signals corresponding to at least two transmission/reception points (TRPs), the at least two TRPs being at least two intra-cell TRPs or at least two inter-cell TRPs. For layer 3, the at least two downlink reference signals may comprise at least two downlink reference signals corresponding to at least two TRPs in one serving cell. The downlink reference signals may be synchronization signal blocks (SSBs) or channel state information reference signals (CSI-RSs).

In an embodiment, the method may further comprise transmitting UE capability information to the network node, the UE capability information comprising at least one of the capability to indicate that the UE supports simultaneous reception of the at least two downlink reference signals, the capability to indicate that the UE supports the group based beam reporting, the capability to indicate that the UE supports the beam sweeping factor reduction, the capability to indicate that the UE supports simultaneous reception of at least one downlink reference signal and at least one physical downlink shared channel, or the capability to indicate that the UE supports a concurrent measurement gap (CMG).

In an embodiment, a method performed by a user equipment (UE) in a wireless communication system, may comprise receiving, by the UE, a radio resource control (RRC) configuration, the RRC configuration comprising information related to resource scheduling. The method may comprise when a resource scheduled by the RRC configuration satisfies a first condition related to scheduling, simultaneously receiving, by the UE, a downlink reference signal and a physical downlink shared channel. The first condition may be related to an overlapping situation of the downlink reference signal and the physical downlink shared channel in a time domain.

In an embodiment, the first condition may comprise at least one of downlink reference signal resources are at least partially overlapped with physical downlink shared channel resources in the time domain; when the RRC configuration is related to single downlink control information (DCI), the downlink reference signal resources and same physical downlink shared channel (PDSCH) resources scheduled by the single DCI are located at a same time instance, and the same PDSCH resources comprise different parts of the same PDSCH resource corresponding to at least two transmission/reception points (TRPs); or when the RRC configuration is related to multiple DCI, the downlink reference signal resources and different PDSCH resources corresponding to different TRPs are located at a same time instance.

In an embodiment, the RRC configuration may further comprise at least one of related information of multiple TRPs corresponding to the downlink reference signal and the physical downlink shared channel that are received simultaneously; or quasi co-location (QCL) requirement related information.

In an embodiment, the method may further comprise transmitting UE capability information to a network node. The UE capability information may comprise at least one of the capability to indicate that the UE supports simultaneous reception of at least two downlink reference signals, the capability to indicate that the UE supports a group based beam reporting, the capability to indicate that the UE supports beam sweeping factor reduction, the capability to indicate that the UE supports simultaneous reception of at least one downlink reference signal and at least one physical downlink shared channel, or the capability to indicate that the UE supports a concurrent measurement gap (CMG).

According to embodiments, a method executed by a user equipment (UE) in a wireless communication system, may comprise receiving, by the UE, a radio resource control (RRC) configuration, the RRC configuration being related to beam failure detection (BFD) measurement of a set layer. The method may comprise in case that the RRC configuration comprises multiple measurement gap related information, determining, by the UE, a first scaling factor based on the multiple measurement gap related information. The first scaling factor may be related to a time domain overlapping situation of at least one of a measurement gap occasion, a synchronization signal block (SSB)-based measurement timing configuration (SMTC) window, and a SSB occasion used for BFD. The method may comprise determining, by the UE, based on the first scaling factor and a beam sweeping factor, a link quality evaluation time based on corresponding downlink reference signals from at least two transmission/reception points (TRPs).

In an embodiment, the multiple measurement gap related information may be related to a beam link quality.

In an embodiment, the time domain overlapping situation may comprise at least one of a time domain overlapping situation of the measurement gap occasion, the SMTC window and the SSB occasion used for BFD that are configured for a same TRP by a network node; a time domain overlapping situation of SSB occasions used for BFD that are configured for the at least two TRPs by a network node; or a time domain overlapping situation of a SSB occasion used for BFD that is configured for one TRP by a network node and measurement gap occasions and SMTC windows that are configured for other TRPs by the network node.

According to embodiments, a method performed by a network node in a wireless communication system, may comprise transmitting, by the network node, a radio resource control (RRC) configuration to a user equipment (UE), the RRC configuration comprising a configuration related to a group based beam reporting. The method may comprise in case that the group based beam reporting of the UE is enabled, transmitting, by the network node, at least two downlink reference signals. The method may comprise no later than a first moment, receiving, by the network node, a measurement result obtained by performing simultaneous measurement on the at least two downlink reference signals based on the RRC configuration by the UE.

According to embodiments, a method performed by a network node in a wireless communication system, may comprise transmitting, by the network node, a radio resource control (RRC) configuration to a user equipment (UE), the RRC configuration comprising information related to resource scheduling. The method may comprise, when a resource scheduled by the RRC configuration satisfies a first condition related to scheduling, simultaneously transmitting, by the network node, a downlink reference signal and a physical downlink shared channel. The first condition may be related to an overlapping situation of the downlink reference signal and the physical downlink shared channel in a time domain.

According to embodiments, a method performed by a network node in a wireless communication system, may comprise transmitting, by the network node, a radio resource control (RRC) configuration to a user equipment (UE), the RRC configuration being related to beam failure detection (BFD) measurement of a set layer. In case that the RRC configuration comprises multiple measurement gap related information, a link quality evaluation time based on corresponding downlink reference signals from at least two transmission/reception points (TRPs) may be determined based on a first scaling factor and a beam sweeping factor. The first scaling factor may be determined based on the multiple measurement gap related information, and the first scaling factor is related to a time domain overlapping situation of at least one of a measurement gap occasion, a synchronization signal block (SSB)-based measurement timing configuration (SMTC) window, or a SSB occasion used for BFD.

According to embodiments, a user equipment (UE) may comprise at least one transceiver. The UE may comprise memory storing one or more computer programs. The UE may comprise one or more processors communicatively coupled to the at least one transceiver and the memory. The one or more computer programs may include computer-executable instructions that, when executed by the one or more processors, cause the UE to receive a radio resource control (RRC) configuration, the RRC configuration comprising a configuration related to a group based beam reporting. The one or more computer programs may include computer-executable instructions that, when executed by the one or more processors, cause the UE to, in case that the group based beam reporting is enabled, perform based on the RRC configuration, simultaneous measurement on at least two downlink reference signals transmitted by a network node. The one or more computer programs may include computer-executable instructions that, when executed by the one or more processors, cause the UE to transmit a measurement result to the network node no later than a first moment.

According to embodiments, a network node may comprise at least one transceiver. The network node may comprise memory storing one or more computer programs. The network node may comprise one or more processors communicatively coupled to the at least one transceiver and the memory. The one or more computer programs may include computer-executable instructions that, when executed by the one or more processors, cause the network node to transmit a radio resource control (RRC) configuration to a user equipment (UE), the RRC configuration comprising a configuration related to a group based beam reporting. The one or more computer programs may include computer-executable instructions that, when executed by the one or more processors, cause the network node to, in case that the group based beam reporting of the UE is enabled, transmit at least two downlink reference signals. The one or more computer programs may include computer-executable instructions that, when executed by the one or more processors, cause the network node to no later than a first moment, receive a measurement result obtained by performing simultaneous measurement on the at least two downlink reference signals based on the RRC configuration by the UE.

According to embodiments, one or more non-transitory computer-readable storage media may store one or more computer programs including computer-executable instructions that, when executed by one or more processors of a user equipment (UE), cause the UE to perform operations. The operations may comprise receiving, by the UE, a radio resource control (RRC) configuration, the RRC configuration comprising a configuration related to a group based beam reporting. The operations may comprise in case that the group based beam reporting is enabled, performing, by the UE, based on the RRC configuration, simultaneous measurement on at least two downlink reference signals transmitted by a network node. The operations may comprise transmitting, by the UE, a measurement result to the network node no later than a first moment.

In an embodiment, the first moment may be related to a beam sweeping factor.

Embodiments of the disclosure provide a computer-readable storage medium having a computer program stored on the computer-readable storage medium, the computer program, when executed by a processor, implements the steps and corresponding contents of the foregoing method embodiments.

Embodiments of the disclosure also provide a computer program product including a computer program, the computer program when executed by a processor realizing the steps and corresponding contents of the preceding method embodiments.

The terms “first”, “second”, “third”, “fourth”, “1”, “2”, etc. (if present) in the specification and claims of this application and the accompanying drawings above are used to distinguish similar objects and need not be used to describe a particular order or sequence. It should be understood that the data so used is interchangeable where appropriate so that embodiments of the disclosure described herein can be implemented in an order other than that illustrated or described in the text.

It should be understood that while the flow diagrams of embodiments of the disclosure indicate the individual operational steps by arrows, the order in which these steps are performed is not limited to the order indicated by the arrows. Unless explicitly stated herein, in some implementation scenarios of embodiments of the disclosure, the implementation steps in the respective flowcharts may be performed in other orders as desired. In addition, some, or all of the steps in each flowchart may include multiple sub-steps or multiple phases based on the actual implementation scenario. Some or all of these sub-steps or stages can be executed at the same moment, and each of these sub-steps or stages can also be executed at different moments separately. The order of execution of these sub-steps or stages can be flexibly configured according to requirements in different scenarios of execution time, and the embodiments of the disclosure are not limited thereto.

While the disclosure has been shown and described with reference to various embodiments thereof, it will be understood by those skilled in the art that various changes in form and details may be made therein without departing from the spirit and scope of the disclosure as defined by the appended claims and their equivalents.

No claim element is to be construed under the provisions of 35 U.S.C. § 112, sixth paragraph, unless the element is expressly recited using the phrase “means for” or “means”.

What is claimed is:

1. A method performed by a user equipment (UE) in a wireless communication system, the method comprising:
receiving, a radio resource control (RRC) configuration, the RRC configuration comprising a configuration related to a group based beam reporting;
in case that the group based beam reporting is enabled, performing, based on the RRC configuration, simultaneous measurement on at least two downlink signals transmitted by a network node; and
transmitting a measurement result to the network node before a time instance.

2. The method according to claim 1, wherein the time instance is related to a beam sweeping factor.

3. The method according to claim 2, wherein the transmitting of the measurement result to the network node before the time instance comprises:
determining, according to the beam sweeping factor corresponding to at least one of capability information, to transmit the measurement result to the network node before the time instance,
wherein the capability information comprises:
information whether to use at least two receive spatial domain filters to simultaneously receive the at least two downlink signals, and
information whether to support beam sweeping factor reduction.

4. The method according to claim 1, wherein the performing, based on the RRC configuration, of the simultaneous measurement on the at least two downlink signals comprises:
performing, based on the RRC configuration, simultaneous measurement of a set layer on the at least two downlink signals.

5. The method according to claim 4, wherein the set layer is layer 1 or layer 3.

6. The method according to claim 1, further comprising at least one of:
for a known transmission configuration indication (TCI) state, receiving a TCI state switch command within a first duration, the first duration being related to a beam sweeping factor; or
if at least one of at least two TCI states is unknown, receiving a downlink control channel based on a target TCI state before another time instance after the time instance, the other time instance being related to the beam sweeping factor.

7. The method according to claim 2, wherein the beam sweeping factor comprises at least two candidate values.

8. The method according to claim 1,
wherein for layer 1, the at least two downlink signals comprise at least two downlink signals corresponding to at least two transmission/reception points (TRPs), the at least two TRPs being at least two intra-cell TRPs or at least two inter-cell TRPs,
wherein for layer 3, the at least two downlink signals comprise at least two downlink reference signals corresponding to at least two TRPs in one serving cell, and
wherein the downlink signals are synchronization signal blocks (SSBs) or channel state information reference signals (CSI-RSs).

9. The method according to any one of claim 1, further comprising:
transmitting UE capability information to the network node,
wherein the UE capability information comprising at least one of:
information to indicate that the UE supports simultaneous reception of the at least two downlink signals,
information to indicate that the UE supports the group based beam reporting,
information to indicate that the UE supports a beam sweeping factor reduction,
information to indicate that the UE supports simultaneous reception of at least one downlink signal and at least one physical downlink shared channel, or
information to indicate that the UE supports a concurrent measurement gap (CMG).

10. A method performed by a user equipment (UE) in a wireless communication system, the method comprising:
receiving a radio resource control (RRC) configuration comprising information related to resource scheduling; and
simultaneously receiving a downlink reference signal and a physical downlink shared channel in a time instance when the downlink reference signal is at least partially overlapped with the physical downlink shared channel.

11. The method according to claim 10, wherein the simultaneously receiving the downlink reference signal and the physical downlink shared channel is performed if a condition is satisfied, the condition comprising at least one of:
downlink reference signal resources are at least partially overlapped with physical downlink shared channel resources in a time domain;
when the RRC configuration is related to single downlink control information (DCI), the downlink reference signal resources and same physical downlink shared channel (PDSCH) resources scheduled by the single DCI are located at a same time instance, and the same PDSCH resources comprise different parts of the same PDSCH resource corresponding to at least two transmission/reception points (TRPs); or
when the RRC configuration is related to multiple DCI, the downlink reference signal resources and different PDSCH resources corresponding to different TRPs are located at a same time instance.

12. The method according to claim 10, wherein the RRC configuration further comprises at least one of:
related information of multiple TRPs corresponding to the downlink reference signal and the physical downlink shared channel that are received simultaneously; or
quasi co-location (QCL) requirement related information.

13. The method according to claim 10, further comprising:
transmitting UE capability information to a network node, the UE capability information comprising at least one of:
capability information to indicate that the UE supports simultaneous reception of at least two downlink reference signals,
information to indicate that the UE supports a group based beam reporting,
information to indicate that the UE supports beam sweeping factor reduction,
information to indicate that the UE supports simultaneous reception of at least one downlink reference signal and at least one physical downlink shared channel, or
information to indicate that the UE supports a concurrent measurement gap (CMG).

14. A user equipment (UE), comprising:
at least one transceiver;
memory, including one or more storage mediums, storing instructions; and
at least one processor;
wherein the instructions, when executed by the at least one processor individually or collectively, cause the UE to:
receive, a radio resource control (RRC) configuration, the RRC configuration comprising a configuration related to a group based beam reporting;
in case that the group based beam reporting is enabled, perform, based on the RRC configuration, simultaneous measurement on at least two downlink signals transmitted by a network node; and
transmit a measurement result to the network node before a time instance.

15. The UE according to claim 14, wherein the time instance is related to a beam sweeping factor.

16. The UE according to claim 15, wherein the instructions, when executed by the at least one processor individually or collectively, further cause the UE, for the transmitting of the measurement result to the network node before the time instance, to:
determine, according to the beam sweeping factor corresponding to at least one of capability information, to transmit the measurement result to the network node before the time instance,
wherein the capability information comprises:
information whether to use at least two receive spatial domain filters to simultaneously receive the at least two downlink signals, and
information whether to support beam sweeping factor reduction.

17. The UE according to claim 14, wherein the instructions, when executed by the at least one processor individually or collectively, further cause the UE, for the performing, based on the RRC configuration, of the simultaneous measurement on the at least two downlink signals, to:
perform, based on the RRC configuration, simultaneous measurement of a set layer on the at least two downlink signals.

18. The UE according to claim 17, wherein the set layer is layer 1 or layer 3.

19. The UE according to claim 14, wherein the instructions, when executed by the at least one processor individually or collectively, further cause the UE to perform at least one of the following:
for a known transmission configuration indication (TCI) state, receiving a TCI state switch command within a first duration, the first duration being related to a beam sweeping factor; or
if at least one of at least two TCI states is unknown, receiving a downlink control channel based on a target TCI state before another time instance after the time instance, the other time instance being related to the beam sweeping factor.

20. One or more non-transitory computer-readable storage mediums storing one or more computer programs including instructions that, when individually or collectively executed by at least one processor of a user equipment (UE), cause the UE to:
receive, a radio resource control (RRC) configuration, the RRC configuration comprising a configuration related to a group based beam reporting;
in case that the group based beam reporting is enabled, perform, based on the RRC configuration, simultaneous measurement on at least two downlink signals transmitted by a network node; and
transmit a measurement result to the network node before a time instance.
